(19) United States
(12) Patent Application Publication
(10) Pub. No.: US 2024/0345123 A1
(43) Pub. Date: Oct. 17, 2024

(54) IU/MU Transducer

(71) Applicants: Amar Mukund Vakil, Dana Point, CA (US); Sergey Mihailovich Godin, Moscow Russian Federation (RU); John Richard Clymer, Boone, IA (US); Fedor Sergeyevich Zaytsev, Moscow Russian Federation (RU); Keryn Dallas Johnson, Wellington (NZ)

(72) Inventors: Amar Mukund Vakil, Dana Point, CA (US); Sergey Mihailovich Godin, Moscow Russian Federation (RU); John Richard Clymer, Boone, IA (US); Fedor Sergeyevich Zaytsev, Moscow Russian Federation (RU); Keryn Dallas Johnson, Wellington (NZ)

(21) Appl. No.: 18/445,895

(22) Filed: Mar. 11, 2024

Related U.S. Application Data
(60) Provisional application No. 63/451,537, filed on Mar. 10, 2023.

(51) Int. Cl. G01N 37/00; G21B 3/00; H02N 99/00

(52) U.S. Cl. CPC G01N 37/005; G21B 3/00; H02N 99/00

(57) ABSTRACT

The goal of this patent/project is to safely control the release of an electric current or other beneficial action through interaction between the Information Universe (IU), using Low Energy Nuclear Reaction (LENR) action devices, and the Material Universe (MU). The combined Information Universe (IU) and Material Universe (MU) is a feedback control system where the IU regulates the MU. A simulation model of this system is part of this project to guide the LENR device development and the process of learning the rules that relate a disturbance of the MU to the regulator action of the IU. These devices will be controlled using closed loop control surface rules discovered as part of this project. Experiments described in the literature have shown lowered weight and temperature, multiplication of number of photons released, and other beneficial nuclear reactions can occur and be controlled.

### BACKGROUND OF THE INVENTION

There have been many experiments described in the literature where a disturbance in the MATERIAL UNIVERSE (MU) has been answered with release of energy from the INFORMATION UNIVERSE (IU). For example, [1] a physics experiment where a lazar shines on a particular kind of solar cell (disturbance) produces a multiplied flood of photons (regulator action). These experiments and many more have opened the door to the IU/MU system interface only a crack. Our experiments, discussed in this patent, will throw this door wide open to reveal a whole world of new applications for new physics [1-15]. We will do this by discovering the facts and rules that relate a disturbance space in the MU to the space of associated regulator actions by the IU to define the IU/MU control system equations. The IU/MU system must exist; otherwise, random disturbances would allow the MU to return to chaos [7]. Recall, the second law of thermodynamics states that entropy never decreases in an isolated system left to spontaneous evolutionary processes and will always reach a state of thermodynamic, equilibrium where the entropy is maximum. However, the IU/MU system is a non-isolated, evolutionary process that is under regulation such that entropy is minimized. It has been observed that IU/MU system regulation eliminates errant system states [3, 4] that violate the laws of physics (IU rules). Such regulation is like a communications channel [7, 10] where most messages (system states) can never happen (low entropy) or another non-regulated system where all messages are equally likely (maximum entropy). For any disturbance created by our project, the IU response must comply with all physical laws, including the conservation of energy but extended to four dimensions far from thermodynamic equilibrium also known as the IU/MU exhaust [7]. This includes IU/MU system responses that up to now have been unknown (new physics). Of further interest is that both the Shannon and Godel's theorems point to the existence of a sentient hierarchy of self-organizing structures dynamically evolving [2, 10, 11]. A paper on Research Gate [4]“Evolution of Information Universe Rules to Regulate the Material Universe Quantum Stability: Simulation Model” demonstrates how rule learning AI software based on evolutionary algorithms can learn the rules of physics that minimize entropy in the MU. Interestingly, the simulation implied that the rule selection criteria must be provided by a higher intelligence outside the IU hence Godel's theorem [2]. Further, useful rules could not be learned unless there was a constant low level disturbance present [2, 10, 11].

### BRIEF SUMMARY OF THE INVENTION

The invention developed safely controls the release of an electric current or other energy from the IU. IU is an advanced concept that extends literature [17-39] to a practical device the IU/MU Transducer (this invention) addressing 1957, Lee and Yang work for which they were awarded the Nobel Prize involving an IU/MU exhaust. This was the discovery of broken symmetry of opposite charges “such as the ends of a dipole, like between those terminals of that generator”. This would take place in the fierce energy flux of the vacuum. This requires a device that enables a process to furnish aforementioned dipole (SEE FIG. 5) through evolutionary expansionist hierarchies of rules to make accessible in a highly nonlinear regime using systems science process control not reductionist physics models with restrictive parameters. The device created is called IU/MU Transducer (see “Title of the Invention”) to illicit time reversed photon resonance yielding new physics [17-39]. In time reversed photon resonance and concomitantly, other experiments, shown both weight and temperature can be reduced (see Background of Invention). The combined IU and MU is a feedback control system where the IU regulates the MU. An analogy is the heating system in your house. The IU is a continuous process of temperature measurement, and the MU is the furnace system plus your house [7]. If the temperature goes above a set value, the furnace is turned off. If the temperature goes below a set value, the furnace is turned on. For the IU/MU system discussed in this patent, the IU is a set of communicating, concurrent processes that continuously measure various aspects of the MU and institute changes in the MU to return to set-points using in [11, 15, 16, 42] the Autonomous Universal Predictor (AUP) also known as Smart Feature Extractor (SFC), and in [1, 3-7, 15] Operational Evaluation Model for Context Sensitive Systems (OpEMCSS). Three separate but related experiments are provided and, in their unification, achieve the stated invention.

### 1) The Quadrupole Experiments

Generates a collection of disturbances in the MU and learns the rules that predict the associated regulator responses [1]. These rules define a control surface for these IU/MU interactions [1, 3-7] which allow safe control of the IU/MU Transducer advancing [17-39] to practical use.

An example of this is outlined in the single atom physics model whereby the input quadrupole is a function of hydrogen s orbital geometry of the positron and electron pairs in a cross based geometry in NH3+ (amine protonated functionality) and NH2 in the unprotonated form. In the given quadrupole arrangement, the H atom is not in the MU form of proton and electron but is in the positron and electron pairing that aligns the electromagnetic fields with positron and electron geometry. Such an arrangement enables tunnelling of the hydrogen atom into the aromatic ring as the magnetic field barrier is able to prevent entry to charged objects, but the balanced quadrupole geometry of positron electron pairs provides a no mass and no charge functionality to the photons within the electromagnetic field of hydrogen. Thus, photons act as the input into the IU to generate MU structure within the single atom confinement system operating at the center of the IU/MU transducer.

### 2) The Low Energy Nuclear Reaction (LENR) Experiment

Explores the nature of the medium that connects the IU regulator decision to the disturbance in the MU. This medium, called the Ether or Zero Point Energy, is an Information Wave from which the features that completely describe the Ether/Information Wave signal can be extracted for rule learning [8].

The SUSY inversion DE DM system provides connection to the vacuum singularity (gravity DM system) and enables quantum gravity calculations based on conversion of distance away from the Planck scale singularity (1.6 E−35 m) and the position of the particle under investigation. The model enables isotope binding energy conversion into nm distance away from the Planck singularity as well as conversion into kJ/mole (m/s) velocity attributed to the IU velocity wave corresponding to an isotope decay and atom rearrangement event, which produces a new stable atom system as well as released energy to perform work in each external environment. Depending on the form the isotope decay happening to take (IU/MU transducer) will learn the rules and input instructions that provide the basis for repetition and control of the IU/MU process to produce functional work that corresponds to the atomic rearrangement within the atomic system using the IU rules of energy conservation and quantum correction mediated through charge conservation.

### 3) The Homopolar Generator Experiments

Explore further the reduction of weight, temperature, and other effects to gain further understanding of the relation between controlling Ether/Information Wave and the production of new physical phenomena [9 and see note on updates 2023].

The cosmological expansion of the universe is determined to be performed by alpha particle emission from the He-BEC isotropic singularity model. This model provides a faster than light emission system corresponding to negative time dilation as well as negative mass faster than light system that functions to balance the mass present in the MU (observable universe) corresponding to approximately 5% of the matter universe. Such a process has been reconciled with the slower than light DM system via energy conservation rules and the inverse square law framework for single atom physics provides the basis for atomic confinement within the aromatic ring of neurotransmitter function that provides the basis for biological entities have anti-entropic systems operating within them to obtained energy from atomic rearrangements and produce the animate aspects of human biology. Such a model (single atom systems science) provides the basis for anti-entropic negative time dilation processes associated with specific isotope physics processes linked to alpha particle decay systems. The SUSY inversion DE DM system provides the tools to convert Binding energy to kJ/mole (m/s) at the specific time associated with isotope half-life. This model provides a deterministic space-time framework within the confines of aromatic ring structures that generates an inversion field. This gives rise to regenerative healing energy in the form of individual atom decay scalar wave energy systems. The utilization of such technologies is already under patent (Quantum Technologies Ltd).

### BRIEF DESCRIPTION OF THE DRAWINGS

FIG. 1: Autonomous Universal Predictor (AUP) developed by Amar M. Vakil. AUP was used in Functional Magnetic Resonance Imaging] (fMRI) (mechanism can apply to three experiments investigated in “Description of the Invention”) yielding quasi quantum sense entropy detection in dynamical spatio-temporal undetermined blind source signal (fulfills IU concept) separation setting in brain encephalography [15, 42]. AUP involves the IU interface as the OpEMCSS (FIG. 2) involves MU disturbance space, hence IU/MU Transducer. SUSY inversion DE DM He-BEC isotropic singularity physics model (QT) developed by Keryn Dallas Johnson provides the basis for complexation chemistry of single atoms coordinated to neurotransmitter aromatic rings that provides the ability to generate unstable atoms within the faraday like cage environment of the aromatic ring e.g. dopamine structure. The ring system can only house a single atom and therefore is a monoatomic system and not the typical diatomic system presented by the Standard Model of Particle Physics in a biological context. This isolated protected environment provides the quantum location whereby isotope systems can operate in the warm and wet environment of the human brain. The quantum superposition of states and the collapse of the wavefunction is therefore associated with the isotope physics mediated functionality generated by neurotransmitters having a functional role in quantum tunnelling of hydrogen and generation of unstable atoms within the ring system. The IU componentry being modular and featured through tunnelling and entanglement systems that offers a change in geometry from symmetry (photons), having no mass and charge, to asymmetry (proton and electron) having both mass and charge. This functional change in geometry occurring within the aromatic ring system provides a confined environment where anti-entropic processes can operate biologically.

FIG. 2: Operational Evaluation Model Context Sensitive Systems (OpEMCSS) developed by John. R. Clymer [6]. AUP will be used with in tandem (FIG. 1) with OpEMCSS [1] and also see [41].

FIG. 3: Quadrupole. AUP in tandem with OpEMCSS Feature Map will enable an IU/MU Transducer to safely and autonomously perform machine learning feedback control to disturb and regulate IU/MU exhaust open system rewarding goal to reduce system entropy to its surroundings, punish otherwise, thereby, guide to shift towards thermal non-equilibrium.

FIG. 4: Experimental Setup for Quadrupole System Q1 blue circles (See DETAILED DESCRIPTION OF INVENTION) includes pair of each one out of phase by 180 degrees white circles (not required and optional) yielding a dipole time forward and reversed with the goal to REWARD keeping dipole intact time reversed longer as it decays forward.

FIG. 5: Mathematica simulation for Quadrupole System with Asymmetric Dipole advancing references [17-39] (positive and negative charge separation “broken symmetry” and can be controlled keeping the dipole intact in DIPOLE window covering two central blue circles that focus on directing virtual photon absorption that is time reversed and at low frequencies to account for scalar attributes accompanying transverse and longitudinal which is the IU/MU exhaust) in window (see DETAILED DESCRIPTION OF INVENTION). Note these simulations are NOT side to side but overlapping each other at 180 degrees out of phase representing an actual quadrupole system experiment (also simulated in COMSOL Multiphysics—SEE CLAIMS). The mathematics extends Maxwells equations to 4-dimensional quaternion non-commuting and including commuting dihedral geometry including Minkowski, but others too using geometric algebra and geometric calculus.

FIG. 6: Transformation of Nuclides at Low Temperature (TNLT) laboratory setup (SEE DETAILED

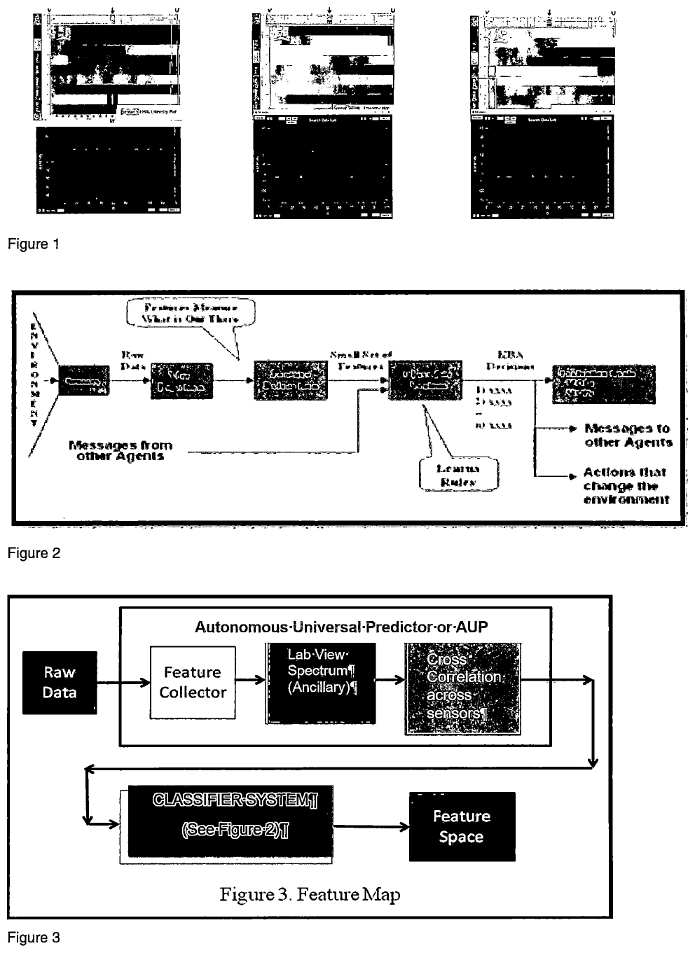

### DESCRIPTION OF THE INVENTION

FIG. 7: TNLT device developed by Feder Zaitsev to extract features of the ether information wave signal (SEE DETAILED DESCRIPTION OF THE INVENTION)

FIG. 8: Homopolar generator experiment (found in white square outline) in laboratory setup (SEE DETAILED DESCRIPTION OF THE INVENTION)

FIG. 9: Close up view of Homopolar generator experiments developed by Vladimir Roschin and Sergei Godin and (SEE DETAILED DESCRIPTION)

FIG. 10: The IU MU TRANSDUCER process (see CLAIMS section and DETAIL DESCRIPTION) combining all five experiments of each inventor listed in this patent (see INVENTORS section). Red arrows counterclockwise AUP+OpEMCSS→SUSY DE DM→Photo-Fenton chemistry quantum entangled fluid generation (Light Cymatics) and senor inputs (photonic coherent laser light)/output (electromagnetic) photonic selection processes to modulate LENR+TNLT=control loop yields an IU interface. The blue arrows are TNLT ether wave theory/SUSY DE DM differential velocity subatomic physics system of information interaction [10,13] involve quadrupole, homopolar, and LENR including other applications [8] yields MU interface. Thus an IU/MU transducer is enabling advancing [17-39] to practical use via red and blue arrows (see ABSTRACT and CLAIMS). The green arrows is visual output for cataloguing/classifying via Mathematica and COMSOL Multiphysics yielding a “control surface” (not confuse with “plot surface” as it means two different things).

FIG. 11: A photonic light feedback acts as a toolbox feature modelling system to model unseen functionality within the atomic systems. IU visualization using IU MU transducer system setup using a photonic interactive feedback light-loop system and identification of a quantum coherent singularity DM connection in SUSY DE DM model. The video feedback system provides a visualization of a central singularity (yellow central sphere in FIG. 11), acting as a vanishing point that has characteristic fluid dynamics of light (electromagnetic fields in terms of E field and B field being at right angles to one another), that has a different fluidic property from the higher wavelength layers observed in the feedback system. A Sony video camera is filming the capture screen which is displaying the image on the camera. This cyclic feedback system offers an interactive interface to the light that is being displayed on the screen. The temporal and spatial compartmentalization in a microscopic (zoom out) or telescopic mode (zoom in magnification). The feedback providing multiple pass photon detection via spectroscopic analysis. It also allows photonic inputs to specific wavelengths of electromagnetism depending on the image displayed. Such interactive systems reveal reciprocal relationships in motion corresponding to a duality of mirror symmetry states that equates to matter/antimatter pairing within atomic structures. This model of motion in atomics is associated with the novel discovery of Baryonic symmetry associate with a new solution to quark charge calculations and provides the basis for the inversion associated with a pinhole camera-like feature of inner atomic structure operating within the nucleus of the atom (Planck atomic singularity at [0,0,0]) connected to Dark Matter (SUSY DE/DM model) and such a model offers insight into isotope physics behavior in terms of spatial and temporal processes mediating a quantum correction in quark reorganization in producing charge parity as a feature of stable atom theory. In this atomic singularity framework where every action has an equal and opposite reaction as observed through the motion of the camera and its 180-degree. An inversion of orientation observed in the opposite directional motion of the image observable on the laptop screen, with respect to the motion of the camera in its rotational behavior representing spin and angular momentum and the motion forward and backward and zooming in and out and the respective observational changes in optical features observed on the screen in terms of distance away from the singularity at the central location. The inversion is seen in reciprocal mathematics and the language of charge inversion developed as part of the SUSY inversion He-BEC isotropic singularity framework for quark charge calculations. This provides the basis for looking into the mirror and seeing a 180-degree rotated image looking back at you. The inversion obtained via isotope physics mediated atomic decay is proposed to be responsible for the temporal directionality of light from inward to outward, which is associated with time reversal symmetry operating in biological systems. This provides a basis for the LENR features of biology linked to consciousness connected to neurotransmitter function. The isotope decay system therefore provides the basis for the temporal difference between unconscious physics processes associated with isotope decay and the W Boson mediated chiral features of unstable atoms in beta decay systems and the conscious mind (neuron processing of the light generated by the motion of electron in protons associated with neurotransmitter function). This connects the biology of consciousness to the physics of the unconscious mind leading to a model that correlates delayed reality associated with photonic information released from isotope decay physics that connect to biological systems mediated by neurological firings associated with the experience of consciousness.

The connection with proton tunnelling into the aromatic ring of the neurotransmitter e.g. dopamine of the hydrogen presented on the locally positioned proton in the amine NH₃⁺ offers an optimal chemical functionality for proton tunnelling into the aromatic ring. The dimensions and functionality of the ring are such that it restricts what atoms can enter the ring and how the atoms are manufactured within the aromatic ring. A systematic evaluation of the features and parameters operating within this environment offer clues to the organization of the atomic structure in an anti-entropic fashion associated with the generation of unstable atoms (isotopes) and their respective stability associated with half-life timings. Given the characteristic features of the internal area of the aromatic ring and the functionality of orbital geometry associated with the proton and its tunnelling into the ring enables classical approaches to modelling these unique loci and its functional attributes can be obtained empirically through learning an atomic language of decay timings and energy emitted associated with the binding energy of the atom. Learning the rules of the atomic systems are made somewhat easier proviso that the ring can only contain one atom at a time. Given this limitation the SUSY DE DM model provides the basis for exploration of the processes operating within single atom systems given the provision that the one atom system is a true reflection of subatomic particle physics. The features of such system are an ideal mathematical playground for leaning the rules of the IU MU Transducer because they relate the dynamic interplay between stable atom states and unstable atom states to functional changes in energy and entropy connected to AUP and OpEMCSS rule leaning programs. In terms of a newly established reciprocal inverse square law-like language that offers further insight into the substructure features of subatomic particles in an empirical fashion that does not require measurements but is based on logical analysis. The model takes advantage that within the aromatic ring “Faraday cage system” the unstable atom is protected from the external warm and wet environment of the mind and therefore the timings and energies are inherently deterministic from the perspective of a single atom either decays or does not decay. As the aromatic ring can absorb specific wavelengths of electromagnetism. The transfer of the energy to the internal atomic system may or may not occur depending on which atom is present. Feature so the atomic energy output associated with isotope decay physics in a LENR one atom system are therefore presented as a way of learning the geometric features of single atoms that operate using physics that is biologically relevant and associated with healing and regenerative features associated with Manuka Honey.

FIG. 12: Spectroscopic information output of the IU MU Transducer connected to the functional video feedback system along with blue tooth non-interactive analysis in real time. The Google screen cast feature was used to transmit the image to a Sony Smart TV. The ability to obtain spectral information via the use of cosmological spectroscopy camera allowing the identification of Fraunhofer lines (absorbance wavelengths) and integrated software provides the IU MU Transducer with the ability to observe photon electron transitions in real time, which are cycled through a 60 Hz recycling video feedback system that offers additional information on the dimensionality with the modelled system. The coherent light (laser light) input and spectroscopic output demonstrates that modulation of the electromagnetic properties can be performed by using the IU MU Transducer setup. The SONY video camera output connected to the video capture card input and the spectroscope software connected to the camera to introduce the video feedback along with spectroscopic information. This mediates a functional model for exploration of the electromagnetic fields within the layered orbital structures associated with various atoms based on their respective geometries. Blue tooth mediated screen casting to a television in another part of the facility enables remote viewing of the processes operating. This non interactive aspect provides a functional benefit whereby human mediated biphoton emission is eliminated from the feed signals and therefore prevents alternative energy sources from interfering with the video feedback system of the IU MU Transducer. The quasi-quantum nature of the AUP and fuzzy logic learning system of the OpEMCSS take advantage of the system being unsupervised to learn the functional rules to guide the system to the appropriate transitions to obtain the desired functional outcome. Therefore, the signals are inherently associated with the video feedback system free of external influence from an observer. Isolation from biological influence is desirable when learning the IU/MU Transducer rules.

The SUSY DE DM model is a non-interactive logical empirical framework that is self-consistent whereby the conservation of energy rules provides the basis for inverse square law Newtonian framework for single atoms housed in the aromatic ring of various compounds associated with neurotransmitter function and plant phenolics bound to the royal jelly proteins isolated from Manuka honey.

FIG. 13: CRT TV analysis of magnetic field spectral profiling POC using spectroscope and Fraunhofer line analysis. The magnetic fields from neodymium magnets arranged in a hexagonal arrangement with a multi-stack of Nd magnets in a quadrupole arrangement. Effects on the orientation of the north and south pole orientations of the magnets within the CRT 20 keV cathode ray system provides visual observation of the magnetic field orientations and field strength isobaric information related to the strength of the magnetic fields based on the proximity of the field lines. The ability to modify the magnetic fields using changes in position, number of magnets, strength and size of magnets provides the basis for creating various magnetic field arrangements which can be observed directly in real time as changes in the location, orientation, colour and proximity of the field lines as one aspect of the IU MU Transducer. The CRT 20 keV screen provides a simple functional approach to explore magnetic fields and provides the basis for modelling and modulation of the electromagnetic fields and orbital layers of atoms. This facilitates the SUSY inversion singularity physics framework of inverse square law modelling that is integrated into the IU MU transducer system. The ability to visualize magnetic fields in real time and their effects of the spectral Fraunhofer line video feedback system extends the capabilities of the IU MU transducer into magnetic field analysis methodologies which enables a deeper understanding of the gravitational effects operating within single atom systems housed in the aromatic rings of phenolics and neurotransmitters.

FIG. 14: Pinhole lens through aluminum foil layered on top of the CRT 20 KeV TV screen and video loop operating giving a similar effect as the double slit experiment demonstrates a multiple wave feature of light. This temporal cyclic loop light system demonstrates how a single slit experiment using photonic feedback-loop within the IU MU Transducer can explore photonic features and it enables exploration of functional processes operating within light. Integration of the spectral analysis on the separate computer as well as video mixing software/hardware enables combining video output from the spectral input to be used to modulate the specific wavelengths utilized by the IU MU Transducer to generate an atomic system that modulates the atomic structure to transition to a geometric that has useful properties that can be modulated using coherent light (Photonic Input). This multi-pass (light cycling system) allows investigation of both temporal and spatial processes associated with edge effects corresponding to the quantum hall effect and the charge separation associated with the s orbital membrane present in the proton that is connected to the SUSY inversion differential velocity framework that enables exploration of membrane inflationary processes associated with the reciprocal of alpha fine structure constant.

The layering of various metallic sheets and placing a pinhole through multiple layers provides additional functional information relating to the Casimir cavity and its spectral properties and Van der Waals forces associated with hydrophobic interactions between molecular structures. The IU MU Transducer toolbox provides a way to investigate and model atomic systems and the AUP/OpEMCSS provides an automated self-learning system that correlates learned rules to the functional outputs of the atomic system and inputs to enable transitions from stable systems into unstable systems and back again for functionally useful physics. The addition of a sample within the pinhole singularity location provides the basis for interrogation of fluidic samples for their atomic composition based on Fraunhofer line spectral analysis when using the IU MU Transducer with the spectroscopic setup. The modular approach or LENR “toolbox” of the IU MU Transducer, as well as its interactive nature provides the flexibility to analyze a range of characteristic physics-based phenomenon that have been identified with MU physics within the framework of IU modulation within the IU MU transducer. This provides the basis for learning the rules of the IU MU Transducer in a feedback control setup mediated by AUP and OpEMCSS logic control systems.

FIG. 15: Quadrupole arrangement of the magnetic field within the hexagonal neodymium magnetic arrangement observed using the IU MU Transducer 20 keV CRT screen. The magnets are arranged in opposing north south orientations as determined by the attraction or repulsion of an external handheld magnet. CRT TV cathode ray tube analysis of the magnetic field provides a straightforward way to determine the correct quadrupole cross based geometry that is expected to be present within the aromatic ring of the neurotransmitter dopamine. Modelling of the aromatic ring within dopamine and the functionality of the time reversal monopole connection where single atoms are created within the aromatic ring connected to neurotransmitter function. Opposite pole arrangement of the magnets across the ring provided the correct polarities with respect to North and South orientations. The structure of the magnetic field changes since North and South orientations and the layering effects enable increasing the magnetic field strength. The functionality of the magnetic field in the electromagnetic fields within atoms can also be explored along with the energy level splitting associated with p, d, and f orbital layers. The IU MU Transducer provides a simple visualization of magnetic field arrangements to provide a practical way to observe features within atomic structures that are mathematically described but are not intuitively easy to comprehend. Making the unseen visible is a simple feature of the IU MU Transducer.

FIG. 16: Six layered disk stacked face to face and back-to-back with photonic sensitive surfaces with a magnetic quadrupole arrangement demonstrating the functionality of the IU MU Transducer with its internal cavity for the reactor space to explore unusual physics phenomenon associated with unstable atoms. A magnetic strip was placed around the outside of the disks along with Teflon layer and then a copper wire coil and insulting tape. A current was able to be passed through the coil to affect a weak magnetic field. Neodymium magnets were placed around the outside as well as either side of the disks to explore the magnetic fields on the CRT setup of the IU MU Transducer in the exploration of photonic feedback with magnetic field modulation. B: The generation of circular magnetic fields and a ring magnet on the CRT 20 keV screen. A functional model of s orbital layers and the central sphere within the center point as an inverted system. C: IU MU Transducer CRT screen demonstrating changes in magnetic field coloration associated with magnetic field orientation. Geometric features of North South pole orientation. The balancing of the electric and magnetic fields in the quadrupole arrangement corresponds to the positron and electron pairing in the s1 orbital layer of hydrogen in the SUSY DE DM framework. The L=0 angular momentum in the s orbital layer of hydrogen giving a different functionality to the hydrogen atom in the generation of unusual physics processes in biological systems giving rise to unstable atoms.

FIG. 17: Spectroscopic analysis of the central location within the stacked disk quadrupole arrangement. The quadrupole disk arrangement was placed onto the CRT screen to examine the magnetic orbitals. The spectroscopic camera was arranged in the central area of the disk setup. The corresponding spectral line information was analyzed and compared to a reference standard for demonstration purposes. Changes in the magnetic fields based on changing the light-loop zoom functionality of the IU MU Transducer provided disturbances in the magnetic fields through electromagnetic modulations. Spectroscopic information associated with such magnetic field changes were recorded with the IU MU Transducer to evaluate the central location in the quadrupole disk setup (FIG. 16).

FIG. 18: Inverse square law gravitational model for atoms 1 s orbitals.

The observation that nm vs. kJ/mole corresponds to a power law slope where the slope=119627, when squared and the reciprocal is determined equals 6.98782 E−11, which is like G=6.67 E−11 kg⁻¹ m³ s⁻². Having a suitable approach to explore gravitational processes within atomic structure provides a significant advancement in being able to integrate the missing force to explore the subatomic processes operating within atoms. This is different from the quantum mechanic's approach. The SUSY inversion model offers and alternative to QM on an atomic scale by utilising the features of GR within the atomic dimensions. This inverted process connects to a DM differential square root velocity system and allows comparative analysis between inner and outer velocities through inversion (reciprocal functionality) and connects approach to a Newtonian inverse square law and a method for understanding energy conservation.

FIGS. 19A and B and C and D (spectroscopic signals). Single atom photonic signal from laser 488 nm excitation. The concentric ring system FIG. 22A corresponding to an atomic model of s orbitals in hydrogen atom. It is proposed from the SUSY inversion model that the DE DM system associate with isotope decay of alpha particles corresponds to spherical emission processes with DM recoil into the daughter atom down to the singularity 1.6 E−35 m. The concentric ring distribution and distances correlating with an nm/kJ/mole (m/s) IW output from the unstable atom (isotope) generated within the atomic ring of the phenolic bound to the royal jelly protein isolated from Manuka honey (INCI: MEL-RJPI).

Spectral properties of the waves based on spectroscopy provide Fraunhofer information to determine the potential atom responsible for the atomic decay. The concentric features provide s orbital layering, and the rules of the IU are inferred by the input/output T delay time (isotope half-life) correlated to binding energy (nm to KJ/mol (m/s)) velocity IW output. In FIG. 19B the spectral information is linear corresponding to temporal features of isotope physics half-life transitions mediated via input laser 488 nm and output isotope decay timings corresponding to a temporal and spatial set of parameters correlated to a specific isotope of a specific atom. The IU/transducer takes such signal inputs from atomic decay LENR outputs from the functional biological materials and identifies the temporal and functional aspects of the output signal which is processed to allow identification of the nuclear process (type of decay mode) and IW KJ/mol binding energy dataset (theoretical model SUSY inversion DE DM) to give atomic identification (like spectral analysis in cosmological composition of stars and galaxies. The single atom atomic light systems operating within the aromatic ring (Faraday cage) system providing the IU interface in unconscious mind physics mediated temporal and spatial resolution. The input signal and output signal are functional parameters that enable learning and response timeframes as modulated sensory inputs giving rise to functional changes in the IU/MU transducers functional outputs. The learned responses giving rise to functional changes and comprehension of the IU rules. Repeatability and systematic adaptation to environmental selective processes within the IU atomic processor unit framework giving rise to the responsible rules in the MU output (IU/MU exhaust).

FIG. 20: Thermogravimetric analysis of colloidal protein and highly fluorescent pollen grains isolated from Manuka honey (inserted image FIG. 20). Above 1100 degrees Celsius there is a reduction in percentage weight (green line) corresponding to −84.55% at 1285.74 degrees C. Negative mass generation associated with faster than light processes in IW IU process based on nm MeV calculations on conversion into kJ/mole (m/s) velocity connected to DE/DM SUSY inversion model and the original atomic inflationary system wherev>c within the tunnelling of the atom which is connected to the photo-Fenton chemistry system converting the pollen phenolics into CO₂ and water as part of the pollen germination process and ovum fertilization.

FIG. 21: The modulation of light phase-shifting in the light-loop IU MU Transducer setup provides the system in an unstable state where there is a phase shift. Video footage https://youtube/sv2hJO2AcIE The stabilization of the phase shift is obtained using coherent laser light of 405 nm+/−10 nm. The positioning of the handheld laser to reflect at 45 degrees off the mirror and its temporal positioning provides the coherent laser light into specific temporal and spatial locations within the light-loop whereby the initial motion of the trapped photon moves Up the corresponding second image in the light-cycle motions Down. The corresponding alignment of the coherent light source that positions the laser light into a superposition (overlapped colocation) within the light-loop cycle creates stabilization of the phase-shifting phenomenon. This provides context for the balance between the electric field and magnetic field at 45° (angle of the mirror) and the location of the neodymium magnet on top of the CRT screen giving the magnetic field image in the superposition of states separated by the magnification of the video camera and the differential Hz cycle frequency of the CRT screen and Sony Digital video camera. The interactive features of the IU MU Transducer offer photonic interactions within the magnetic fields corresponding to inverse square law positioning of photons in an electronic configuration of orbitals.

FIG. 22: Spectroscopic input and modulation of the signal using laser input. The stabilization of the photonic signals corresponds to the arrangement of the coherent laser light in such a way that it entrains the functional motion of the electronic system to prevent the oscillation of the feed-back loop in the light operating system within the IU MU Transducer. https://youtube.com/shorts/eGiN4LdB4Ws?feature=share

FIG. 23: Laser light triggering of photonic cycling. Arrow highlight laser magnification and the small dot in the middle of the screen corresponds to a physical neodymium magnet. The ability to interact with the magnetic oscillation of the photonic field provides a dynamic interactive E/M process that offers insight into the atomic processes within the atoms magnetic field properties. The spectroscope captures the photonic wavelengths associated with the image and the delta change in field dynamics can be stabilized using the laser coherent light. This provides a controller interface based on laser light and an output photonic spectroscopy where the delta change describes the level of instability within the system being investigated. The geometric alignment of the laser interaction offers a stability using coherent light.

FIG. 24: Position and motion of inverted atomic layers. The arrows indicate the photon direction of motion.

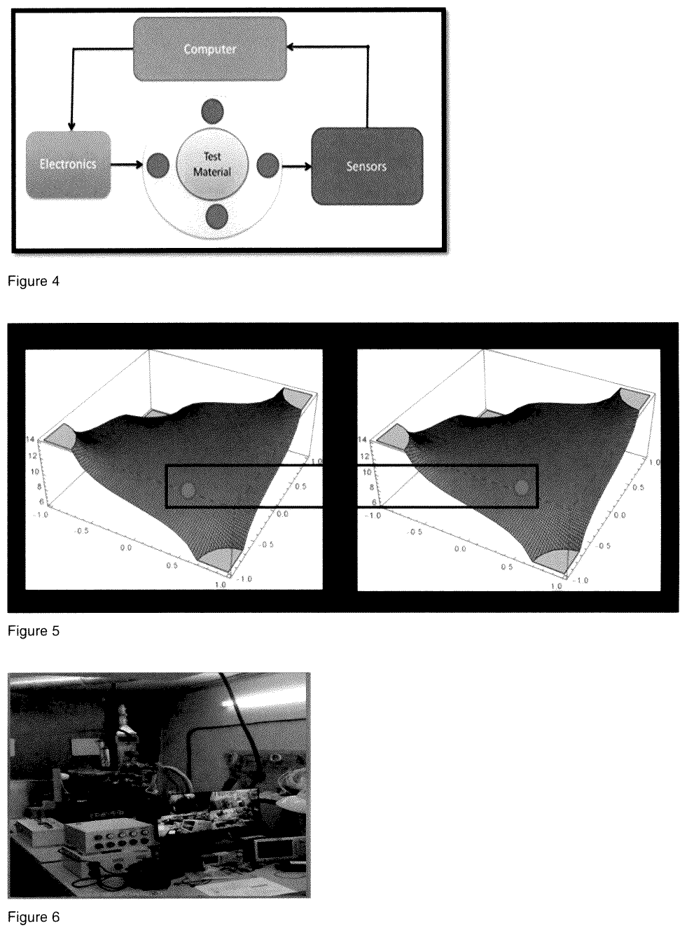

The packets of electromagnetic particles are observable as discrete objects. The temporal layering in the light-feedback loop within the cyclic photon system (point light source—laser light shown by the arrows in FIG. 4) demonstrates functional motion in one-layer results in the opposite motion in the next layer. This suggests that an equal and opposite set of functions are operating to distribute the energy within the system so that a new equilibrium point can be reached with the least amount of change distributed throughout the photonic system. This appears to offer a conservation of energy within the system that operates collectively in the distribution of the energy. The reorganization of atomic structure is not localized in only one layer but within the entire system. It provides the idea that the atomic system is not rigid in its orientation but has an ability to rearrange its own geometry to accommodate additional energy from external sources. This external modulation of structure provides the basis for having the ability to photonically modulate the inner structural arrangement of the atom based on external photonic input of coherent laser light.

### Features of the Photon Particles.

FIG. 25: Photonic layering and differential direction of motion through photonic light-layers within the IU MU Transducer https://youtube.com/shorts/-57sK1rV_vA?feature=share. The position of the motion of the photon (laser particle input coherent light source) into the IU MU Transducer provides an equal and opposite arrangement of functional motion between each respective photon loop cycle giving the functional motion of light in both a temporal and spatial arrangements. The central magnetic field and its geometry provides the observable magnetic field orientation and the magnification on the video camera and live feed into the CRT 20 keV cathode ray tube provides an energy system making the magnetic fields observable at various magnifications based on the zoom function on the camera. The positive and negative feedback modulation of the observed signal can be mediated by the wavelength input of the laser giving rise of oscillations of the colour cycles through the temporal layering of the photonic-light feedback system of the IU MU Transducer. These features offer insight into spectral electromagnetic fields connected to the s orbital spherical layers containing 4 particles two electrons and two positrons as identified by the SUSY inversion DE DM model. The revision of quark charge calculations providing a Baryonic symmetry model that accounts for the missing anti-matter in cosmology. Through the discovery of the positron associated with the neutron in atomic theory the correct starting parameters can be identified for the beginning geometry of the universe at TO. The separation of the electron and positron by the reciprocal of the alpha fine structure constant (137.036), a dimensionless number, provides the connectivity to the proton's geometry in the subatomic structure of the atom at the n=1 layer of Lyman line and the expansionary process connected to the Km analysis performed. The analysis of the s orbital layers in the proton giving an inverse square law functional geometry associated with an inverted symmetry system operating within the atoms structure. The atomic expansionary process is identified as being directly connected to the 91.2 nm location within the Bohr model of the hydrogen atom.

FIG. 26: The membrane structure of the proton orbital at n=1 corresponding to the Casimir cavity and Quantum Hall effect of charge separation within the reciprocal alpha fine structure constant expansion associated with Km and Vmax differential velocity analysis.

FIG. 27: Changes in photonic positioning within the light-loop IU MU Transducer system. https://youtube.com/shorts/ETHvxn2V_SM?feature=share. The interactive features of the IU MU Transducer enable exploration of the various layers corresponding to different degrees of magnification. Changing the angle of the camera with respect to the image on the screen magnifies the location within the light-loop layers. This functional exploration of the corresponding position relative to a central location provides the basis for the utilization of an internal reference point corresponding to the Planck singularity at (0,0,0) at (x,y,z) and this location is the internal access doorway to the vacuum of space and the permittivity and permeability of space itself identified by 1/c². This is also connected to the Dark Matter Planck mass system corresponding to 85% of the mass of the universe. Having such a framework offers additional insight into the symmetry at this point whereby it provides an inverted pinhole camera functionality corresponding to inversion and mirror symmetry seen in chirality of W Boson mediated atomic beta decay where the handedness of positrons and electrons is a functional outcome of the antineutrino (right-handed) and neutrino (left-handed) due to the rules of the conservation of angular momentum.

FIG. 28. Schematic diagram of the power supply (modulator).

FIG. 29: Initial ferrite core of 25×15×10 mm and shuttle for winding the wire.

FIG. 30: Core with a winding of 100 turns of 0.35 mm wire. On top of this winding are two layers of glass fiber tape for electrical insulation.

FIG. 31. A finished transformer with three windings FIG. 32. General view of the breadboard of the high voltage source (modulator).

FIG. 33 A typical oscillogram of the voltage at the anode of the reactor, the amplitude is 530 V at a modulator frequency of 13.4 kHz.

FIG. 34. Photo of the TNLT reactor with magnets in the NS-NS attraction configuration.

FIG. 35. Reactor with BS-SN magnet configuration.

FIG. 36. Attempt to expose X-ray films using indium activation, (metal rectangular sample between reactor and films).

FIG. 37 shows a piece of metal indium with a Geiger counter installed next to it.

FIG. 38. Reactor operation together with a 450 nm, 10 watt laser.

FIG. 39. Graph of Geiger counter operation, vertical line—number of pulses per minute.

FIG. 40. Pulse counting graphs from Geiger counter, neutron scintillator and neutron counter of SNM-19 type on Helium-3.

FIG. 41. Reactor with X-ray detector.

FIG. 42. graphs from top to bottom: X-ray, neutron scintillator, SMN-19 counter

FIG. 43. Reactor with X-ray detector and indium sample between reactor and detector.

FIG. 44. With indium. Graphs: X-ray, neutron scintillator, SMN-19 counter.

FIG. 45. Using copper and X-ray films in combination with an X-ray detector.

FIG. 46: X-ray films developed after the reactor operation. There is a slight moire, but it does not match on both films and does not repeat the shape of the copper plate.

FIG. 47: Graphs of the result of the hourly recording. The reactor was on for 11-21 minutes and 31-41 minutes.

FIG. 48: TGA analysis of MEL-RJPI. Royal jelly proteins were isolated from Manuka honey using ion exchange chromatography. The protein materials were freeze dried to generate a powder. The powder (0.93 mg) was placed into a pan for TGA analysis. The sample was taken from room temperature to 1300° C. The royal jelly proteins contain several covalently linked polyphenolic materials along with MGO modifications on Lys, Arg and Cys, amino acid residues. The phenolic contain coordinated minerals. The functionality of the minerals provides the basis for the unusual properties of the freeze-dried powder above 1000° C. The percentage weight of the original sample at 902.81° C. is 23.52% whereas the percentage weight of the material at 1285.74° C. is −84.55%. The temperature change of 382.93° C. from 902.81° C. to 1285.74° C. resulted from a loss of −108.07 percentage weight loss. The material had already lost 76.48% from 0 to 902.81° C. The unusual mass reduction properties of the biological material are proposed to arise from the coordinated mono-atomic minerals associated with the phenolics bound to the royal jelly proteins isolated from Manuka honey. Exploration of the location of the minerals resulted in the discovery of unstable atoms within the rings of the phenolics that could be examined using a range of methodologies. Analysis of the phenolic materials using traditional biochemical means identifies the compositional information regarding the royal jelly protein powder. SDS PAGE identifies the protein compositional information, MALDI TOF MS providing the modifications of the proteins by MGO and phenolic components.

FIG. 49: Minerals present in the royal jelly protein preparation.

FIG. 50: SEM analysis of MEL-RJPI after TGA analysis

FIG. 51: EDS analysis of MEL-RJPI after TGA analysis

FIG. 52: Particle analysis of MEL-RJPI using NanoSight

FIG. 53: Particle analysis of MEL-RJPI using NanoSight and wave features. The unusual photonic effects observed under the Nanosight microscope provides the basis for exploration of the biological material with the IU MU transducer.

FIG. 54: Quantum coherent fluid (metamaterial) that is analyzed using UVA excitation. A: UVA excitation and B: Bright field white light. Quantum coherent water generated by photo-Fenton chemistry using processes that are biologically relevant to apoptosis processes occurring within multicellular biological systems. This unusual physics can be examined using the IU MU Transducer to explore the generation of coherent states of water generated using electromagnetic modulation of water structure. The water responds to electromagnetic energy by changing its, geometry. It captures photons from UVA electromagnetic wavelengths at 365 nm and when exposed to bright field releases the captured photons. The structural features of the quantum coherent water are unknown. The molecules are broken down by the photo-Fenton chemistry leading to the formation of the unusual characteristics of the metamaterial that changes shape based on light mediated inputs.

FIG. 55: Gold leaf (layer 1), copper leaf (layer 2), silver leaf foil (layer 3) were overlayed on top of one another as three separate sheets with nothing binding them together.

FIG. 56: Photo-Fenton chemistry reaction. A: The four samples of royal jelly protein isolate. B: The addition of one crystal of Fe2+ and 10 microL of 30% H₂O₂. C: Blue 5 mW laser excitation of the solution along with a red laser 650 nm. Acceleration of photo-Fenton chemistry observed by the increased number of bubbles formed within the sample on top of the sliver foil.

FIG. 57: Post reaction fusing of the metal foils together. A: After overnight incubation at room temperature. B: Wider view of the completed reaction after overnight. C: Bottom gold foil underneath the reaction mixture. Pulling the foils apart was impossible. The reaction mixture had fused the three layers of the different metal foils together. The underlying plastic paper sheet was not connected to the metals. The unusual chemistry was able to bring together the three layers of the different metals. Photo-Fenton chemistry is known to support quantum tunnelling. The use of the silver foil to generate an emitted electron from the metal surface using the photo-electric effect would facilitate the photo-reduction of the mineral iron that is coordinated the phenolics within the sample applied to the silver layer as a droplet.

FIG. 58: Spectral analysis of photonic excitation of foil with various lasers

FIG. 59: Detection of magnetic fields using CRT 20 kEV setup on the IU MU Transducer. The orientation of the magnetic fields was identified by positioning the neodymium magnets in a hexagon arrangement associated with the hexagon aromatic ring present in the phenolics bound to the royal jelly proteins isolated from Manuka honey. The identification of a magnetic inverted cross and central position within the ring provided visual evidence for the potential quantum location of single atoms within the rings of the phenolics. The capture and storage of light inside of the aromatic ring appears to be a functional environment for unusual physics that the IU MU Transducer can be used to explore what is happening within the aromatic ring system.

FIG. 60: Photonic feedback on the CRT 20 keV screen and modulation of magnetic fields

FIG. 61: Combining the IU MU Transducer with spectroscopic analysis (POC)

FIG. 62: Fluidic properties of the aetheric field obtained in the central region of the video feedback loop.

FIG. 63: IU MU Transducer photonic feedback and the central singularity location

FIG. 64: IU MU Transducer singularity wavefunction

FIG. 65: Spectroscopic evaluation of IU MU Transducer photonic cycle feedback

FIG. 66: IU MU Transducer spectral data for analysis of unusual physics

FIG. 67: IU MU Transducer 3D visualization of photonic feedback. B: Background

FIG. 68: Information wave in the IU MU Transducer as a photonic feedback system

FIG. 69: IU MU Transducer feedback wave passage through the 3D visualization

FIG. 70: Gravitational inverse square law calculation for Balmer line electron transitions in the hydrogen atom obtained by plotting nm vs. kJ/mole (m/s) velocities. The slope was a power law function of x⁻¹ and the slope of 119619 (m/s)/nm. The inverse square law process provides the following calculation of 119619²=1.43 E+10 and 1/1.43 E+10=6.99 E−11 corresponding to the gravitational processes operating within the hydrogen atom in the Balmer line transition. G is 6.67 E−11 kg⁻¹ m³ s⁻². The power law relationship between nm and KJ/mol provides a tool to explore gravitational processes within single atoms and this is based on the differential velocity relationship provided by the nm distance away from the Planck reference giving a m/s velocity.

FIG. 71: Lineweaver Burke plot of space kinetic analysis for the hydrogen atom based on the double reciprocal plot of differential velocities operating within the s orbital layers of the hydrogen atom. The slope (Km/Vmax) and the y intercept (1/Vmax) were utilized to identify the Km and Vmax for the hydrogen atom based on the known electron transitions. Utilizing the nm to KJ/mol (m/s) velocities gave rise to useful kinetic properties of the hydrogen atom.

FIG. 72: The atomic rate of inflation within the hydrogen atom associated with the power law golden ratio. The inverted Planck scale singularity enables exploration of isotope physics decay systems corresponding to various transitions based on the isotopes half-life timings along with their binding energy in MeV. The Binding energy is converted into eV, nm, and KJ/mol. The navigation processes of nm to KJ/mol allows exploration of the isotope decay systems as functional transitions mediated through temporal half-life timings that utilize energy conservation rules based on the He-BEC isotropic singularity model.

FIG. 73: S orbital atomic inversion through concave lens of Lyman line electron transition.

FIG. 74: DVD-R analysis of photo-Fenton chemistry and the formation of emission lines on the DVD polymer. A: DVD-R disc, B: MEL-RJPI 10 microL droplet placed onto the surface of the disc, C: Fe2+ added and H₂O₂ added, D: internal bubble formation indicating photo-Fenton chemistry, E: Further reactions, F-M: blue light and red light laser excitation of reactions, N: Overnight finished reaction, O: Magnified reaction product looking like honey, P: Red laser illuminated surface of DVD-R disk, Q and R: Surface lines on DVD-R disc.

FIG. 75: Spectroscopic analysis of Photo-Fenton chemistry on the CRT TV 20 keV electron quadrupole setup

FIG. 76: IU MU Transducer comparative analysis using AUP/OpEMCSS and SUSY DE DM

FIG. 77: Iron oxidation states

FIG. 78: Fenton chemistry reaction with graphene tissue paper+hydrogen peroxide and Fe2+. Arrow represents a Fenton chemistry sphere which is expanding due to the generation of CO₂ and water in the breakdown of the tissue paper and the introduction of quantum tunnelling energy into the graphene ring energy capture system. Arrows in image 11B shows individual small spheres of Fenton chemical reactions merging into the larger bubble sphere.

FIG. 79: Microscopic analysis of the solution after photo-Fenton chemistry of the square 1 cm filter paper with graphite material on its surface. Horizontal arrows graphite sheets. Vertical downward arrows cellular fibers. B: Laser excitation 405 nm

FIG. 80: Excitation with a red laser 650 nm
Table 1: Spectroscopic video and analysis of timestamps associated with wavefront and wave-rear timings.
Table 2: Differential time in between the waves
Table 3: Statistical analysis of differences of the primary wave data
Table 4: Time differences between waves detected on the spectroscope in the IU MU Transducer
Table 5: Balmer line electron transitions
Table 6: The velocities are analyzed using differential velocity analysis.
Table 7: The differential velocities were then converted into nm distances.
Table 8: The numbers correspond to the electron transitions of the other hydrogen series at longer wavelengths. The Lyman series was converted into KJ/mol from nm.
Table 9: Electron transition series based on differential velocity analysis of positron electron pairing
Table 10: Differential analysis of changes in velocities
Table 11: Parameters Km and Vmax for the hydrogen atom
Table 12: Expansion rate of hydrogen atomic inflation

### DETAILED DESCRIPTION OF THE INVENTION

The combined Information Universe (IU) and Material Universe (MU) is a feedback control system where the IU regulates the MU. An analogy is the heating system in your house. The IU is a continuous process of temperature measurement, and the MU is the furnace system plus your house. If the temperature goes above a set value, the furnace is turned off. If the temperature goes below a set value, the furnace is turned on. For the IU/MU system discussed in this paper, the IU is a set of concurrent processes that continuously measure various aspects of the MU and institute changes in the MU to return to setpoints. This system must exist as described; otherwise, random disturbances would allow the MU to return to chaos. It has been observed [3,4] that IU/MU system regulation eliminates errant system states that violate the laws of physics (IU rules). An experiment is proposed where a quadrupole system creates disturbances in target matter in the MU producing an IU response. This experiment is described, and the mathematics of the IU response is discussed.

IU responses are modelled using SUSY DE DM systems to compare theoretical with actual spectral Fraunhofer data for IU responses to MU imbalances.

IU rules developed based on Baryonic symmetry, charge parity, mass parity, time parity and space parity. The He-BEC isotropic singularity model generating DE and DM has been identified based on the revision of quark charge calculations for Baryonic symmetry. This novel approach based on non-interactive logic provides the basis for the inclusion of positron in atomic structure. This approach differs from the standard model of particle physics and provides the basis for being able to explore and understand the universe without having to measure it directly, thereby enabling the system under investigation to be at an equilibrium point which equates to the proposed Baryonic symmetry state. This has resulted in the inclusion of positrons in atomic structure. The discovery of anti-matter within the atom structure provides the basis for a new geometry associated with atom theory. This new mirror symmetry model and framework provides the basis to explore atomic structures of atoms and isotopes within the confines of the aromatic ring system where only one atom can reside due to confinement, which simplifies analysis and learning the IU MU rules. The IU system identified because of Baryonic symmetry provides a transition mediated by alpha particle decay into Dark Energy (DE) and Dark Matter (DM) and then another set of decay transitions into the generation of Matter (M). Matter has been studied extensively based on atoms having protons, electrons, and neutrons but not positrons. This simple biological framework for atoms has limited our understanding of biology. This novel approach to atomic structure implies a foundational change in atomic theory through the inclusion of positrons in atomic structure associated with the neutron. The addition of the positron therefore provides additional information that can facilitate the discovery of further information about atoms and how they operate at subatomic levels. Evidence of features operating within the IU system that cannot be explained by the existing model corresponding to the Standard Model of Particle Physics can now be explored from a new paradigm in atomic theory. The additional features described by the inclusion of positrons includes the discovery of the missing anti-matter in cosmology, the discovery of the identity of dark energy and dark matter and a model that can describe the composition of the universe 13.82 billion years after its beginning through the emission of alpha particles from helium with a known half-life of 1 E−18 seconds. The original structure of the universe has been modelled based on the parameters of a Helium Bose Einstein Condensate (BEC) singularity. Its associated features offer further information as to the IU operating system and the functionality that the IU system uses to modulate, regulate, and control the MU system. It is these functions, rules and features that the IU MU Transducer toolbox, which enables the discovery of a set of functional rules learned by AUP and OpEMCSS through the interactive feedback analysis of the processes operating within atoms corresponding to the LENR systems that are operational in biological systems and connected to aromatic ring complexation chemistry and the proton tunnelling system.

As an example, there are features of subatomic systems that appear to be defined in the Standard Model such as the electron elementary charge. The feature of elementary charge of the electron is normalized to a negative 1 charge in biology. This treatment of charge provides an oversimplification. Charge therefore becomes a normalized function of the electron. When charge is treated in this way a barrier to deeper understanding has been put in place. The consequence is that charge is an unknown functional property of the electron and it cannot be associated with anything tangible in terms of the electrons characteristics in the subatomic dimensions of the electron. The electron is treated as a point particle in the standard model of physics. The electron becomes more Newtonian in biology, where it is associated with the proton where the Bohr model corresponds to the electron location of 91.2 nm Lyman line electron transition. The quantum mechanics representation of the electron is more in terms of uncertainty and a statistical model of its wavefunction and the probability of finding it at a specific location is determined by squaring the wavefunction.

The SUSY inversion model treats the electron differently. The temporal half-life feature of alpha particle emission corresponding to the correct composition of the universe after 13.82 billion years has a functional area function (πr²) corresponding to s/7 πs²=3.18 E−19 C/2=1.59 E−19 C which equates to the surface area of the electron. This correspondence to charge reflects the subatomic features of the electrons diameter as 4 E−18 m. The half-life (s)/Area relationship (s²) corresponding to the electron charge provides context for the features of the electron being directly related to how the universe has evolved. These subatomic features of the electron provide an ability to explore the subatomic features of atom theory connected to cosmological composition of the universe and the processes of isotope decay physics that have led to the current known composition of the universe.

In the SUSY inversion model the electron is treated as a spherical particle with a surface area, a circumference, an area, and volume. An internal concave surface and an external convex surface. The radius corresponding to 2 E−9 m and the inverse square law functionality associated with the surface area calculation provides the basis for a concave inner surface area and a convex outer surface area. The area calculated based on inversion to 5 E+8 m corresponds to 3.141592 E+18 and the inversion (reciprocal) gives 3.18 E−19 m corresponding to the temporal functionality attributed to the half-life timing of the alpha particles emitted from the He-BEC isotropic model and provides the connection to DE and DM systems that predate electron formation. Such a model provides an underlying reason why the elementary charge is what has been determined experimentally but does so mathematically based on the radius of the electron using inverse square law as well as the temporal features of the universe based on, He-BEC isotropic singularity alpha particle half-life of 1 E+18 seconds that provides the correct parameters based on the age of the universe of 13.82 E+9 years to link the composition of the universe to the electrons elementary charge. This feature of the IU therefore predetermines a feature of the MU electron structure in terms of elementary charge being associated with the surface area of the electron. This is one of several features of the SUSY DE DM framework that enables feedback control regulation in the IU MU Transducer.

### Agent-Based Model of the IU/MU System

The combined Information (IU) and Material Universe (MU) is a feedback control system where the IU regulates the MU. An analogy is the heating system in your house. The IU is a continuous process of temperature measurement, and the MU is the furnace system plus your house. If the temperature goes above a set value, the furnace is turned off. If the temperature goes below a set value, the furnace is turned on. For the IU/MU system discussed in this paper, the IU is a set of concurrent processes that continuously measure various aspects of the MU and institute changes in the MU to return to setpoints.

Expanding our system science model, the IU is a network of Intelligent agents that generate the concurrent processes that regulate the MU. A network of intelligent agents can implement any context-sensitive language by learning the rules. According to [14], the IU is described by such a language. In this model, each agent receives messages from the MU and other agents. Each agent applies these messages to select a rule to fire. These rules specify actions to be taken in the MU to restore correct operation and messages to be sent to other agents. The result is a continuous and coordinated set of process threads to regulate the MU in a universal and coordinated manner. Indeed, these agents work locally, for example on cell DNA, but coordinate with other agents throughout the MU [4,13].

Given the IU/MU system message passing interface described above (what the system does), a more detailed view on how matter and living cells in the MU communicate with the IU is based on the existence of a temporal T field discussed below. We believe that continuously transmitted status, information wave signals (T field) are monitored, using intelligent agents, as discussed above in the systems science model of IU/MU system operation.

Using this model, agents detect changes in MU status which trigger rule execution [4]. The correct rule fires, given the MU status information received, specifying the correct IU action to make changes. The model discussed in [4] provides a detailed explanation of how these intelligent agents process MU status data to make system control decisions.

Expanding the model description, intelligent agents are organized in a network to create communicating context-sensitive processes that interact to consistently regulate the MU universe. Local MU changes must be consistent throughout the MU universe [1,3].

This system must exist as described; otherwise, random disturbances would allow the MU to return to chaos. It has been observed that IU/MU system regulation eliminates errant system states [2,4] that violate the laws of physics (IU agent rules) and reduce entropy. Recall, the second law of thermodynamics states that entropy never decreases in an isolated system left to spontaneous evolutionary processes and will always reach a state of thermodynamic equilibrium where the entropy is maximum. However, the IU/MU system, as described as a feedback control system, is a non-isolated, evolutionary process that is under regulation such that entropy is continuously being minimized. It has been observed that IU/MU system regulation eliminates errant system states [4, 5] that violate the laws of physics (IU rules). Such regulation is like a communications channel [12, 14] where most messages (system states) can never happen (low entropy) or another non-regulated system where all messages are equally likely (maximum entropy). For any disturbance created by our project, the IU response must comply with all physical laws, including the conservation of energy [12]. This includes IU/MU system responses that up to now have been unknown (new physics).

Of further interest is that both Shannon and Gödel's theorems point to the existence of a sentient hierarchy of self-organizing structures dynamically evolving [3, 9, 14]. A paper on Research Gate [5?] “Evolution of Information Universe Rules to Regulate the Material Universe Quantum Stability: Simulation Model” or Clymer, J. R. 2017. Mathematics OR Complex Adaptive Systems, Int. J. of Design & Nature and Ecodynamics. Vol. 12, No. 3, 377-384 demonstrates how rule learning AI software based on evolutionary algorithms can learn the rules of physics that minimize entropy in the MU. Interestingly, the simulation implied that the rule selection criteria must be provided by a higher intelligence outside the IU hence Gödel's theorem [2]. Further, useful rules could not be learned unless there was a constant low level disturbance present [2, 13, 14]. The quadrupole system experiment will be used to show how a model of the IU/MU interface can be learned.

One model of the quadrupole system is the hydrogen atom. Its geometry can be modelled using a variety of different approaches. The Bohr model describes one model of hydrogen. The quantum mechanical wavefunction has a variety of wavefunction structures that provide probability maps for location of the electron in the orbitals of hydrogen. The SUSY inversion model provides a new model for hydrogen that is represented by an inverted cross, where positron and electron pairs are positioned within an electromagnetic framework. This geometry of the hydrogen atom functions to enabling the electromagnetic fields to be arranged in positioning the electron and positron pairs within the s orbital at 90-degree angle corresponding to the electromagnetic field interaction of the E field (electric field) and the B field (magnetic field). The Positive and negative poles and the North and South pole of the magnetic field are opposite one another so that the attractive electric field is repelled by the opposed magnetic field and charge repulsion is counterbalanced by the attractive force of the magnetic fields of opposite poles. In this equilibrium arrangement all forces cancel out one another, and the system is observed to be at the point of an equilibrium. This SUSY inversion state of hydrogen when the IU MU Transducer arranges the poles and charges in such a way that the s orbitals no longer has a magnetic field as the spin −½ and ½ of the two electrons and spin −½ and M of the positrons cancel each other out. There is no energy level splitting in the s orbitals but there is the Lamb Shift associated with the position of the electron with respect to the inverse square law function operating within the gravitational processes operating within the hydrogen atom. The Lamb shift offers insight to the magnetic field generated by the electron itself and what effect that has on its proximity with respect to the n=1 layer at 91.2 nm. The n=2 layer is expected to be at 364.8 nm but the literature indicates its measured value is at 364.5 nm. This 0.3 nm difference corresponding to the model's ability to predict the Lamb Shift based on inverse square law of s orbital locations within the hydrogen atom and the actual measured position.

The model also provides a way through which to explore the gravitational properties occurring within the atoms inner structure. By plotting nm versus kJ/mole a gravitational slope can be obtained that when squared and inverted (reciprocal) calculations are performed equates to a gravitational velocity corresponding to G. The model therefore offers something that is novel in terms of atomic geometry as well as features within atoms that are novel in terms of the calculations in how they are performed, and this provides the basis for the eV to nm relationship for hydrogen that is established for differential velocity and its relationship to c³ and v³.

In the s orbital geometry, the positron and electron positions provide a model whereby under such an arrangement the motion of the electron is mirrored by the motion of the positron and the visa versa. So that every action has an equal and opposite reaction between the motion external to the single atom equilibrium point and the internal balance of the atom's geometry in a Baryonic symmetry state can be identified. This geometry is proposed to correspond to a geometry suitable for quantum tunnelling because the magnetic fields of s orbitals are cancelled under such a configuration within the s orbital. It is important to consider entropic principles of a single atom systems occupied within the aromatic ring system in terms of the isolated environment in which the atom evolves over time. A functional input into the aromatic ring from the amine NH3+ system of dopamine provides a suitable atomic functionality of proton carrier and inversion of amine structures provides a tunnelling system to deliver the amine proton into the aromatic ring. The addition of one hydrogen at a time into the aromatic ring provides the basis for an atom manufacturing facility within the aromatic ring using functional atomic transitions between stable and unstable atomic states. The geometry of hydrogen in the cross based inverted geometry provides the atomic input into the ring.

The temporal and spatial relationships can be investigated as a theoretical model due to the mathematical language developed as part of the comparative analysis of IU/MU transducer functionality. This comes about through the unification of AUP/OpEMCSS/SUSY DE/DM modelling. It is proposed that the singularity at the center of the nucleus acts as a pinhole camera inverting the image of one side of the atom with the other side of the atom (SUSY inversion DE DM framework for quark charge calculations). This provides a model for Baryonic symmetry and an equal amount of matter and anti-matter separated from each other to prevent annihilation but still able to interact to provide reciprocal interaction through opposite motions and charges. The opposing side therefore is inverted through mirrored symmetry. Inverted in this case outlines a reciprocal calculation of (1/x=x/1), where the “equals” sign corresponds to the Planck scale singularity 1.6 E−35 m. Such a framework for the atomic singularity provides the basis for charge parity and the approach undertaken to determine the SUSY inversion quark charge calculations to maintain an overall parity of charge in DE and DM to equal zero. The transition from the He-BEC isotropic singularity into DE and DM corresponds to the generation of no charge. This equates to alpha particles having no charge and this corresponds to particles travelling without deviation through gates of charged plates (positive or negative).

The current Standard Model for alpha particles provides the basis that alpha particles are positively charged (2+) because they contain two protons and two neutrons, where the neutron has no charge, and the proton has a positive one charge. The revision of quark charge calculations for SUSY inversion suggests that neutrons are negatively charged, and the proton has a positive charge. Therefore, the SUSY inversion calculation identifies that alpha particles have no charge and therefore have no magnetic moment and are therefore difficult to detect. The dark matter generated during alpha particle emission corresponds to the daughter atom recoil. This is where charged plates in the IU MU Transducer can provide characterization of alpha particles and the DE and DM system due to the generation of alpha particles which are equivalent to dark energy and the recoil of the daughter atom contains the DM energy that travels inward towards the Planck scale singularity at 1.6 E−35 m.

The mathematical language of isotope decay provides the basis for the agent network whose instructions are provided by the original geometry of the helium Bose Einstein Condensate homogeneous isotropic singularity whose features describe the cosmological constants of nature. The IU/MU transducer and quantum coherence light operating system within the developed quantum computer enable evaluation of functional systems science methodologies to produce context sensitive set of instructions that reference the Planck scale singularity at the center of the atom at (0,0,0). This instruction set can be explored through a reciprocal language of energy conservation and differential velocities to provide an instruction set of rules outlined by the IU as the communication features for the IU MU Transducer exhaust.

The IU rules are featured in Table 1.
Charge parity. Given by SUSY inversion quark charge calculation for proton and neutron where the Up quark=−1 and the Down quark=+1. Multiplication is used to determine quark charge calculations. Giving rise to a negatively charged neutron with its associated positively charged positron and the proton is positively charged with its negatively charged electron. This is a Baryonic symmetry atomic model. The entanglement of protons with electron and neutron with positrons gives the features of an inverted symmetry system whereby −1 electrons become positively charged down quarks and positively charged positrons become negatively charged Up quarks.
Energy conservation. Obtained through inverse square law rules where 1/√v=√v/v
Time parity. Where negative time dilation v>c is balanced by positive time dilation c>√v
Mass parity. Where positive mass c>v and negative mass where v>c are balanced.

### SUSY Inversion DE DM and the Use of IU Rules

A mathematical framework based on an empirical non-interactive logical model has been created which comprises a systematic approach to identifying all components of the universe. The non-interactive approach monitored by AUP provides a logic gated quantum correction for the functionality of the SUSY DE DM framework. The SUSY DE DM model identities an alpha particle decay with a half-life of 1 E+18[41] seconds as being responsible for the generation of 7.26% alpha particle decay after 13.82 E+9 years (4.36 E+17 seconds). The model is self-consistent with a single atom inverse square law setup associated with the balance in the inward at the velocity of √v (getting closer together from the initial distance of 4 E−14 m in the He-BEC isotropic singularity model corresponding to Planck 1.6 E−35 m with a Δ4 E−22 m) and outward (getting further apart at velocity 2990700000 kJ/mole) energy flow in a balance of opposites offered in Newtonian mechanics where v²=(√v)⁴. Where photons of light decay in the inverse square law and the balance of energy conservation is generated through the rules of the IU (see Table 1).

A 4D quaternion model of electromagnetism is discussed to explain how MU status is conveyed in the IU/MU interface.

The IU quaternion is mediated by the 90 angles within s orbitals conveying positron electron pairing within orbital layers of the hydrogen atom. Functionality of the atomic model for hydrogen based on differential velocities of positron and electron motion gives rise to electron transition theory based on first principal calculations and offering a connection to alpha fine structure constant in the kinetic analysis of fluidic motion of atomic expansion. The mechanisms are outlined in Table 2 and FIGS. 16 and 17.

The development of Lineweaver Burke plot (double reciprocal plot of velocity (m/s) vs. 1/nm) offers insight into subatomic physics in the SUSY inversion model. This provides a methodology to explore kinetics for atomic expansion whereby the fluidic properties of space and time are an aetheric medium connected to dark matter (DM) that is drawn through the atomic singularity (atomic Planck scale) to produce the medium to fill up the space within the orbital layer. The dynamic features of the model and Km and Vmax parameters refer to the substrate of space based on nm distance away from the singularity (Planck singularity 1.6 E−35 m) and the rate of reaction (velocity (m/s) kJ/mole converted from eV energy data) corresponding to Vmax velocity rate of atomic inflation and expansion of the atom. The parameters provide useful information in terms of electron transition theory related to a sided spherical s orbital layer having charge separation and convex and concave properties of a membrane with the thickness related to 1/alpha fine structure constant. The kinetic properties of the atomic inflationary processes are mirrored in that of the Hubble constant cosmological inflation process which arises from the He-BEC isotropic singularity model FIG. 18.

The mathematics shows that a third scalar temporal field T exists that we believe is generated by living cells or matter everywhere in the MU.

This can now be described in terms of isotope physics (space time relationships) through the SUSY inversion model and the connection to DE and DM systems. The reconciliation between atomic theory and cosmological theory obtained through the discovery of baryonic symmetry and the identification of the missing anti-matter in atomic structure in the SUSY inversion quark charge calculations. The quark charge calculations corrections corresponding to charge parity with positron and electron pairs.

This scalar T field can be thought of an information wave signal [10] that implements a two-way IU/MU communication channel. We describe how the quadrupole system can learn to generate these information wave, disturbance signals, communicating with the IU to produce an IU response resulting in useful new physics.

This information wave (IW) corresponds to the energy binding kinetics operating within the isotope physics superposition of many states and the wavefunction collapse mediated through the isotope physics decay processes corresponding to kJ/mole (m/s) energy conservation velocity parameters operating within the boundaries of the atoms structure. The ability to observe such processes is outside the boundaries of measurement and therefore a theoretical framework based on mathematical calculations that translate to the hidden atomic processes operating within atoms offering insight into subatomic physics that can be explored through the reciprocal language of inverted symmetry. This model is providing insight into atomic theory through the development of a theoretical empirical mathematical language for subatomic physics.

When living cells or matter are disturbed, the information wave status signals changes. The IU detects such changes and responds with corrective actions. Therefore, these continuous IU processes generate feedback control of the MU as discussed above. The quadrupole system, discussed next, is designed to create such disturbances in matter that change the information wave status signals (T field) to cause the IU to respond with desired new physics: (1) lower gravity or temperature; (2) production of an electric current, or (3) increased photon emission.

The IU maintains the conservation of energy rules that correspond to the original no mass, no charge, no space and no time corresponding to the original structural features of the singularity at the beginning of time (He-BEC isotropic singularity model having a diameter of c²). IU rules provide MU corrections through the maintenance of IU state functions (original conservation parameters that govern the cosmological constants of nature based on the original configuration of the universe at the beginning of time). Changes in the constants of nature over time can then be determined using the IU rules and can be seen as the functional evolution of the universe from its beginning.

### Quadrupole System Experiment

The basic quadrupole experiment, shown in FIG. 4, consists of four electromagnets spaced at 90 degrees around a circle, a test material in the center, electronics to drive the electromagnets with alternative disturbance signals, sensors to measure the data resulting from regulator actions plus experiment outcomes, and a computer executing the control actions to guide the experiment.

The electromagnets Q1 are wired so that the combined magnetic field of the four electromagnets rotates around the test material. A moving magnetic field will induce a T field in the test material as discussed in the mathematic discussion below. Further, the rotating magnetic field strength increases from the center of the test material outward, producing an electric field gradient. A plot of the moving magnetic field was generated by a Mathematica program to show the contour and motion of the rotating field. We believe this rotating magnetic field will produce some interesting new regulator responses.

The single atom quadrupole arrangement is the proton/electron (positron/electron paired inverted photon model of SUSY inversion). The LENR outputs of the quadrupole are given in FIGS. 20 and 21.

The freeze drying of the material generated was heated in a thermogravimetric device (TGA) and the weight of the material analyzed during heating. The heating profile is shown in FIG. 22. The negative mass obtained is associated with inversion physics whereby the properties cross the boundary conditions above a set temperature corresponding to MU physics transitioning into IU physics. Therefore, the reciprocal system operating in the IU/MU transducer provides IW to restore balanced inverted symmetry corresponding to the generation of the stable zero-point energy system operating through the mirror inversion lens of the atomic singularity. This central location acting as the “Atomic Processing Unit” (APU) of the atom shifting from its unstable state where asymmetry exists to its stable state where symmetry exists. In di-atomic systems (more than one atom) there is a balance obtained through sharing of atomic infrastructure. In the mono-atomic singularity physics apparatus only the APU confers the IU rules into the MU structure providing the basis for IU/MU IW formation and the anti-entropic state of moving from disorder to order within the confines of the aromatic ring single atom system. There can be no statistical analysis associated with a many atom system when there is room for only one atom. This confinement offers functionality above that of diatomic multiple atom systems.

A computer program has been written that can learn the information wave signal coefficients that result in time varying signals that produce desired new physics. An inverse FFT algorithm is used to transform the coefficients into the time varying signal. This signal then is outputted through an D to A converter interface to a power amplifier. The power amplified signal, frequency and power selected for desired affect, is sent to all four quadrupole electro-magnets. Magnetic magnet nodes 1 and 3 are plus and nodes 2 and 4 are minus, resulting in a composite (E,B,T) field discussed in the mathematics discussion. This field creates a disturbance in the center material that results in a status change in the material. The IU detects this status change and responds with the corrective action. The computer program learns the time varying signal resulting in desired new physics.

In order to learn the information wave signal coefficient vector that produces the desired new physics, it is required that a utility measure be provided for each signal coefficient vector. For example, consider a archery target where each information wave signal is an arrow. The center of the target is the goal (desired new physics). Controlling the arrows is required for achieving and maintaining hitting the center of the target. What is needed is a measure of how close the arrow is to the center of the target: the utility function needed for learning. Thus, the utility function provides the fitness measure for each signal coefficient vector to guide the evolutionary optimization algorithm, computer program. Therefore, the sensors shown in FIG. 4 are input to the computer using A to D converter interfaces. The sensor time signals are analyzed to produce the scalar utility value to guide the search. Once the distribution of information wave signals over the target area is determined, a feedback control system can be created to maintain constant output of the desired new physics.

### Mathematics of Quadrupole System Fields

The quaternion axiom states that physical space is a quaternion structure [40]. Paper [40] does not provide a mathematical model of the composite quadrupole system field but it does provide insight into the existence of the scalar T field and what it does. The vector cross product used in 3D Maxwell equations does not exist in 4D, but symmetric and antisymmetric products do exist. Same is true in the geometric algebra and calculus formulation.

Define notation a→b is the right product and b←a is the left product where the product mathematics is specified in [40].
Symmetric product {a,b}=½(a→b+b←a) and the antisymmetric product [a,b]

$$= 1 / 2 ( a -> b - b \text{<-} a )$$

Define the 4D electric potential A=(U+A1i+A2j+A3k) where U is the scalar potential.
Define the 4D differential operator d/dr=(1/c ∂/∂t+∂/∂x i+∂/∂y j+∂/∂z k).
Electric field E=−{d/dr, A}=(T, E′) and magnetic field B=[d/dr, A]=(0, B′) where E′=(E1 i+E2j+E3k) and B′=(B1i+B2j+B3k) are the 3D Maxwell fields.
Working through the mathematics we get the following results. B

$$= ( 0 , Δ \times {A}^{′} )$$

$$E = ( T , 1 / c \partial {A}^{′} / \partial t - ΔU )$$

$$T = - 1 / c \partial U / \partial t + Δ {A}^{′}$$

$$Δ T = Δ E 0$$

It is known that all matter consists of atoms that have a positive nucleus surrounded by swarm of electrons moving around the nucleus. This electromagnetic system produces E, B, and T fields that define the status of the system. The IU agent closest to this system monitors the status field and responses with corrective action when the status changes away from the correct value. This is required to minimize entropy and reduce chaos in the MU as discussed above. When the quadrupole system creates a disturbance in the center material, this invokes a response by the IU that creates new physics. There is ample research describing experiments [1] where such new physics has occurred. The problem has been how to maintain such new physics over a long period of time. The solution of this problem requires a systems science model and process control as discussed in this paper (patent).

Research papers found in the literature suggest that there exists a combined Information Universe (IU) and Material Universe (MU) where the IU is a network of intelligent agents that communicate to create 3D+ space-time and globally regulate quantum particles to maintain a stable (low entropy) quantum states. This network implements a concurrent, context-sensitive feedback control language for the IU/MU system. This language implements our systems science model of WHAT the IU/MU system must do. The quadrupole experiment and concomitant mathematics provides some insight into how IU/MU system does it.

IU is a set of communicating, concurrent processes that continuously measure various aspects of the MU and institute changes in the MU to return to set-points and [11, 15, 16] introduce AUP, and [1, 3-7, 15] introduce OpEMCSS and both used together make this enabling with following three experiments (see FIG. 10 in BRIEF DESCRIPTION OF THE DRAWINGS):

### 1) Quadrupole System

The experimental system [1], shown in the FIG. 4 (BRIEF DESCRIPTION OF THE DRAWINGS) consists of a pair of four electromagnets spaced at 90 degrees around a circle (Quadrupole—Q1) with two opposite poles with opposite polarity or out of phase by 180 degrees, with the second pair (optional not required) out of phase by 180 degrees (Quadrupole-Q2), a test material in the center of Q1, electronics to drive the electromagnets with additional rotating magnetic field MU signals (disturbances), sensors (particularly the central z-axis and periphery xy axis) to measure the data (particularly thermal and magnetic radiation and laser spectrum analyzer and spectroscopy of any electric disturbances along z axis and xy axis) resulting from rotating magnetic field IU (regulator) actions plus Ether/Information Wave signals from the IU. The paired Q1 electromagnets are wired so that the combined magnetic field of the paired four Q1 electromagnets rotates around the test material with the second pair (optional and not required) 180 degree out of phase optional add on but not required. A rotating, twisting, magnetic field will induce an electric field in the test material and FIG. 5 (BRIEF DESCRIPTION OF THE DRAWINGS) can be simulated to illustrate this on Mathematica and COMSOL Multiphysics simulation to using a mathematical physics model [15]. Further, the rotating magnetic field strength increases from the center of the test material outward, producing an electric field gradient “asymmetric dipole” paired vortices out of phase by 180. The software already exists and has been successfully tested on a similar problem. It is now being currently investigated to extract a dipole and keep it time reversed intact via low frequency virtual photon absorption (characteristic of all mediums curving space-time) according to references [17-39] and depicted in the DIPOLE window in FIG. 5 (BRIEF DESCRIPTION OF THE DRAWINGS).

### 2) Low Energy Nuclear Reactions Resonance

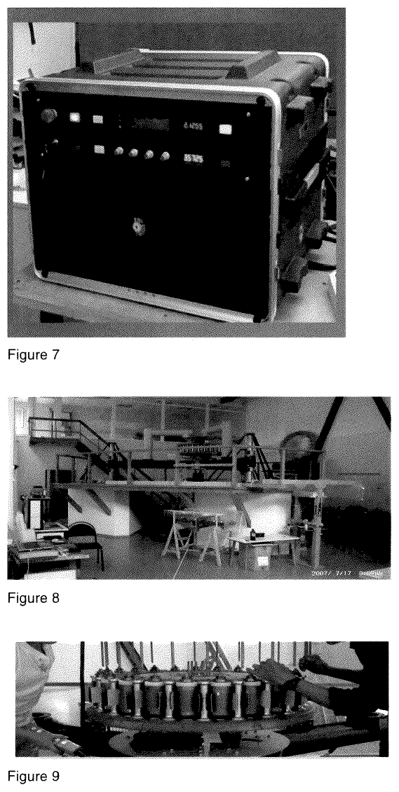

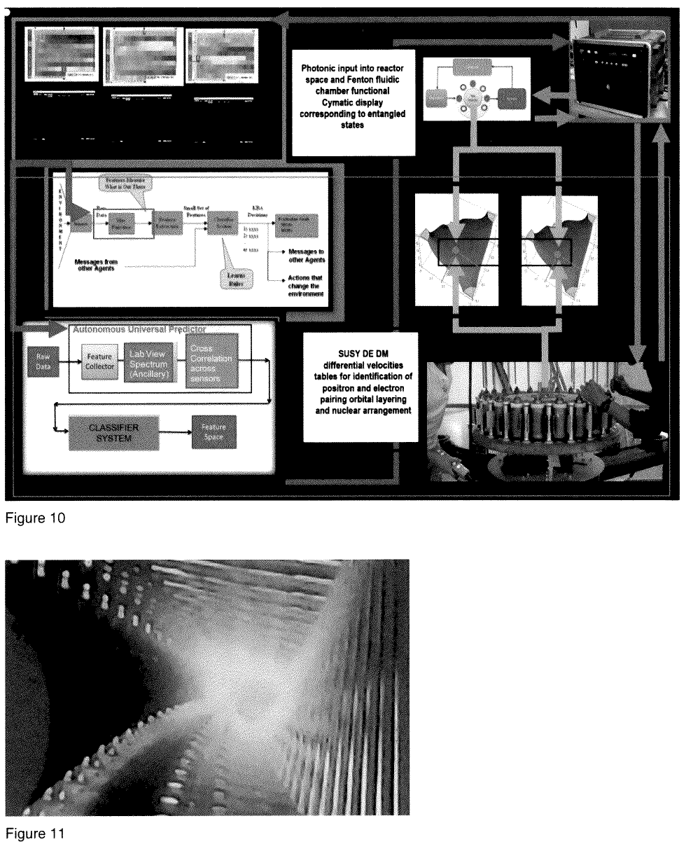

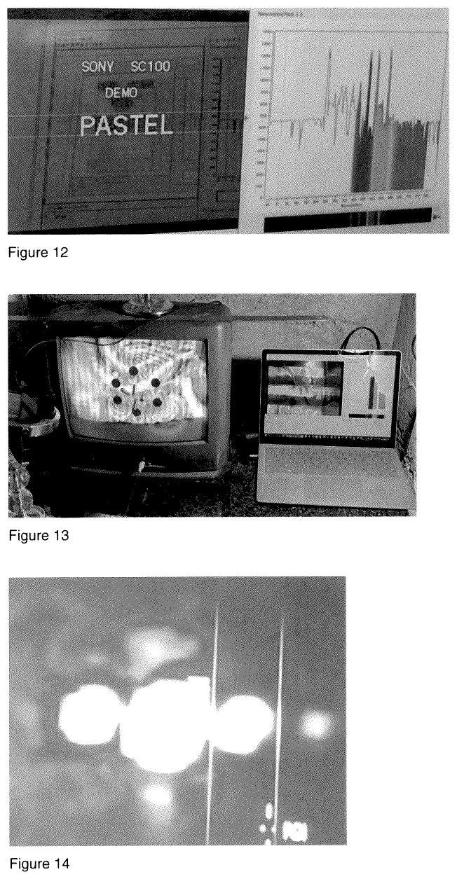

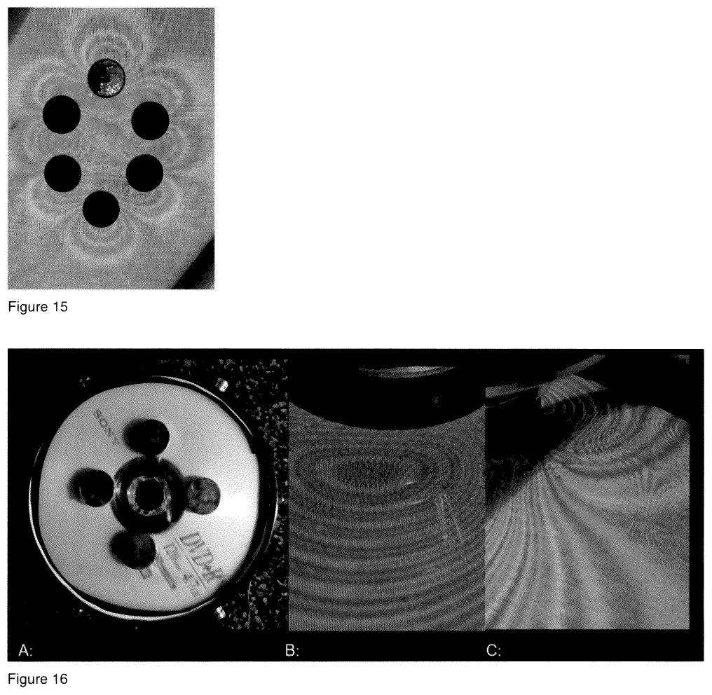

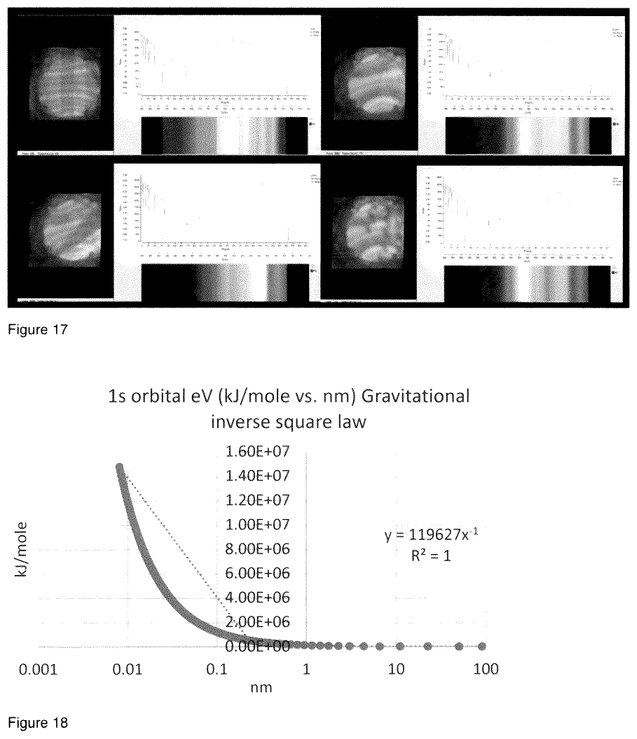

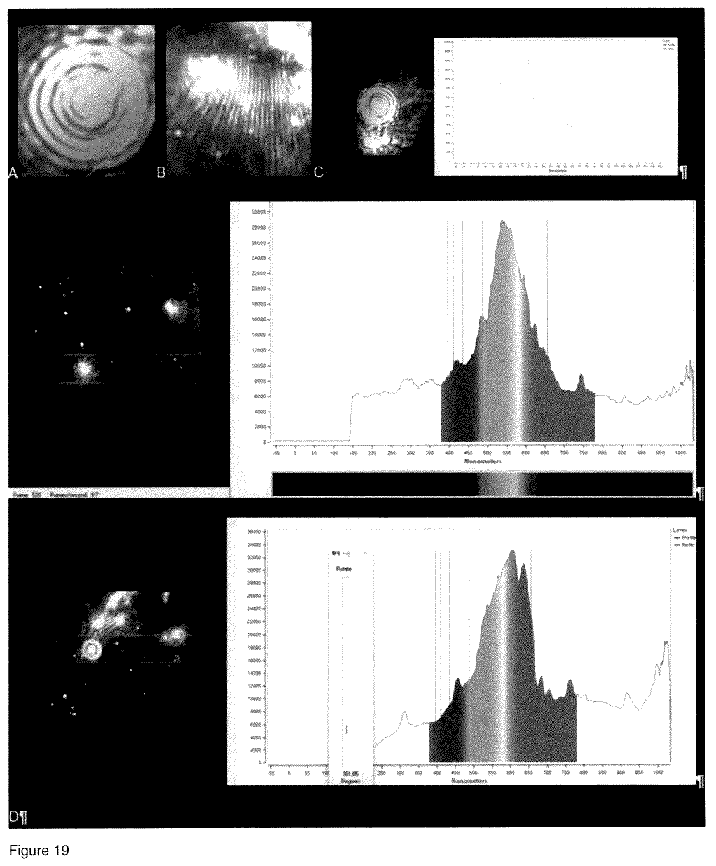

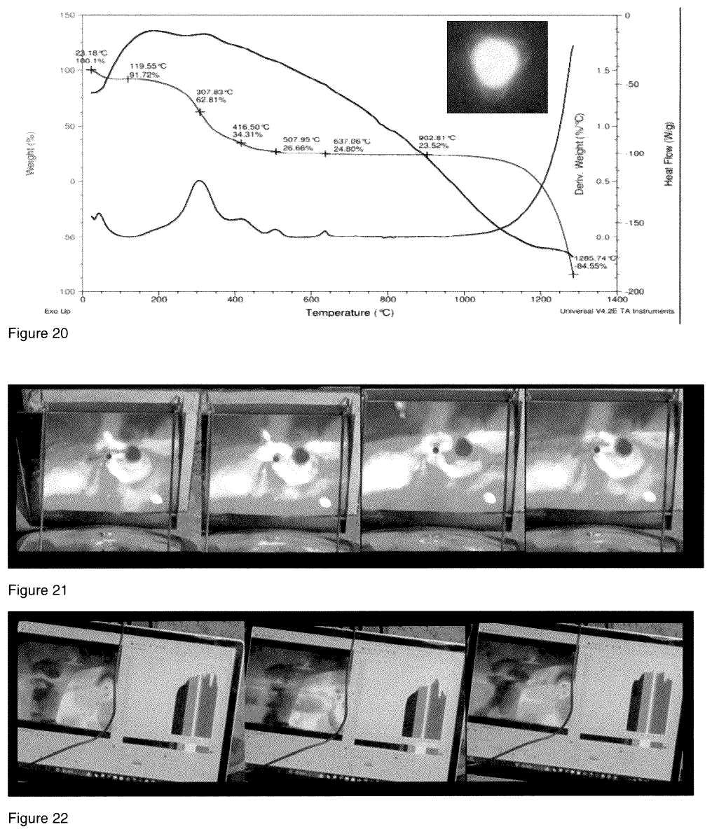

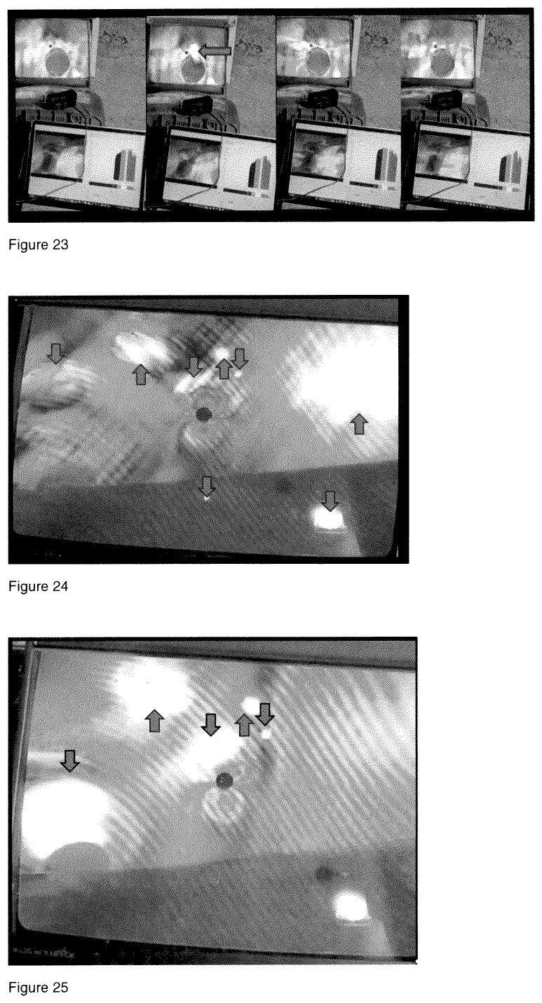

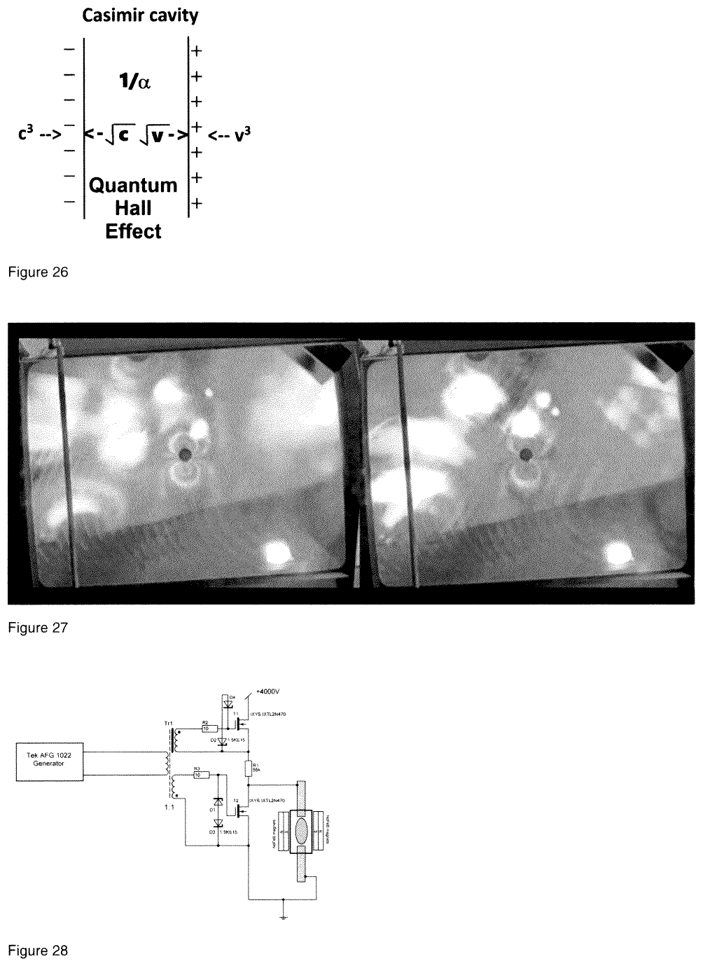

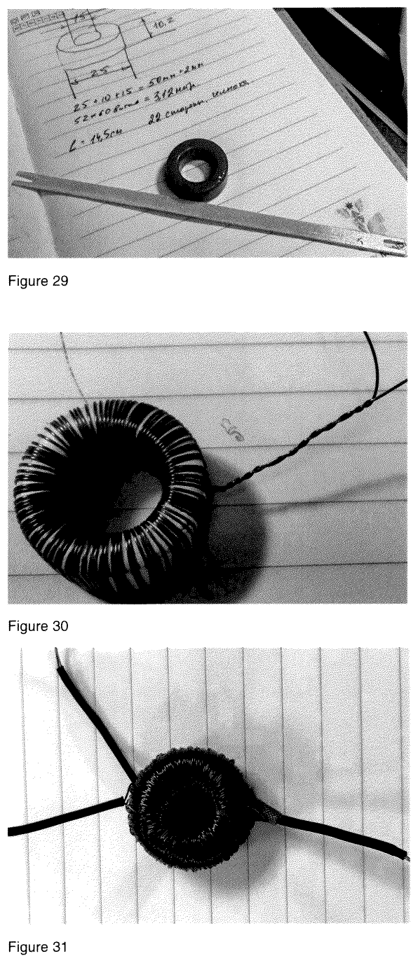

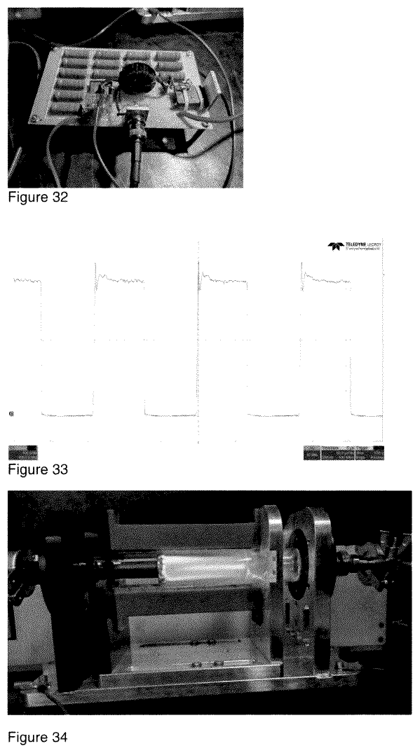

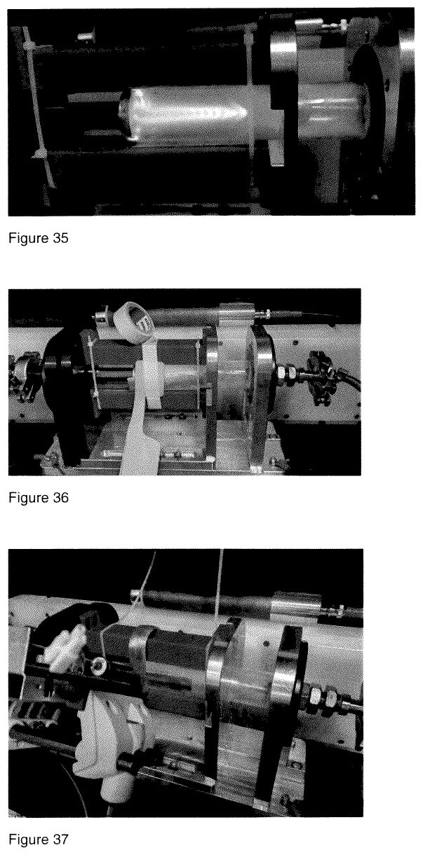

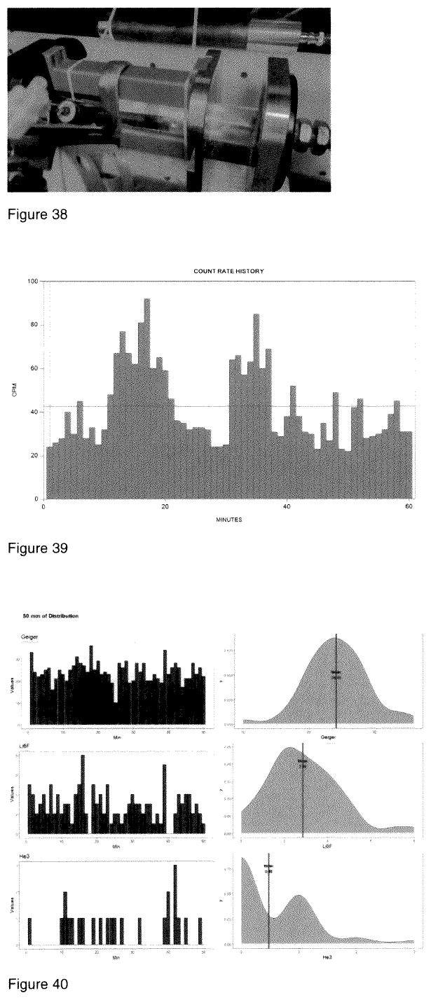

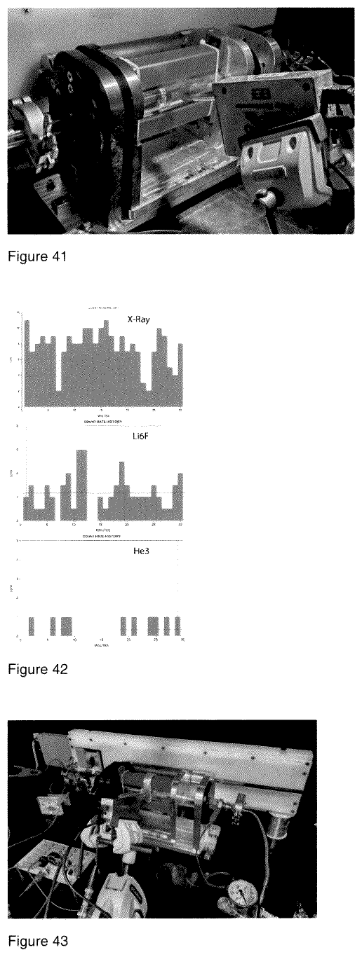

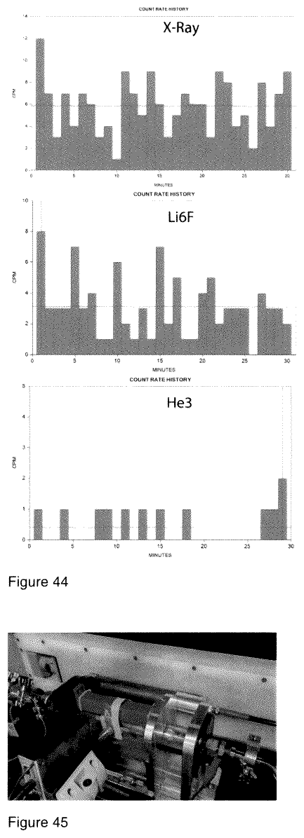

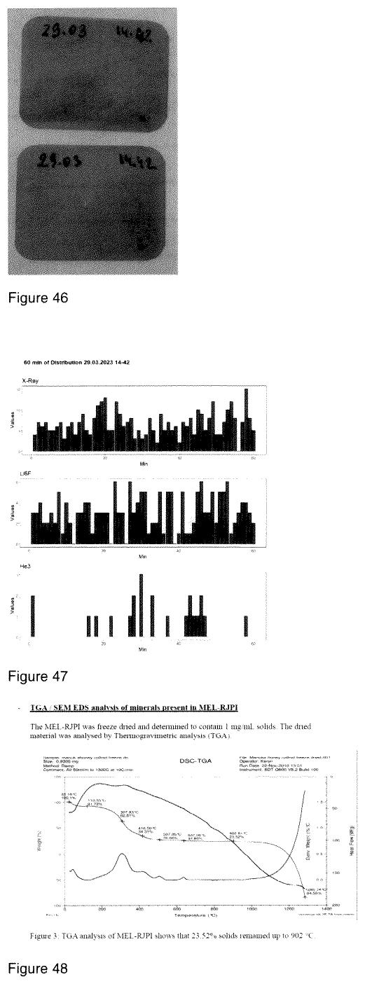

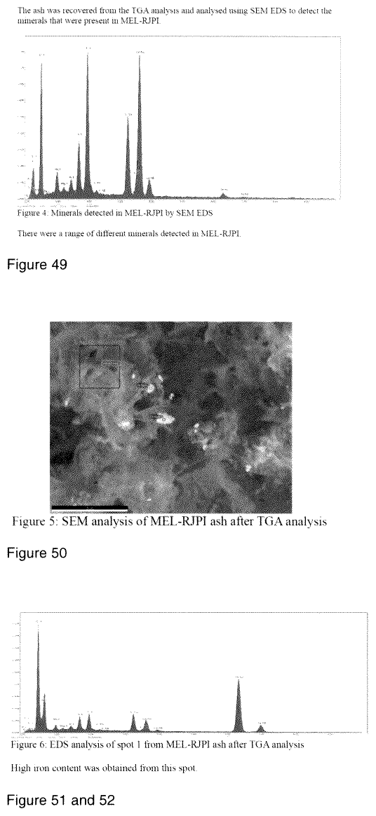

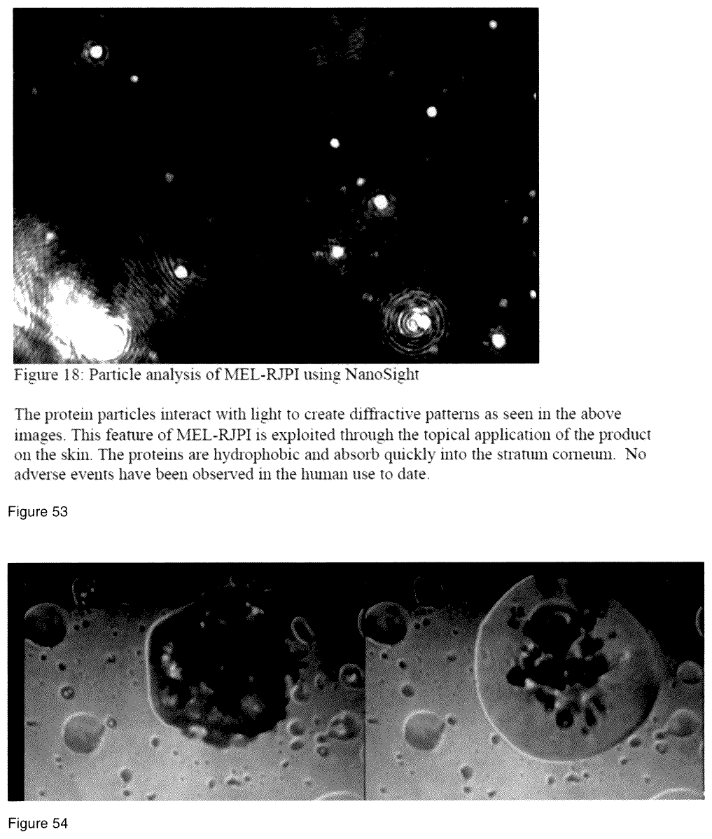

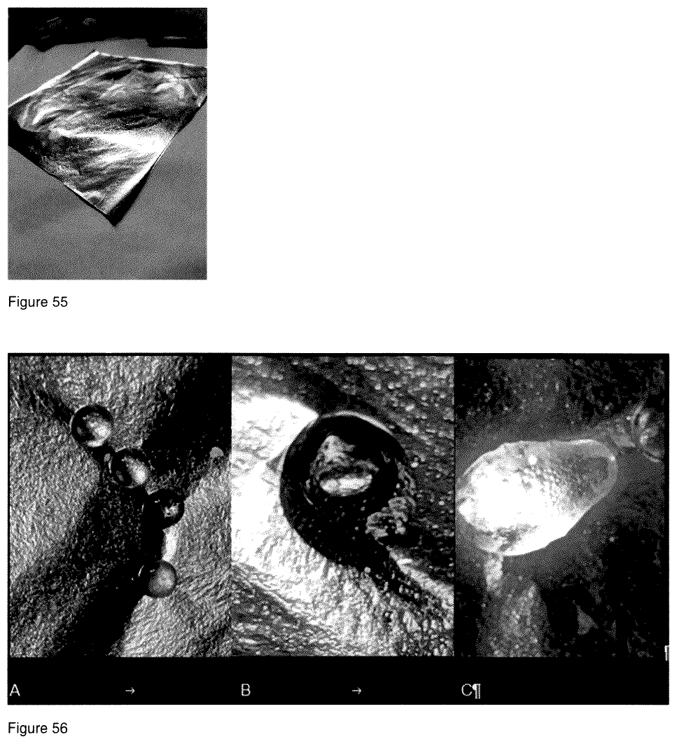

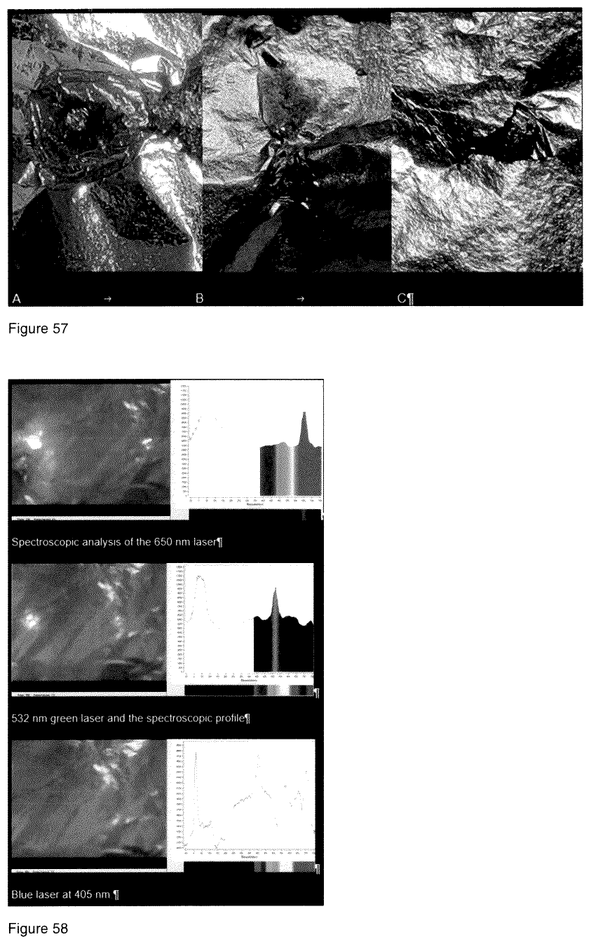

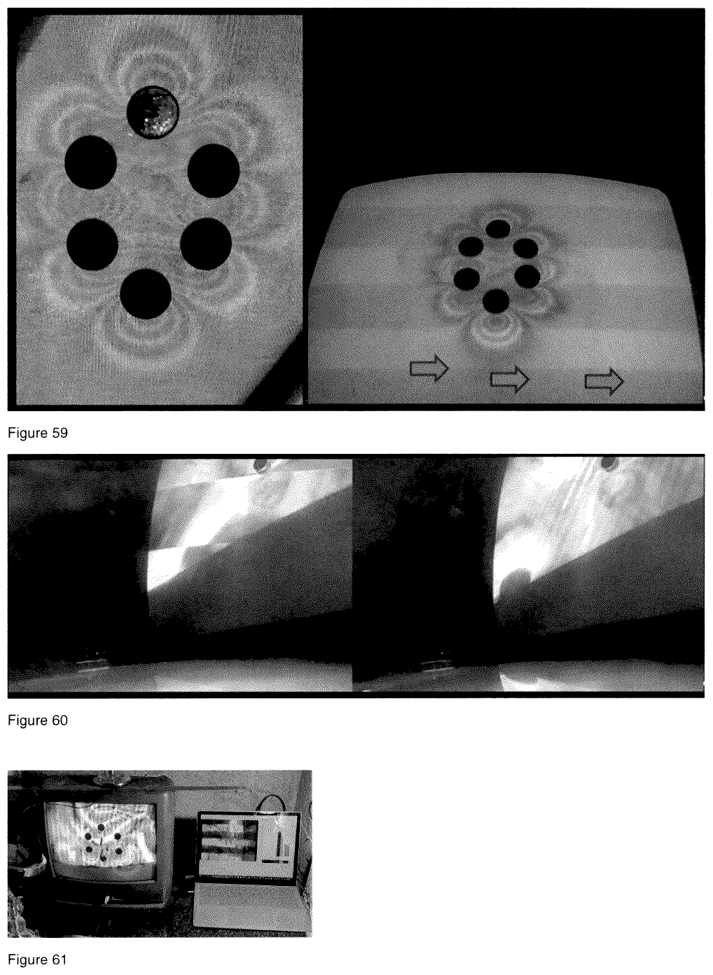

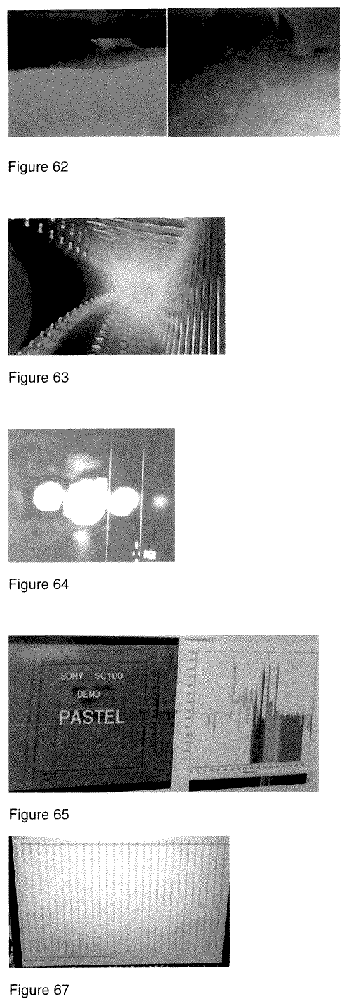

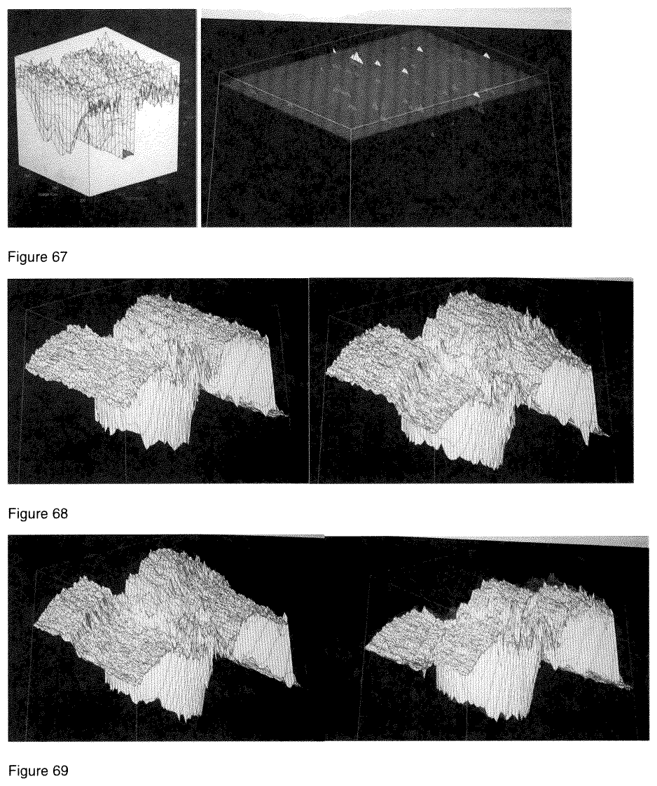

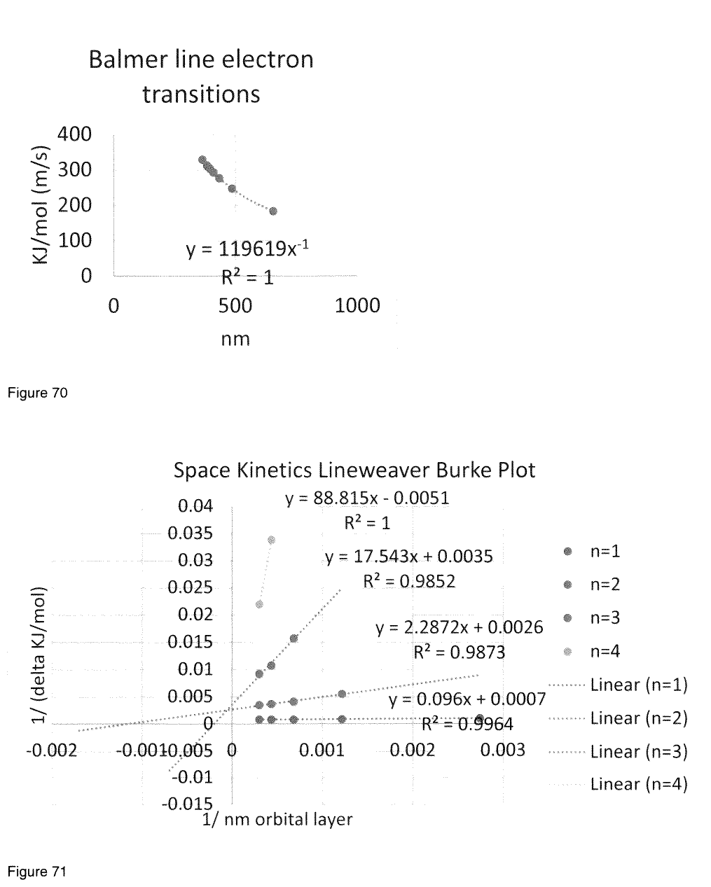

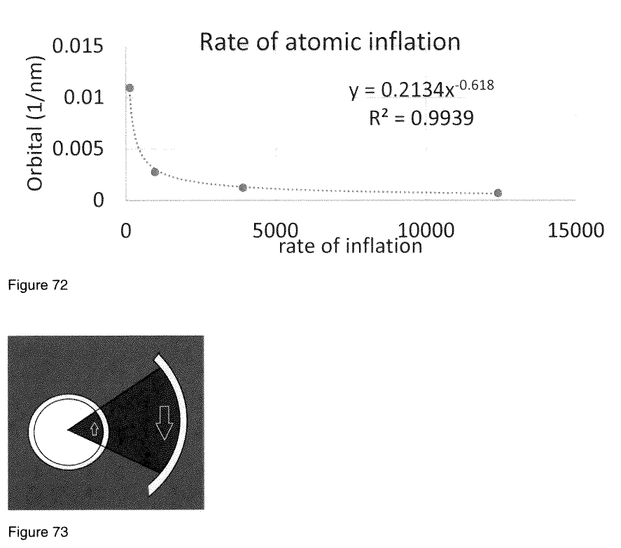

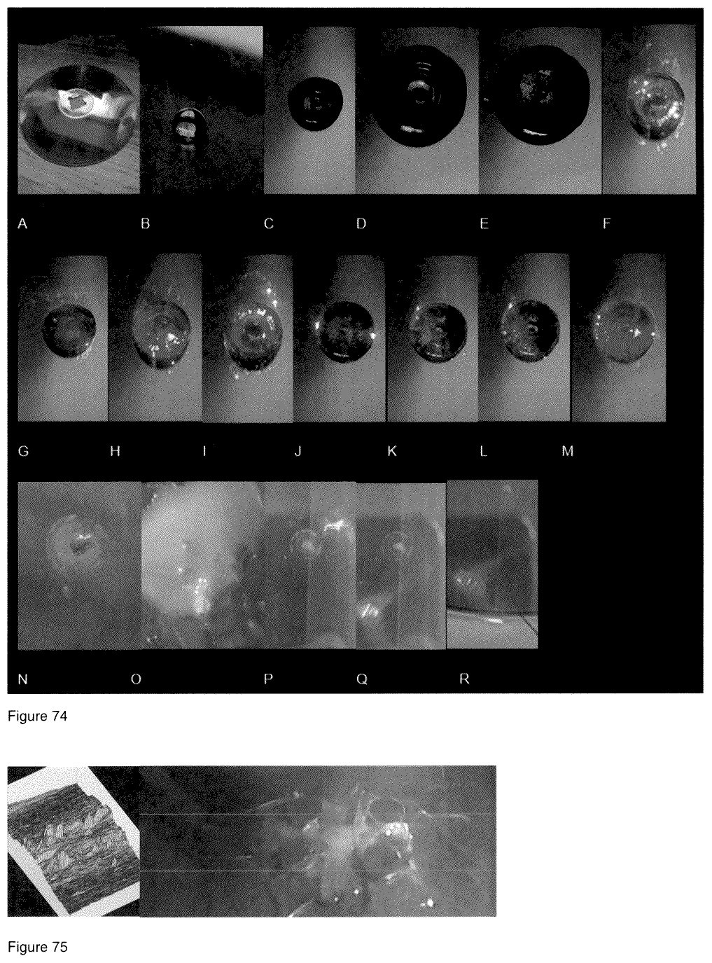

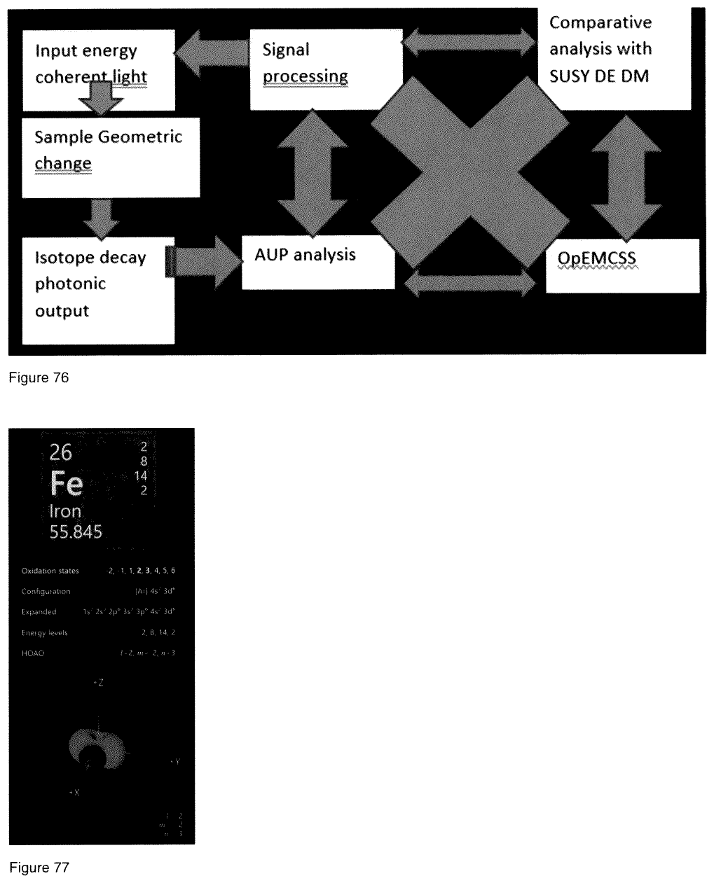

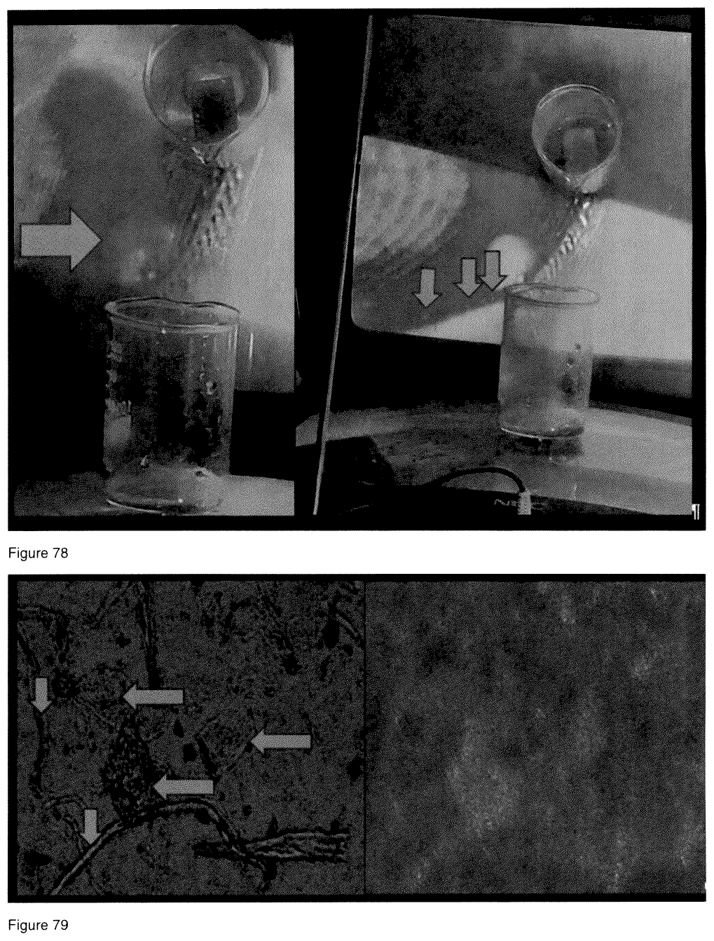

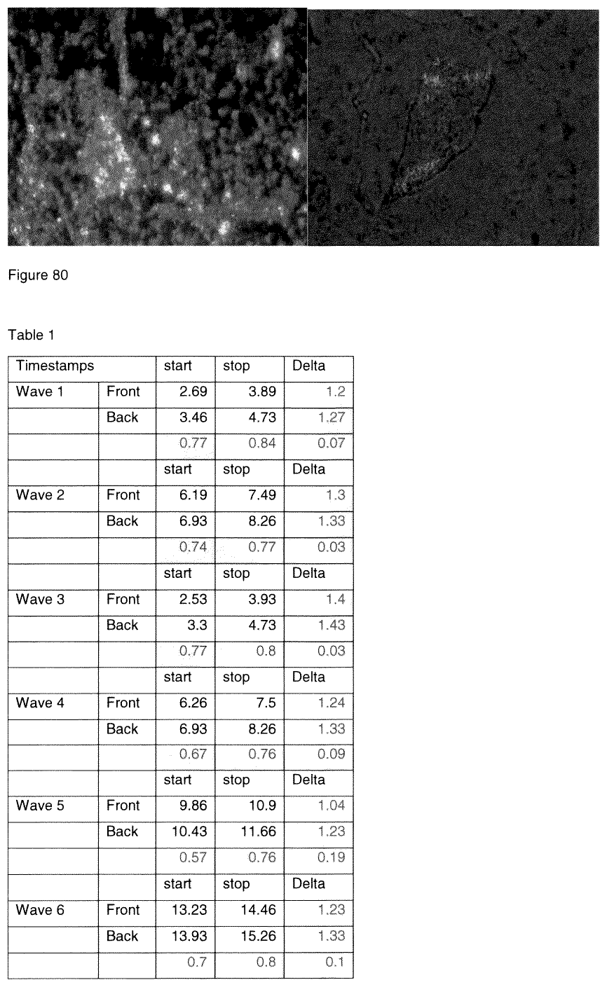

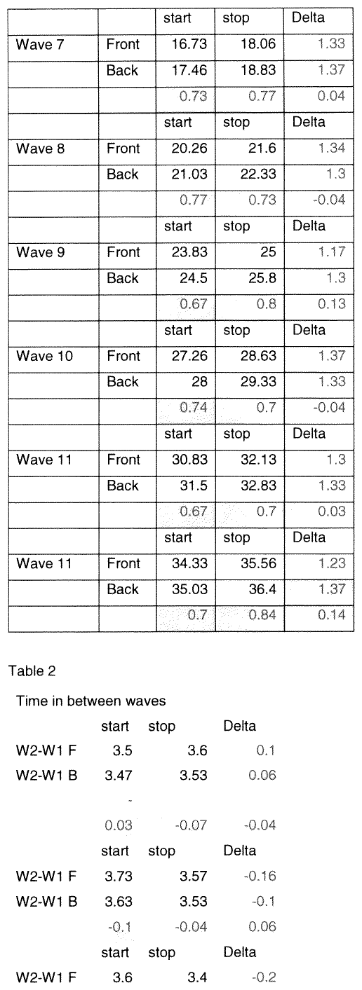

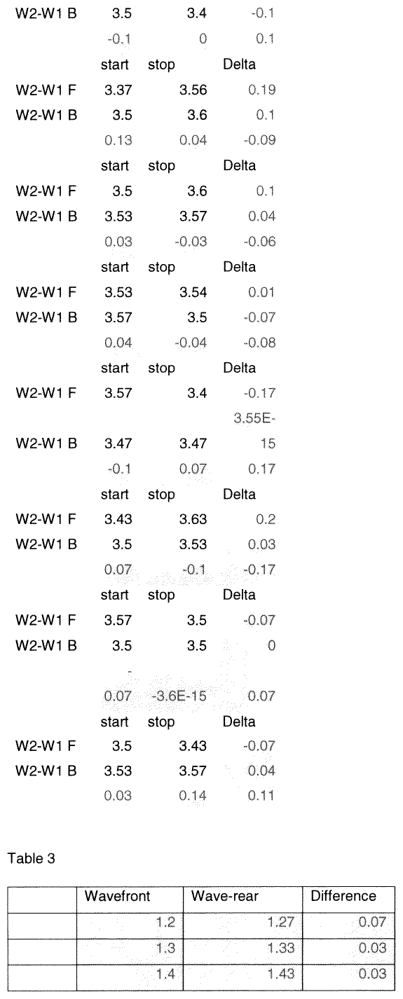

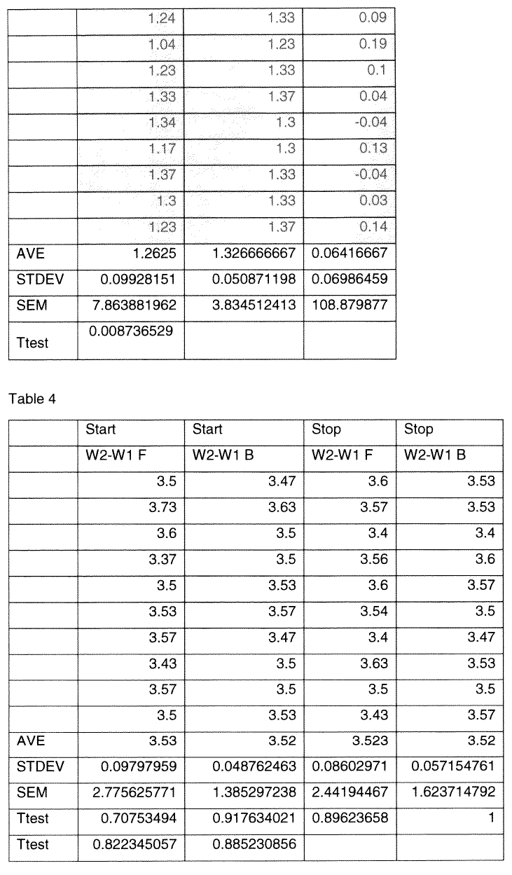

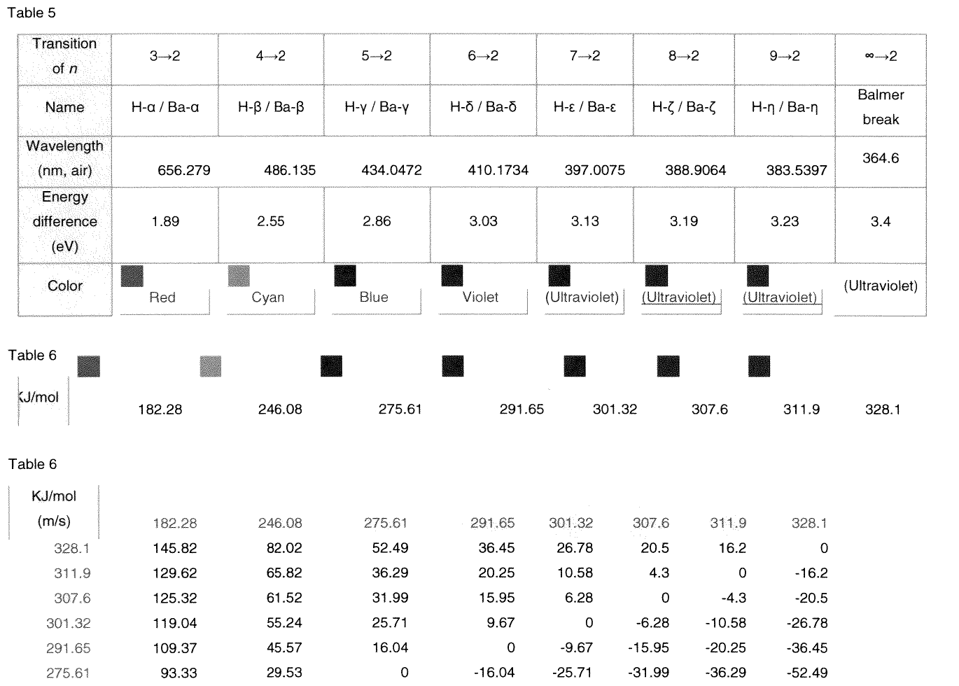

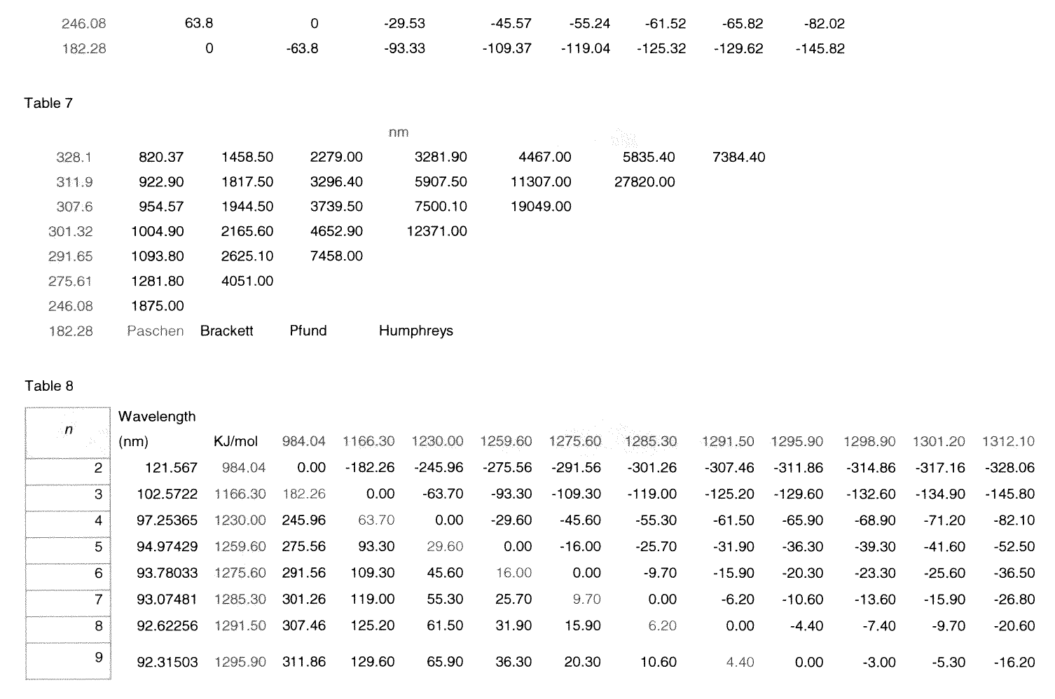

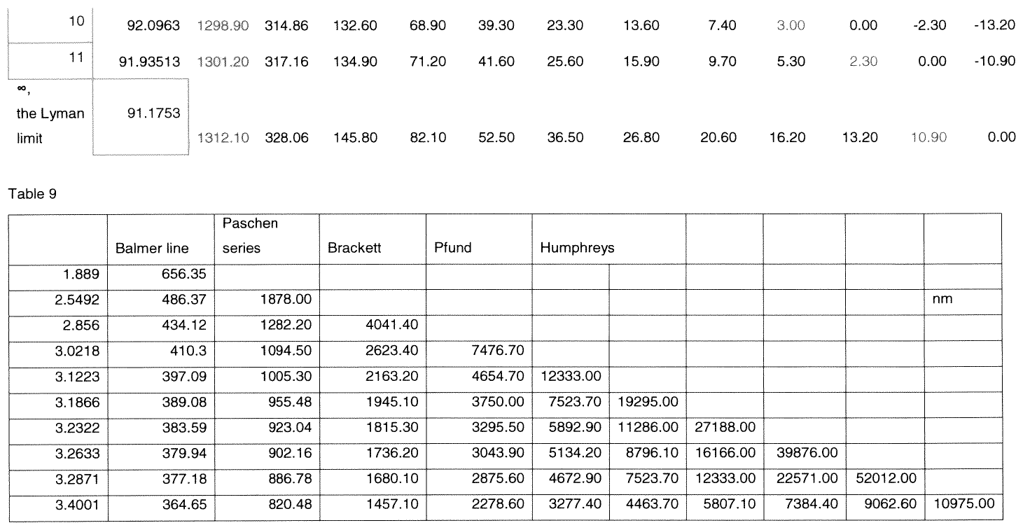

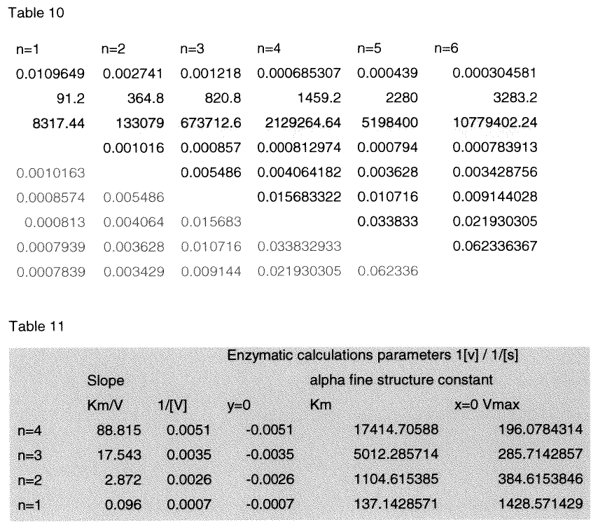

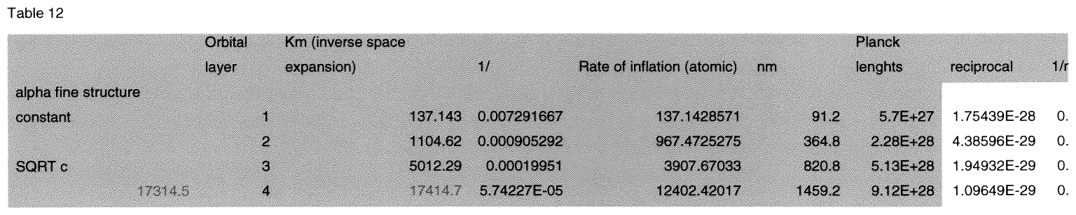

The Ether/Information wave found in [8] forms a medium to carry information that specifies the IU regulator action given an associated disturbance in the MU [7]. An important part of this project is to extract the features of the Ether/Information wave signal that relate the disturbance to the regulator action using transmission of nuclides at low temperature (TNLT) found FIGS. 6 and 7 (BRIEF DESCRIPTION OF THE DRAWINGS). This is required to be able to control the release of desired new physics such as the IU/MU Transducer. Indeed, these features allow a set of rules (non-linear control surface) to be learned that define the control system [1, 3-7]. Therefore, the resulting control system can safely maintain the desired MU behavior of IU/MU Transducer, gravity control, or other new physical phenomena). The Ether/Information wave found in [8] forms a medium to carry information that specifies the IU regulator action given an associated disturbance in the MU [7]. An important part of this project is to extract the features of the Ether/Information wave signal that relate the disturbance to the regulator action. This is required to be able to control the release of desired new physics such as the IU/MU Transducer. This project is based on the Mathematical Modeling (MM) of a physical vacuum or ether through which all physical processes defined by the laws of physics occur [8]. The importance of MM besides defining the IU/MU system control equations is to create concepts for new devices across many disciplines, determine their design parameters, and conditions of use [7, 8]. The new idea is that all physical laws can be based on the laws of the conservation of matter and the amount of ether motion [8]. This project will investigate disturbances in which resonances in the ether/information wave signal produce new physical phenomena that can be useful such as the IU/MU Transducer [7, 8].

### 3) Homopolar Generator Experiments

The Homopolar machine in FIGS. 8 and 9 (see BRIEF DESCRIPTION OF THE DRAWINGS) creates resonances in the ether/information wave signal using a static magnetic field (stator) with rotating magnetic rollers that move around the stator [9]. This operation is like the Quadrupole in that it creates a rotating, twisting, magnetic field that induces various, probably different, ether/information wave resonances in the machine. The purpose of this project is to capture the ether/information wave signal that connects the disturbance in the MU (produced in the Homopolar) to the regulator action which has been observed in past Homopolar experiments as lowering the machine weight and temperature [7-9]. It is expected that other new physical phenomena will be observed, and ether/information wave signals recorded for the purpose of extracting the rule learning features from the signal, supporting the IU/MU Transducer project [7-9]. In addition, this patented project will investigate gravity and temperature control using Homopolar generator which also supports the IU/MU development.

### Reference Chinese Patent Once You Get Chinese Translated Sergei and John Needs to Understand the Implications for the Induction Motor and OpEMCSS

ALSO BE aware that a team claims to have reduced 7 percent weight, but are they using your stuff??? Sergei (Sergei and Roschin patent material). We need to discuss this in the next meeting VERY SERIOUS.

The conservation of energy parameters created by the IU rules provide context for cosmic inflation and atomic inflation processes that arise from faster than light isotope physics decay processes corresponding to alpha particle emission which correlates to DE in the SUSY inversion model. MU decay providing the faster expansion of space the further away from earth giving rise to red shift processes in the expansion of space itself which are connected to the Hubble constant. This is correlated to the SUSY inversion model via square root velocities of c and v corresponding to 72001 m/s/Mpc. This expansionary process is balanced through the gravitational implosive singularity physics operating within the medium of the vacuum of space in the Planck epoch dimensions of time (5.39 E−44 s). The balanced energy systems operating are outlined and defined through inverse square law calculations that provide conservation of energy rules in the IU leading to the functional conservation of energy rules for IU. The no mass and no charge features of photons and the Planck scale no space and no time are measured through balancing reciprocals to provide a process of transformation that maintains conservation rules that apply to DE and DM systems science synchronization of transformation giving rise to the entanglement of systems of spooky action at a distance. This feature of maintaining the IU in balance via MU modulation can therefore be seen in a systems science big picture setting.

Conservation of energy rules in the IU convey boundary conditions and the DM singularity gravitational Planck system giving an internal boundary for the IU/MU exhausts connection to the vacuum of space being located within the atom itself at (0,0,0). The inverted geometry providing a reciprocal model of space-time within the atomic lens of the singularity (Planck epoch). The inverted model SUSY inversion DE DM system therefore offers a Planck microscopic lens into the temporal and spatial relationships through lights atomic decay red shift expansionary properties related to the inverse square law atomic landscape that can be explored mathematically through the development of a non-interactive logical model that provides a model of the theoretical basis for the IU/MU transducers interrogation of LENR systems science. The confirmation of the IU rules can be developed by the automated AUP/OpEMCSS programs in a systems approach. The identification of a functional technology that enables negative mass generation from matter/antimatter (Baryonic symmetry) as the means through which energy generation is providing the basis for asymmetry generation in the MU. The tunnelling and entanglement of the two-photon quadrupole system offers the insight into the modelling needed to learn IU rules and its regulation of the MU in maintaining the conservation of energy.

### Example

### IU MU Transducer

The video feedback setup provides a 180-degree rotational inversion providing a model whereby clockwise rotational motion of the physical camera results in an anti-clockwise rotation of the image on the TV screen or laptop screen. This provides an interactive model whereby every action has an equal and opposite reaction. The nature of the light looping and the zoom function on the camera provides an interactive zoom function that is magnified by the interactive light cycle that mediates the magnification. By focusing in on the vanishing point and mediating adjusted resolution a process of feedback can be established at various layers within the light-loop cycling and this establishes a psychedelic like fluidic motion of colors through the layers of the light cycle.

A spectroscope was arranged to observe the photonic output from the IU MU Transducer and the feedback control of the laser was monitored using the spectroscopic modulation of the output signal. When the signal was cycling the laser was used to stabilize the feedback. This was able to be observed as a stabilization of the photonic signal picked up by the spectroscopic camera as shown in the following video. The wavelengths associated with the output can be investigated for functionality associated with input wavelength modulation.

The IU MU Transducer provides a toolbox through which exploration of atomic processes taking place can be explored. The IU MU Transducer along with the SUSY inversion He-BEC DE DM theoretical model offers greater insight into unstable atom theory and the exploration of the spatial and temporal features of atomic structures and a potential way of modelling unseen processes operating within the atoms under investigation. The interactive nature of the toolbox enabling exploration of various atomic features provides a set of instructions that generate functional outputs that are somewhat different from what has previously been understood based on the models obtained using high energy atom colliders that accelerate various ions to velocities near the speed of light to explore the subatomic structures within atoms. The Transducer provides a functional toolbox to explore conceptual ideas in the modulation of atomic processes using a natural language systems science connected to AI OpEMCSS and quasi-quantum AUP analysis.

What the theoretical model provides along with the IU MU Transducer is a set of tools to learn the natural processes operating within the universe corresponding to nature's rule book which includes dark energy and dark matter and the original geometry of the universe prior to the beginning of time. The existing models using light cannot ascertain features of the universe that occurred prior to 380,000 years after the beginning because the features of the universe where opaque prior to this time. Developing a model that has explanatory power to reveal the unknowns in science offers opportunities to utilize alternative approaches to develop energy technologies and health technologies that are aligned with this new understanding.

The photon sphere increases in size through each cycle of the light-loop. The spreading of photon is apparent associated with each light cycle or loop. As photons red shift or their intensity decreases by inverse square law the functional volume of the spheres observed at each cycle can be used to understand the expansion of the photon along with the cycle scale amplification via the video camera zoom function. Therefore, the IU MU Transducer can explore different atomic orbital layers as well as model the positioning of the various standing wave locations by exploring the spatial and temporal.

The differential velocities of v and c corresponding to the expansionary Casimir cavity and charge separation due to the quantum Hall effect. The motion of charge around the surface area (inside concave) and outside (convex) provides the basis of differential velocities of the electron (negative) and positron (positive) features of the photonic membrane of 1/alpha=137.036 which corresponds to 0.00729 which is 1 E−7 orders of magnitude difference between √v+√c=72001 m/s and connected to 4 π which is directly linked to μ₀=1 E−7×π×4, where

$$\frac{( \sqrt{v} + \frac{1}{α} )}{( \sqrt{c} + \frac{1}{α} )} = π$$

The position of the 1 s orbital layer in hydrogen is 91.2 nm or 5.7 E+27 Planck lengths away from Planck reference point of (0,0,0) which is equivalent to 1 Planck length. The expansionary process of the charge separation is connected to the growth of energy within the atom. As the energy levels increase from n=1 to n=7 2, 8, 18, 32, 32, 18, 8 the width of the membrane increases and the photonic features change. Modelling of these features using the IU MU Transducer using the double reciprocal plot of Lineweaver Burke plot where v is the kJ/mole (m/s) velocity of the quantum system equivalent to the rate of reaction and the nm or m distance away from the Planck length is considered the substrate concentration [S] and plotting 1/v vs. 1/[S] correspond to the kinetic parameters where the slope is Kₘ/Vₘₐₓ and 1/Vₘₐₓ respectively. The change in the kinetic parameters associated with atomic systems operating within the proton can be investigated based on Kₘ and Vmax which can provide corresponding information related to the Quantum Hall and Casimir cavity effects in the membrane structure of the proton at the n=1 91.2 nm. This extends the Bohr model of the electron position relate to the Lyman line electron transition and it provides a theoretical framework for analysing quantum fluctuations within the proton system corresponding to the electron transitions in the Bohr model giving the other transition series through a process of differential velocity (m/s) based on the kJ/mole parameters. The translation of the eV values into kinetic motion since kJ/mole provides an explanatory power for the relationship to c and v in the SUSY DE DM He-BEC isotropic singularity model.

This is demonstrated by the equation

$$\frac{\sqrt{{c}^{3} {v}^{3}}}{6.25 E 25} = 13.58 nm .$$

The corresponding n=1 eV value of 13.58 for the 6.25 E25 ionization of hydrogen is equivalent to the nm feature of the electromagnetic average of the cubed velocity of c (speed of light) and v (speed of alpha particles) emitted from the He-BEC isotropic singularity. This offers insight into the functioning of the electromagnetic properties of the hydrogen atom and its structure since an internal distance between the Planck and the n=1 orbital layer in the hydrogen atom appears to be based on differential velocity between the speed of light and the alpha particle. The He-BEC singularity model's diameter is c² and the velocity v is determined by the distance between positron and electron pairings of 4 E−14 meter corresponding to 2,990,700,000 kJ/mole (m/s). Such a functional model offers insight into the inner workings of subatomic systems and the set of functional instructions that determine the atomic features of hydrogen.

### TNLT Generation of LENR and X-Ray Emission

Objective: to try to intensify the operation of the TNLT reactor using a new power supply circuit and optical radiation from a 450 nm blue solid-state laser.

New power source. The main difference from the previously used one is the use of a second switch to short-circuit the TNLT reactor to “ground”. Such a connection allows a steep signal edge and reduces the power dissipation at the ballast resistors. Without changing the ballast resistors, but only by combining it in parallel-serial connection, it is possible to regulate the operating current of the reactor within a wide range. The schematic diagram of the source is shown below.

The circuit is based on two high voltage, 4700 volt, IXYS MOSFET switches type IXTL2N470. The keys work in antiphase mode, one open, the other closed and vice versa. The control antiphase signals are generated with the transformer Tr1, which has three windings, one primary connected directly to the master oscillator output and two secondary windings. The secondary winding for the first transistor is high-voltage insulated from the other windings and wound on a ferrite core of the first, followed by two layers of fiberglass tape, providing a dielectric strength of about 4 kV.

The pictures below show the steps of making this transformer. The core is ferrite with a magnetic permeability of 10,000. The number of turns of each winding is 100, with 0.35 mm wire.

Diodes D1-D4 of type 1,5KE15 have a protective function, protecting the transistor gates from voltages higher than 15V. The ballast resistor R1 is made up of several 33 kΩ resistors and a 5 W power dissipation.

The whole construction, shown in the photo below, is blown by a fan for cooling. (FIG. 32) The modulator is powered by a simple step-up transformer with a bridge rectifier and a 1 μf smoothing capacitor. The figure below shows a typical voltage waveform at the anode of a TNLT reactor.

The design of the magnetic system. The use of a magnetic system consisting of four magnets was not very convenient because of the impossibility of directing the laser beam along the plane of the plasma formation in the reactor. Two magnets were removed and the other two were left in the attraction mode to each other, i.e., in the NS-NS configuration. A photo of the reactor and the plasma formation is shown in the photo below.

It should be said that before this, the flat cathode was replaced with a spherical one in the reactor to eliminate edge effects and provide a more uniform current density over the surface. In this configuration of the magnetic field, the plasma discharge turned out to be very fuzzy and diffuse, and it was not possible to create a stable stratum pattern in it. Further, the configuration of the magnetic field was changed to repulsive NS-SN, as shown in FIG. 8 below.

In this configuration an experiment with X-ray films and indium was made. Unfortunately, here we used an already quite worn-out tablet on the anode consisting of nickel powder and sodium tetraborate, FIG. 9 below.

Irradiation was performed for 15 minutes at a pressure of 1.5-1.8 mbar and an average current of 10 mA at a frequency of 13.4 kHz in an air atmosphere. Unfortunately, the insufficient sealing of the reactor does not allow the use of pure helium or hydrogen filling, air is continuously flowing into the reactor. The result of this experiment is negative, there are no traces of X-rays from indium on the films. A frequency of 13.4 kHz was chosen from the condition of obtaining the clearest picture of the stratum at a current of 10 milliamps and a pressure of 1.5 mbar.

Laser use. To further activate the plasma, a solid-state continuous laser with a power of 10 W and a wavelength of 450 nm produced by RUI DIAO was used. Some changes were made to the reactor design: two aluminum rectangular strips were glued to the two side surfaces of the reactor for multiple reflection of laser light inside the reactor. A Geiger counter based on the popular and sensitive to any type of ionizing radiation LND712 front end element made in the USA was used.

Use of a Geiger counter. In addition to the Geiger counter, thermal and slow neutron detectors were used for measurements: one based on a gas-discharge counter filled with helium 3 (above in the photo), the second one of scintillation type on plastic (rectangular behind the white plastic reactor), containing Lithium-6 and luminophore, which generates light. The pressure in the reactor during the experiment was maintained within 1.5-1.8 mbar, the medium was air with helium residues.

The laser was mounted on the side and its beam passed along the plane of the discharge, repeatedly re-reflecting from the walls of the quartz tube and the glued aluminum foil. The intensity of the light was very high and it was possible to make a quality photograph only through a special attenuating light filter as shown in the picture FIG. 11 below. The laser allowed modulation of the emission with an external oscillator producing a signal in a standard TTL level (0, +5 volts). In the experiment modulation at half the electrical frequency was used, i.e. 13400/2=6700 Hz.

An hour-long recording was made in which the first 10 minutes of background was recorded, then from 11 to 20 minutes the reactor was on, then 10 minutes of background recording, then from 30 to 40 minutes the reactor was on again and then the background recording from 41 to 60 minutes. The results of the Geiger counter are shown in FIG. 39.

On the graph there are clear excesses of the background level, coinciding with the moments of reactor activation. The tablet was used the old one, only slightly rotated by 45 degrees to shift the spent spots on the tablet to those that did not work.

The software used allows all waveforms of the recorded pulses to be stored in memory and manually edited, eliminating obvious electromagnetic interference and other artifacts. After carefully reviewing all the recordings and removing the interference, we got the picture shown in FIG. 36.

Some flashes on the neutron scintillator that coincide with the reactor operating time and with the Geiger counter activity can be noted, but they are short-lived and rather random in nature.

The use of the X-ray detector. Next, a new tablet was installed in the reactor, and next to it the head of the Amptek X-123 semiconductor X-ray CdTe detector, as shown in FIG. 14 below. The detector's energy range starts at 1 keV and ends at 170 keV. The tablet at the anode is covered with aluminum foil and the foil is available on the outer surface of the reactor, the X-ray detector should register the secondary gamma radiation.

The results of the half-hour recording are shown in the graphs in FIG. 15. The reactor was energized together with the laser radiation from 11 minutes to 21 minutes of signal recording. No electromagnetic interference or other malfunctions in the recording detectors were detected. The pressure was maintained at 1-2 mbar, the modulator frequency was 13400 Hz, the laser modulation frequency was 6700 Hz, the average current in the reactor was 10 mA, and the average laser power was 5 W. The working mixture was air with helium residues.

As can be seen from the graphs, under these experimental conditions, none of the graphs showed the presence of a significant difference from the background during the operation of the reactor. The X-ray detector here was used in the pulse counting mode without taking into account their energy.

One can assume that the scintillation detector on Li6F at 11-12 minutes gave a signal twice as high as the average background, but the He3 detector at that moment did not register a single neutron at all and did not register an excess of X-rays.

The next day, the tablet in the reactor was rotated 45 degrees and an indium strip and the head of an Amptek X-123 semiconductor X-ray CdTe detector were placed next to it, as shown in the photo FIG. 16 below.

The results of the half-hour recording are shown in the graphs in FIG. 40. The reactor was energized together with the laser radiation from 11 minutes to 21 minutes of signal recording. No electromagnetic interference or other malfunctions in the recording detectors were detected. The pressure was maintained at 1-2 mbar, the modulator frequency was 13400 Hz, the laser modulation frequency was 6700 Hz, the average current in the reactor was 10 mA, and the average laser power was 5 W. The working mixture was air with helium residues.

As can be seen from the graphs, when using indium, none of the graphs again showed the presence of a significant deviation during reactor operation. The X-ray detector here was used in the pulse counting mode without regard to its energy.

It should be noted. that in the pressure range of 1-2 mbar the reactor does not produce significant high-frequency interference and the signal recordings are practically free of interference.

Then another recording was made already without indium. The same tablet on the anode was again rotated by 45 degrees. In this experiment copper and X-ray films were used instead of indium as shown in FIG. 45 below.

Here we used a different modulation frequency of laser radiation−50 Hz. Starting from 11 minute the reactor, laser and high voltage modulator were turned on at a frequency of 13400 Hz with an average current of 10 mA, 21 minute turned off everything, 31 minute turned on the reactor and laser 50 Hz, 41 minute turned off everything. The results are shown on the photos of developed films, FIG. 42 and graphs of radiation detectors FIG. 46.

Conclusions. Application of laser radiation had no noticeable effect on the readings of the radiation sensors. To continue the experiments two options are proposed: 1—increase the operating current, the modulator and high voltage source allow to do this; 2—reduce the pressure in the reactor and increase the operating voltage to 4-4.5 kV to achieve the quantum potential of 3.74 kV.

### The Development of a IU MU Transducer Model for Beta Plus and Beta Minus Decay

The role of quantum correction in atomic structure has not been correlated with proton and neutron symmetry as the N and Z components of an atom deviate from N═Z at higher mass numbers. The number of stable nuclei change over the periodic table. The composition of the atom is somewhat confusing due to the absence of the positron connected to the neutron in the current Standard Model of Particle Physics. The inclusion of this additional particle provides the basis for exploring the electromagnetic fields within the hydrogen atom's structure and this connects directly to the SUSY inversion Baryonic symmetry quark charge calculations. The inversion of charge corresponding to the opposite charge from what is expected to be in terms of position within a (x,y) coordinate system on a mathematical graph. If the area is a positive area then the charge attracted to that area would expect to be negative. Where the area is negative the charge attracted to that area is expected to be positive. Just as a positively charged particle (positron) is attracted to the negative charge on an electric plate. The neutral particle will not divert towards a positive or negatively charged plates. This indicates that quarks of opposite charges to their entangled orbital partner are attracted to one another. It is therefore reasonable to consider the functional interaction between positron and neutron where the neutron is negatively charged, and the overall charge obtained within the Standard model to equate to the presence of a positron associated with the neutron. The half-life of the free neutron is 888 seconds. This gives an underlying reason why protons do not decay when free versus the decay of free neutrons. It also provides the basis for asymmetry in the masses of protons and neutrons, where the neutron is heavier than the proton, because of the presence of the positron. The novelty of such a model provides new insights into the atomic structure of atoms on the basis of matter=anti-matter symmetry in the universe.

The quark charge calculations in SUSY inversion provide a conservation of charge process whereby the Up quark −ve charge is connected to the generation of positron +ve charge during beta plus decay. The inverted charge is obtained through its transition through the pinhole Planck singularity system at the center of the atom, which allows the quark to exit the nucleus and enter the orbital layers of the atom. As it is a positron it is coming to reside on the external surface positive charge via a muon process as determined by SUSY inversion model. This can be seen in terms of beta plus decay where the protons Up quark (−ve) transitions into the positron +ve and the electron −ve associated with the proton transitions into the nucleus to become the Down quark +ve of the newly formed Neutron. So, there is an inward and outward process that maintains energy conservation and renormalization of charges where the electron −ve becomes +ve Down quark and the Up quark −ve becomes +ve positron. The positive proton is converted into a negatively charged neutron in this process and the positron balances the charge of the newly formed neutron so together the charge is zero. This can be considered a process that occurs naturally within beta plus decay taking in consideration of the inclusion of the positron within the atoms structure.

The beta minus decay takes a neutron and the +ve Down Quark, which is converted into a −ve electron and the positron associated with the neutron enters the nucleus to become an Up quark −ve to generate the proton. Again, an energy conservation process is taking place that results in the beta minus decay system. The functionality of this system operates to correct charge imbalance. This highlights that the overall charge within the atom is most stable when the overall charge of the atom is zero and the number of protons and neutrons are equal, and the number of positrons is equal to the number of electrons. This is seen in the N═Z line associated with isotope physics. At higher atomic masses there is a deviation from N═Z and the increase in the number of neutrons is observed in the stable atoms. We not only have to consider of the N═Z parameters but also the functional analysis of neutrons and proton numbers but also the difference in the number of positrons and electrons. If the difference between protons and neutrons in terms of Up and Down quark charges is equal to the differences between the positron and electron orbital configurations in terms of s, p, d, f then what we observe are a number of situations where the charges of the nucleus can cancel out the difference in charges in the orbitals and the overall atom can still have an overall zero charge state despite the N>Z.

### IU MU Transducer Experiments and Evaluation of Negative Mass

Negative mass analysis TGA thermogravimetric analysis of mono-atomic coordination complexation chemistry of MEL-RJPI. Proteins were isolated from Manuka honey. The proteins were shown to contain interesting properties because they contained minerals coordinated to phenolic compounds bound to the proteins through MGO modifications. The ash material was recovered from the TGA analysis and minerals analysis was performed using SEM EDS analysis.

The transducer provides the basis for exploration for the photonic energy released after laser light excitation of the minerals coordinated to the phenolics bound to the royal jelly proteins. Spectroscopic information obtained provides an example of the commercial utility of the IU MU Transducer in the analysis of a commercial product that has regenerative potential as well as other functional properties to assist in wound healing and anti-bacterial properties. The IU MU Transducer enables analysis of the photonic patterns through spectroscopic examination of Fraunhofer lines and provides information related to mineral composition and isotope transitions that give rise to the various photonic outputs that can be measured using Fraunhofer line spectroscopic analysis leading to the identification of which minerals are potentially coordinated within the phenolic aromatic ring. This is an example of one potential commercial application of the IU MU Transducer, which is a functional toolbox to explore unusual physics operating in biological systems.

Photo-Fenton chemistry and hydroxyl radical mediated quantum tunnelling and unusual physics.

The phenolics bound to royal jelly proteins provide functionality associated with radical chemistry including the generation of hydroxyl radical (OH*) and superoxide (O₂^{*-}). The hydroxyl radical has a short half-life of 1 nanosecond, and it generates 1200 eV of energy and provides significant energy for chemical transformational changes in biological systems including useful energy in the deconstruction of cells into CO₂ and water as part of the natural processes in cells associated with apoptosis. The functional properties of hydroxyl radicals in the generation of quantum coherent water provides the basis for further investigation of the unusual properties of metamaterials generated through photo-Fenton chemistry and the production of quantum coherent fluids.

### Example 3: IU MU Transducer Examination of Unusual Physics Associated with Fusing Metal Sheets Together

Wax paper sheet was placed on the bottom. Samples of the royal jelly protein extract were placed onto the silver leaf (on top). Then a crystal of iron sulphate was added along with 1 microL of 30% hydrogen peroxide. The phenolics within the royal jelly protein isolate coordinate to the iron. Different laser lights red 650 nm, green 523 nm and blue 405 nm were used to facilitate photo-Fenton chemistry to produce the high-energy short-lived hydroxyl radical. The changes to the metal surface were observed after 24 hours. The three sheets of metal (Gold bottom, copper middle, and silver top were connected and could not be separated without ripping the foils. The source of the unusual physics was a combination of photo-Fenton chemistry and the generation of hydroxyl radicals that appear to function to change the electron geometry and enabling bonding to occur between the three sheets of metal foil but not the plastic sheet.

The ability to measure photons emitted from the surface and because of emitted energy from the photon-Fenton chemistry reactions provides useful information that the IU MU transducer can analyze using AUP and OpEMCSS.

### Magnetic Field Detection Using CRT 20 keV and the Light Loop Feedback System of the IU MU Transducer

The CRT 14 inch 20 KeV display of the neodymium magnetic fields. The orientation of the magnetic field can be determined using a handheld magnet and attraction and repulsion provides the basis for the orientation of the field. The alternative magnetic orientation e.g., North up South down is followed by South up and North down. This led to the following inverted cross based geometry of the magnetic field in a hexagon arrangement. The functionality of the IU MU Transducer to explore magnetic fields visually using a cathode ray tube (old television screen) provides for a real time interactive understanding of the magnetic field and its functional orientation in the field lines (arrows). The integer and fractional quantization of the magnetic field system is seen as a functional relationship with the inverse square law electric field via the quantum hall and features of atomic structures and Landau lines. Such a system provides a 2-dimensional framework to explore magnetic field lines and how magnetic fields can be structurally changed using attraction and repulsion of magnets at different positions and distances. The IU MU Transducer functions to make invisible magnetic fields visible. The zoom function of the IU MU Transducer allows for exploratory examination of different layers within the magnetic field lines.

### Inverted Reciprocal Relationships in the IU MU Transducer

An atomic model for visualization of nuclear processes within the atom associated with unstable atom radioactive decay systems is performed using the IU MU Transducer. The IU component is an unseen SUSY DE DM system, and the MU is the atomic system with a Boson quark charge calculation framework. The singularity at the center of the single atom housed within the atomic ring of the phenolics (royal jelly protein monoatomic healing technology), has a different set of functional parameters that produces unusual physics. The dynamic aspects of the unstable atoms are modelled using an inversion and reciprocal functionality associated with a video feedback loop system whereby mirror symmetry states can be established with an inverted geometry (180 degrees), which provides layered interference patterns with temporal information. The setup includes a camera filming a screen that is displaying the image that of the video camera. Such a setup provides a mirror symmetry inversion system corresponding to a matter (real physical system) and anti-matter (artificial representations of the real system) as the display on the screen. The rotation of the camera in a clockwise direction result in the motion of the anti-matter screen system in an anticlockwise orientation. The zooming inward provides a magnification of the light to the point where unusual features of light emerge as the slowing down and the observation of a fluidic property of light itself giving rise to observational studies that provide the basis for the development of the SUSY inversion, He-BEC isotropic singularity model. The isotope physics systems under investigation give rise to complex temporal and structural changes within atoms that cannot be readily ascertained using conventional scientific equipment and the basis for the new understanding gained from the use of the IU MU Transducer is a controller that enables on demand functionality to generate unstable atomic systems that can be controller to provide the basis for the development of new technologies that have commercial application. The IU MU Transducer allows the detailed investigation of the unseen processes within unstable atoms using Planck resolution to enable evaluation of unstable atom energies giving rise to LENR processes that can be utilized to do work in the MU environment.

Fluidic Properties of the Central Singularity within the Video Feedback Loop.

This central location has fluidic properties as if light has been slowed down to the point where it acts more like a fluid than a gas with faster mobility as an analogy. The model developed associated with dark matter gives a basis for the unseen aspects of the universe having a function in atomic theory and being associated with a fluidic system operating within the atom beyond the limitations of measurement. This equates to the superfluid like properties of the He-BEC singularity and how it has specific functionality.

Temporal video feedback loop of the IU MU Transducer allowing investigation of temporal features of isotope decay physics where the light is cycled around within a closed loop giving rise to temporal features with a central vanishing point that contains a collected reservoir of light corresponding to the gravitational inward flowing of light into an atomic singularity. Such a model gives a framework for temporal implosion from the initial state based on a decrease in distance and the equivalent gravitational processes has been devised in the He-BEC isotropic singularity framework. Having a central location (nucleus) within the atom and its central Planck reference point provides the basis for creating an energy conservation law to balance the inward gravitational process with the outward cosmological inflationary process. The IU MU Transducer with its temporal and spatial features providing a valuable model for a new atomic theory allows exploration of materials with unusual physics properties from a novel standpoint in a temporal dynamic and interactive device.

A layer of aluminum foil was placed over top of the CRT 20 keV television tube that had been orientated in such a way that the screen was horizontal. A single pinhole was placed into the foil and the video feedback light loop was setup that produced an image that corresponded to an interference pattern corresponding to the wavelike nature of light in the double slit experiment. In this case the IU MU Transducer with its temporal functionality gave a similar wave pattern with only one whole. The ability to do spectral analysis of the light that passes through the small hole provides the basis for spectroscopic interrogation of a sample that can be placed inside the IU MU transducer sample window. Analysis of the photons emitted using a spectroscope was performed to obtain Fraunhofer line information which is utilized for mineral analysis of stars in cosmological setting. In this case the IU MU Transducer can facilitate the analysis of a sample from its spectral characteristics. The isotope physics mediated processes can also be investigated using the IU MU Transducer. This provides a simple functional tool that has temporal dynamics that can be observed using the feedback frequencies associated with the video feedback system of the IU MU Transducer.

Remote analysis to prevent observer interference with the isotope decay systems operating is also a function of the IU MU Transducer. The feature of blue tooth screen sharing with other devices is a function of the Chrome Cast feature on a laptop. The spectroscopic information was a test using a Sony video camera was performed to demonstrate the casting functionality allowing remote observation of the functional system. The IU MU Transducer can be run in manual mode or via automation with the OpEMCSS and AUP operating systems providing the video feedback control signal inputs corresponding to the desired automated learning and control system.

Specific wavelengths based on the Fraunhofer spectral signals provide a basis for the isotope physics mediated reorganization of the atoms, internal structures below the wavelengths of visible light. This gives rise to a feedback control where the signal output via comparative analysis with the SUSY DE DM framework generates an expected output because of the change in geometry of the atom based on the signal input. The cyclic feedback of the IU MU Transducer gives rise to the functional properties of control and regulation of the energy output which is based on the decay parameters. The decay output giving rise to the input signal for the next iteration of the learned response framework that enables the system to operate independently with the use of the AI mediated signal processing.

One of the functional outputs of the spectroscopic element of the IU MU Transducer is a tabulated numerological set of wavelength intensities that provides the input data stream in real-time for the AUP processing system that allows analysis of the synchronicities associated with isotope mediated processes. A spectroscopic output is also available giving visual information of changes in spectral information over a range of nanometer range with different flux intensities (FIG. 67).

Cyclic video interference operating in the IU MU Transducer. Photonic waves cycle through the photonic data that operate when the video looping was operating. The waves did not occur on the spectroscope when the video signal from the camera was disconnected from the CRT screen. The spectroscopic camera was pointed at the CRT screen and a 45-degree double sided mirror and the spectroscope was used to analyze the photon video feedback cyclic loop system of the IU MU Transducer.

The waves passed through the spectroscope 3D profile in a regular fashion having a repeatable timing associated with the width of the wave as well as the velocities of the wave front and rear were slightly different giving rise to an increasing width of the wavelength as part of the photon expansion. The IU MU Transducer wavefunction information was analyzed for the timing of the wavefront and rear wave velocities as the passed through the spectroscopic 3D analysis window.

A functional statistical difference between the velocity of the wavefront and the wave rear. The IU MU Transducer observation of the differential velocities in the wave front and rear gives rise to the modular understanding of the different velocities in the generation of the formation of π and the model for the v³ and c³ bi-directional membrane in the hydrogen orbital at n=1, 91.2 nm.

$$\frac{( \sqrt{v} + \frac{1}{α} )}{( \sqrt{c} + \frac{1}{α} )} = π$$

The differential relationships in velocities giving rise to atomic functionality associated with the formation of positron and electron pairs out of the vacuum of space and this being directly linked to the IU generation of DM. The time between the waves was consistent with no statistical significance in the temporal features of the time between the waves. On average the wave passed through the spectroscope every 3.52 seconds.

### Kinetic Analysis of Wavefunction

Kinetic analysis of the wavefront and the theoretical model based on Km and Vmax and the aetheric Dark matter system as part of the He-BEC SUSY DE DM isotropic singularity model. The IU MU Transducer provided valuable information relating to the fluidic nature of space as observed in the temporal video feedback capture window. Such a fluidic space-like liquid provided a model for space-time kinetic analysis to determine the features of the atomic inflationary processes operating within the SUSY inversion DE DM system as exemplified by the SUSY DE DM model of the hydrogen atom.

The Bohr model of the hydrogen atom is obtained by a central positively charged proton and an electron with a negative charge present in the electron orbitals at quite some distance form the nucleus of the atom. This framework provides the basis for a standard teaching of the structure of the proton in biology. The first electron orbital layer that the electron can occupy in the hydrogen atom is known as the Lyman line electron transition or n=1 layer at 91.2 nm. The next layer. N=2 Balmer line electron transition is at 2²=4*91.2 nm=364.8 nm and the third layer n=3 Paschen line corresponds to 820.2 nm. This model of the location of the electron within the s orbital layers of the hydrogen atom is one structure that is taught to biological scientists.

Another model for the hydrogen atom is based on quantum mechanics. In the quantum mechanical framework, the electron is a quantum object and is therefore subjected to uncertainty regarding its position and its momentum within the hydrogen atom. This provides a statistical and probability-based location of the electrons position as a wavefunction, and the electron's position is based on the Schrodinger equation and the probability obtained by squaring the wavefunction. Measurement is required to identify the location but measuring causes loss of information related to the particle's momentum. This is attributed to the collapse of the wavefunction into a defined location. What causes this collapse is an observer making a measurement. There are many possible states but only one functional outcome based on the measurement made. So, it goes from a range of possibilities to one definite outcome. This cloud of possibilities does not provide a discrete picture for the hydrogen atom. The electron is therefore located as a cloud of potential locations.

The SUSY inversion DE DM system provides a new interpretation of the hydrogen atom that is based on an empirical set of calculations that provides the basis for knowing both the location as well as the velocity of the electron within the hydrogen atom. This logical framework forms the basis of non-interactive logic. It provides the basis for knowing the position based on a theoretical framework that includes DE and DM, which comprises 95% of the universe. The SUSY DE DM model provides a structure to space and time giving rise to a central reference point within each single atom at the Planck Epoch of 5.12 E−44 s and 1.616 E−35 meter. By placing the atom within an aromatic ring cavity that confines its location to a defined environment and using mathematical model of the equilibrium position of that single atom. The location and momentum of the quantum particle (electron) can be modelled in sufficient detail as to be able to know both its momentum and location. Such a singularity physics framework has been developed to explore the functionality of the mono-atomic mineral coordination complexes with the phenolics bound to the royal jelly proteins isolated from Manuka honey (MEL-RJPI). The model developed is based on first principles and does not require measurement to ascertain key features of the quantum object.

The IU MU Transducer has provided confirmatory information as to the inverted reciprocal nature of the atomic structure and Boson statistical framework used to understand quark charge calculations that confer Baryonic symmetry and charge conservation rules between electrons and quarks in K+ electron capture. The revision of the quark charge calculations gives rise to the discovery of positrons in atomic structure as their charge cancels the negatively charged neutron and provides for the basis of the increased mass of the neutron compared to the proton as well as its short half-life of 888 seconds. The revision of quark charge calculations provides the basis for SUSY inversion where the quarks have whole number charges like Bosons rather than the Fermion fractional charges. The Pauli exclusion principle does not apply to the Boson like quarks in a Bose Einstein Condensate. The features of the universe appear to be derived from such an initial structure.

The SUSY inversion model of the hydrogen atom therefore consists of three quarks and the electron. The quarks having Boson properties and the Up quark carrying a −1 charge within the nucleus of the atom. The Down quark having a +1 charge. Therefore, the Up and Down quark pair has no charge. The remaining quark carries a positive or negative charge. The proton with two Up quarks and one Down quark if added would give −1 charge. However, the Boson statistical model for SUSY inversion provides a multiplication process where the two negatively charged quarks are multiplied to give a positively charged proton. The electron, which is also negatively charged when added to the positively charged proton gives an overall charge of zero. Such a model is also seen with the neutron and positron. Overall, the adding of the neutrons −1 charge and the positrons +1 charge provides the basis of a zero charge. As the model provides the basis of a framework of four components (three quarks and one electron) for the proton the SUSY inversion model explores the symmetry of the proton within the single atom aromatic ring system. This provides the basis for the hydrogen atom being considered as an inverted symmetry model of two positrons and one electron within the quark model of the proton. This can be understood in terms of a Up quark (−1) giving rise to a positron when released from the nucleus of the atom. The Down quark (+1) converts into an electron (−1) when released from the nucleus of the atom. As there is an electron on the outside of the nucleus this has not gone through an inversion to retain its charge based on its original state.

The beta plus and beta minus decay system associated with inversion of quark charge calculations was revised based on the inclusion of positrons within the neutrons structure. This provides a model that can explain the conservation of energy rules operating within atomic decay processes. It is these rules that form the framework for the SUSY inversion DE DM systems science model, which is used as part of the IU MU Transducers comparative differential velocity analysis to provide the framework to access unstable atom theory and its application and implications associated with functional biological processes operating within cells. The evolutionary aspects of biological systems through an isotope mediated transition and energy conservation system provides a way forward to explaining how the universe has created life from its original structure. This is shown through the energy conservation rules mediated through isotope transitions from the original singularity structure.

A unified field theory based on the He-BEC model has been developed via the SUSY inversion DE DM framework. This creates boundary conditions for the start of the universe from the original singularity. The energy conservation transition via alpha particle decay, within the SUSY DE DM framework gives rise to an initial 75% DE and 25% DM at TO. The transition point from the He-BEC to DE and DM. The functional geometry and its relevant energy systems give rise to cosmic inflation. In addition to inflation there is a DM gravitational implosion process that gives rise to the Planck singularity within each atom (Planck scale atomic reference at x,y,z 0,0,0). The Planck scale therefore is a function of the gravitational inward process originating from the He-BEC system.

The reciprocal to the Planck is 1/Planck=6.25 E+34 meters. This number is also the functional number of Planck lengths per meter. A meter scale framework given in Planck lengths is obtained. The original He-BEC diameter was r=c giving rise to a 1 second time frame equal to 299,792,458 m/s. This forms one aspect of the He-BEC model.

### The Fluidic Nature of the Singularity and the Kinetic Analysis of the Hydrogen Atom.

With the inclusion of positrons in the atomic structure along with the framework of DE and DM providing a set of boundary conditions through which a single atom via its internal Planck reference point can be inverted via reciprocal calculations gives rise to a theoretical model for the atom that can be explored in a 1 m³ volume. The 1/Planck volume in 1 m³ is given by the calculation of 4/3×π×6.25 E+34³=1.0227 E+105 PL³.

Features of the model allow very small scales to become very large scales via reciprocal inversion. The temporal microscopic analysis obtained with the IU MU Transducer provides the basis for exploring such a functional model in atomic structure to make the features of the universe that are unable to be observed using measurement approaches measurable via an inverted theoretical model.

One of the features of the model that supports the functional structure of the hydrogen atom based on the SUSY inversion framework is obtaining a differential velocity approach to identify the ionization energy of hydrogen from the n=1 Lyman line layer of the atom. This is based on the mathematical calculation for the √v³c³/6.25 E+25=13.58 nm giving a reason for the ionization of hydrogen related to alpha particle emission velocity from the He-BEC as well as the speed of light in a vacuum. This is a volumetric term with a reciprocal calculation corresponding to the Planck scale to nm scale conversion factor (6.25 E+25). This gives rise to a nm distance equivalent to eV ionization energy.

The inversion within the hydrogen atom is seen where 13.58 nm=91.2 eV and 91.2 nm=13.58 eV. The linkage to velocity of v and c in cubic form gives rise to m³ to Planck length relationship. Such a volume to distance relationship provides a window into relativistic modelling of the hydrogen atom via singularity inversion at the Planck reference point at the center of the atom.

N=2 transitions (Table 5). The nm distances were converted into KJ/mol (m/s) velocities using an online tool. This places the position relative to the Planck reference in nm providing a gravitational gradient where mass is a feature of proximity to the Planck scale reference point at the centre of the atom.

The differential velocity analysis was performed to obtain all the transitions associated with the other positions of the electron within the framework of the Lyman line. The differential velocities were converted back into nm to confirm the identification of the other transition series. The conversion into m/s provided a way to compare to the IU velocity of v originating from the He-BEC isotropic singularity and the SUSY inversion DE DM framework for quark charge calculations. The Balmer line electron transitions were plotted versus the KJ/mol (m/s) to generate the graph in FIG. 70.

The IU MU Transducer uses the Planck reference to explore isotope physics mediated processes within the singular atom framework obtained through the conversion of particle masses from the Standard Model of Particle Physics and converting these into nm distances from the Planck reference point. This then allows conversion of the known particle masses into velocities (KJ/mol m/s) located at specific distances away from the Planck reference point within the atom. The half-life of the various particles and their masses are then used to obtain both velocity information and position within the single atom model. This gives rise to being able to locate the whereabouts of each particle within the singularity model in a temporal (half-life) and spatial (nm↔KJ/mol (m/s)) framework. This model goes beyond the measurable features operating within atoms. As an example, the tau particle is obtained with a half-life of 2.903 E−13 seconds and a mass of 1,777 MeV corresponding to 6.98 E−07 nm and a velocity of 1.71 E+11 KJ/mol at that position within the single atom model. Based on the half-life calculations the m/s×s=m. This can then be converted into nm using 1 E+9 and this provides the new position with its respective velocity based on the conversion from nm to KJ/mol. The new location at 22.8 nm at 78702 m/s giving a functional relationship to the other components within the atomic assembly line leading to the formation of a new atom based on the processes operating within the atom during isotope decay of beta plus and beta minus that 44 tilizes the W Boson timing of 3 E−15 s. This information is highlighting the functionality of the IU MU Transducer's ability to explore atomic theory based on temporal and spatial properties of the three generations of Leptons and their respective neutrinos as well as the quarks and the differential velocities to the W and Z and Higgs Bosons along with the reference to the Planck Epoch of 5.12 E−44 second. The development of a navigation framework bounded by DE and DM arising from the He-BEC model provides the conservation of energy rules operating within the atomic universe through the SUSY inversion model and its relevance to isotope physics decay systems.

The Lyman line differential velocity was analyzed using a double reciprocal plot of 1/KJ/mol vs. 1/nm (Lineweaver Burke plot). This was performed in order to explore the functional properties of the hydrogen atom in terms of its kinetic properties related to Km and Vmax where the rate of reaction is determined by KJ/mol (m/s) and the substrate concentration was determined by the nm distance away from the Planck reference point as shown above to be linked to the gravitational process within the subatomic structure of the hydrogen atom.

The various atomic layers obtained by differential velocity were converted into the double reciprocal dataset and the data plotted using Lineweaver Burke plot.

The rate of Vmax changed from fastest at n=1 and slowest at n=4. The Km also changed from 1/alpha at n=1 and 17414 which is 100 more than √c. Finding relevant information in the kinetic analysis of the differential velocity kinetic data for the hydrogen atom provides context for the relationship between atomic structure and differential velocities. This provides another aspect of the IU MU Transducers reference framework that allows comparative analysis to differential velocities within single atoms operating in an inverted Planck scale singularity framework.

The change in Km and the change in Vmax associated with each atomic orbital layer provides further information of an atomic expansionary processes within the atom itself that is mediated through a change in the affinity and a change in the velocity of the expansion. As things get further away from the atomic Planck central reference point, they slow down. The slowing down reduces the velocity of atomic expansion where Vmax decreases from n=1>n=4. The affinity Km decreases from n=1<n=4.

The atomic rate of inflation was analyzed to give comparative analysis of the change in Km versus 1/nm giving rise to a power law functionality that is related to the golden mean ratio. The power function of −0.618 is related to 1/0.618=1.618 and this number is seen in the Lucas and Fibonacci sequences of numbers which provides a direct link to biological structures of known significance. This agreement with known physiological systems in nature provides the basis for exploring space within atoms utilising enzymatic kinetic methodologies. This provides a deep understanding of the properties of atomic systems in terms of the functional processes operating within them is related to differential velocity and this mediates a language based on energy conservation rules in the singularity physics framework of SUSY inversion DE DM and provides the basis for learning the rules of isotope physics mediated transitions which the IU MU Transducer provides via the unsupervised learning of the AUP and OpEMCSS.

The hydrogen atom can therefore be modelled as an enzyme with Km and Vmax based on differential velocities of the respective electron transitions. The features of the hydrogen atom in the SUSY inversion framework have been able to identify 1/alpha fine structure constant associated with n=1 Km and an affinity for space. Furthermore, the model provides a basis for electron charge of 3.2 E−19 C/2 giving 1.602 E−19 C. The SUSY inversion singularity structure of the hydrogen atom where n=4 is connected to √c=17314+100. The origin of the 100 is an aspect of the origin differential distance between 2 E−7 and 2 E−9, which are features of the He-BEC model of 4 E−14 m and 4 E−18 m, which differs by 10,000. The 410,000=100.

As more of the pieces of the He-BEC model are integrated into a functional IU MU Transducer the model develops additional predictive power. The relationships between the various temporal and spatial features of isotope decay physics becomes a newly understood learned language. This single atom framework of inverted Planck provides a basis for navigation within the unseen dimensions of isotope physics that provide diagnostic information as to the location and momentum of the quantum object within the atomic structure and allows integration of gravitational processes with the Strong Force through the establishment of a reciprocal relationship. The SUSY inversion He-BEC isotopic singularity framework provides the basis of the reference framework that provides the comparative analysis for the IU MU Transducer's isotope physics energy conservation learning module.

### The He-BEC Model and Energy Conservation

The current model that science has created for materialism is foundational to an external physical model of reality. The human being is seen as a collection of different molecules and atoms within this framework. This model provides the basis of the reductionist's approach that is founded on measurement as the basis for the categorization of all the functions operating within a cellular framework: The processes are seen in terms of this model. This offers a Newtonian vantage point from which we can see a cell packed full of different molecules. The complexity provides confusion as the dynamics of space and time within cells are not considered in a materialism setting.

The He-BEC model offers an alternative model focused on the forces within the atom. Unification via the atomic forces offers a simplification whereby the internal workings of the atom are explored through isotope physics mediated transitions. This offers a new set of rules in which to explore atomic theory.

One of the foundational rules provided by the He-BEC isotropic singularity framework is energy conservation. This law is seen in the following mathematical formalization.

$$\frac{\sqrt{v}}{v} = \frac{1}{\sqrt{v}}$$

The context for energy conservation and the relationship to inverse square law where

$$v = {( \sqrt{v} )}^{2}$$

The establishment of a relationship between the organization and structure of the original singularity (He-BEC) with v can be explored using the conversion of nm 0.00004 (4 E−14 m) and conversion into KJ/mol (m/s) binding energy of the Helium Bose Einstein Condensate Singularity (4/2 He). This corresponds to v=2990700000 m/s and √v=54687.29 m/s. The reciprocal relationship between √v/v=1.82858 E−05. The inversion of this or its reciprocal relationship of 1/1.82858 E−05=54687.29286. This is an energy conservation inverse square law relationship that is operating within a single atom system where the KJ/mol nm (m/s) relationship as outlined above establishes a gravitational inverse square law relationship between the meter scale atom and its position and momentum and timing via isotope decay half-life framework.

The accuracy of the half-life timing system is exemplified by the alpha particle decay from the He-BEC isotropic singularity model. The SUSY inversion framework provides 16 parts to each helium atom, with the inclusion of positrons within the neutron zero charge framework of revised quark charge calculations. The alpha particle emission 75% (12/16) per atom of helium at 2990700000 m/s and 24% inward 25% (4/16) per atom of helium at 54687.29286 m/s. The decay half-life of helium's alpha particles is 1 E+18 seconds. After 13.8 billion years 7.26% decay of alpha particles has occurred giving rise to 67.74% DE and 27.42% DM, and 4.84% matter as the composition of the universe. This Baryonic symmetry model that uses energy conservation via isotope physics mediated transitions exemplifies a model that represents the universe composition as we understand it today. The He-BEC model therefore provides the basis of unification of all the universe as an original singularity before the beginning of time. The ability to predict the composition of the universe after 13.8 billion years offers insight into the functionality of the model as a comparative model for developing technological innovation based on learning the rules of isotope decay physics operating in the temporal and spatial dynamics of individual atoms house in the aromatic rings of phenolics bound to the royal jelly proteins isolated from Manuka honey.

The functionality of time itself within the isotope physics framework offers insight into temporal features in the three generations of Leptons. Putting this time frame of W Boson 3 E−25 s into the Planck Epoch of 5.12 E−44 s and all of time 4.35495 E+17 s and time when first light occurred within the universe as 380,000 years after the beginning 1.1991888 E+13 s places a temporal framework for the inflationary Epoch of 1 E−32 s and temporal features of isotope decay systems are investigated in terms of categorization into functional processes including beta decay, alpha particle emission, neutron decay, proton decay, K+ electron capture, spontaneous fission, positron emission (beta plus), electron emission (beta minus), the photo-electric effect, as well as plasma states (nucleus), ionized states, isotope states, and stable states. The development of an atomic evolutionary framework for transitions of one atom evolving into another atom via isotope physics conservation of energy rules exemplified by the He-BEC isotropic singularity energy conservation framework provides the basis for the AUP and OpenCSS learning models and the AI interface provides a capture and evaluation window into the non-interactive logic of the SUSY DE UM model that predates atom generation and the atomic decay processes that leads to stable atom formation. This provides the stage in which matter is formed and the processes through which matter is created via Baryonic symmetry systems in the isotope physics mediated decay.

Having established a functional model since the IU MU Transducer isotope physics processes are temporal features of the unconscious mind. This provides the memory with a process that is linked to time reversal. This is connected to neurotransmitter function. It provides a functional input of hydrogen that is associated with a quadrupole arrangement. Such a model is observed in the IU MU Transducer setup. The hexagon ring faraday cage system protecting the isotopes formed within the ring generates a time reversal energy system connected to light via hydrogen biology. This functionality is utilised by the IU MU Transducer where the geometry arrangement is harnessed and the Faraday cage isolated environment whereby the atoms can reorganize themselves into geometries based on functional inputs (e.g., laser light), and the fluidic reaction chamber at the centre of the IU MU Transducer can capture and process the photonic inputs and provide the atomic calculations to give the isotope decay outputs as the functional spectroscopic analysis of Fraunhofer lines gives rise to the atomic transitions in the E/M field of the atom undergoing the transition. The 1/137 spectral line splitting observed in cosmology is observed in the Km and Vmax dataset for hydrogen at n=1 Lyman line electron transition and thus provides the basis for a new atomic model and understanding of the origin of alpha fine structure constant and the processes operating within atoms.

S Orbital Inversion and Concave and Convex Lens Effects within the Atomic Landscape

Concave and convex surfaces provide different orientations of photons, and a pinhole camera inversion provides a framework to explore atom s orbital surfaces both internal concave and external convex via a change in the orientation of the of the image as well as the concept that the electron surface area corresponds to 1.602 E−19 C (Joules). The radius of 2 E−9 m corresponds to 5 E+8 m which is a surface area of 3.14 E+18 meters. The inversion 1/3.14 E+18=3.18 E−19 C (m⁻¹). This is double 1.602 E−19C×2=3.2 E−19 C. This indicates that it is an inside and outside surface area corresponding to charge separation by 1/137.036 as the width of the membrane that separates the opposites charges. This provides context for negatively charge concave surface and the convex positively charged surface. Concave and convex surfaces are linked to c and v, where c³=0.43 nm and v³=427.29 nm. The average of these is 13.58 nm and this corresponds to ionization energy of hydrogen at n=1, located at 91.2 nm. It places c³ with the negative charge on the internal surface area and the v³ with the positive charge on the external surface area. The tunnelling system operating via a singularity relationship between 2 E−9/1.6 E−35 m=1.25 E+26/6.25 E+25=2 nm. This quantum tunnelling system is linked to the Planck singularity via meson processes.

Another part associated with the mass of the quantum particle corresponds to the relationship between Planck time 5.12 E−44 s and the Higgs Boson half-life of 1.6 E−22 s which is also linked to the diameter of the electron of 4 E−18 m, where 4 E−18/1.6 E−22=25,000 and 1/25,000=0.00004 nm (4 E−14 m). The He-BEC model converts 4 E−14 m to 2990700000 m/s as v and links the Higgs half-life to Planck length via 1.6 E−22/1.6 E−35=1 E+13. The Higgs Boson half-life 1.6 E−22 s is linked to Gravity which is 6.67 E−11 kg⁻¹ m³ s⁻². Where G is also linked to v via outlined in equation 1.

$$\begin{matrix}Origin of G & \\ \frac{\frac{1}{v} + \frac{1}{v}}{\frac{c}{v}} = G & Equation 1\end{matrix}$$

The reciprocal inverse square law energy conservation system allows substitution of v with (√v×√v). This corresponds to the He-BEC SUSY DM (4/16=25%) implosive process. This is the inversion process that balances the cosmological inflationary DE system corresponding to 12/16=75% DE at T0.

Both systems operate synchronously to maintain the conservation of energy and charge rules that operate in the IU MU Transducer setup.

Concave surfaces invert the image whereas convex surfaces retain the original orientation of the image. The SUSY inversion process for beta plus and beta minus result in an energy conservation process within the atomic system but the quark becomes the opposite charge based on the inversion of the positron to become the negatively charged Up quark in the newly formed proton in beta minus system. The neutron's Down quark (positive) is emitted out of the nucleus and is inverted to become the negatively charged electron. By matching the energy inward with the energy outward processes, the reorganization of the atomic structure during beta decay operates in such a way as to create a more stable atom. The temporal and spatial rules of this processes are being learned by utilizing the IU MU Transducer so that the isotope physics LENR rules can be understood from this new perspective, which includes positrons in the neutron structure.

The Russian doll features of the s orbitals within hydrogen and other atomic systems provides an internal set of functional rules whereby the location and velocity of each quantum particle can be identified through an inverse square law model that has the internal reference point of the DM Planck singularity which has been generated from the He-BEC isotropic singularity over a period of 13.8 E+9 years. This model provides the underlying rules of the composition of the universe as well as features of the cosmological constants of nature. Processes involved in particle formation is also able to be determined via differential velocity between the concave and convex layers of the orbital separated by the reciprocal of the alpha fine structure constant as shown by the kinetic analysis of the hydrogen atom and its Lineweaver Burke plot analysis of the Lyman line electron transitions nm distances converted into the KJ/mol (m/s) velocities corresponding to the gravitational processes operating within the hydrogen atom. The fluidic expansionary process corresponding to 1/alpha at n=1 Lyman line electron transition. The expansion is driven partly by a Fibonacci golden circle ratio system corresponding to the mono-atomic coordination complexes that give rise to the formation of the unstable atoms within the ring. The identification of cosmological inflationary processes based on alpha particle emission (faster than light) gives further insight into the atomic velocity system that works alongside c (speed of light) to give the charges on either side of surface of the s orbital structure within the hydrogen atom n=1 layer at 91.2 nm corresponding to the 13.58 eV ionization energy. The separation of the two charges by 1/α and this gives rise to a Km affinity and Vmax spatial expansion within the atomic system of hydrogen. This brings together a new atomic model for hydrogen that is functional in terms of atomic expansion and linked to the process of quantum tunnelling and entanglement operating within the aromatic ring system of the MEL-RJPI apitherapy.

### DVD-R Experiment and Modification of Surface Polymer by Unusual Physics

A DVD-R writable disk was used as a detection surface where the MEL-RJPI sample along with FeSO4 and 1 microL of H₂O₂ was mixed and excited with 405 nm Blue laser as well as a 650 nm red laser. The reactions taking place stimulate photo-Fenton chemistry and the generation of hydroxyl radicals that function to load up energy into the aromatic rings of phenolic compounds present within the MEL-RJPI.

The formation of surface changes on the DVD-R disc indicates that the photonic properties of the material emit high energy particles that produced the changes on the disc surface. The finished product looks like honey which was interesting as it indicated that the chemistry is potentially useful in the transition of nectar into honey that naturally occurs within the hive. This suggests a reason why bees add enzymes into the nectar as they process it into honey. Additional information regarding the drying of the liquid associated with the thermal properties of photo-Fenton chemistry provides a potential reason why hives heat up during the production of the honey. The IU MU Transducer provides a tool to investigate the functional changes that occur within the generation of honey from nectar performed by bees.

A: Spectroscopic 3D map and B: CRT screen with quadrupole magnet arrangement. Fenton chemistry gives rise to stored monoatomic mineral coordination complexes that reside within the aromatic ring. The hydroxylation of the aromatic ring with hydroxyl radicals, generated by photo-Fenton chemistry generates a process whereby the atom within the aromatic ring is released which then creates the single atom atomic energy LENR process that is functional in biological systems. As these release considerable energy MeV levels, it can be observed through the emission of a range of specific particles which gives the energy for transformation in biological systems. The emission release results in a spectroscopic change picked up by the spectroscope and the Fraunhofer line transitions gives rise to information that can identity the atom responsible for the emission process. The Fenton chemistry is used to create unstable atoms and their release through the hydroxylation of the aromatic ring. This provides a system that can emit LENR for healing and regeneration. The modelling of such a system provides the basis for the SUSY inversion model and the revision of quark charge calculations to enable Baryonic symmetry. This is the proposed single atom system that can be used to explore isotopes residing within the aromatic ring and provides the basis for exploration and interrogation of various products for their ability to enable LENR in a controlled fashion.

### IU MU Transducer Setup

FIG. 76, the cross represents the functional AI learning system that provides the unsupervised learning of the isotope decay systems operating within the sample and the features of geometric change that provides the temporal and functional energy generation as the output via the AUP processor in conjunction with the OpEMCSS model that has a comparative 1 atom inverted singularity framework of the SUSY DE DM model that is a functional universal predictor based on non-interactive logic through the Baryonic He-BEC isotropic singularity model.

The modular nature of the IU MU Transducer provides the flexibility to interrogate a range of unusual physics phenomenon associated with isotope physics. The single atom framework of SUSY DE DM has relevance to the single atoms and isotopes coordinated to the aromatic rings of the phenolics bound to the royal jelly proteins isolated from Manuka honey. By studying single atoms within the aromatic ring, a functional model can be developed for isotopes that has functional relevance to biological systems. This provides the basis for unstable atoms having functional relevance in the memory system connected to neurotransmitter function. The He-BEC model provides a unified singularity physics framework that provides context for how atoms have a functional atomic processor that has rules based on isotope physics. Learning these rules enables a functional transition of solid matter physics to isotope electromagnetic processes operating within the atom that are consistent with biological processes.

Modelling this single atom system into macroscopic systems enables a transition from using external force to influence systems to do work and allows the transition to an internal operational process within the isotope physics decay systems giving rise to the harnessing of latent energy within the reorganization of the atoms structure via isotope physics to do work in an external environment. This is how biological systems operate.

### Photo-Fenton Chemistry Example and Analysis Using the IU MU Transducer

The light is captured by single atoms of iron that is coordinated to the aromatic ring of the plant phenolics collected by the bees isolated from Manuka honey. The iron changes its properties going from Fe3+ to Fe2+.

This photo-reduction is indicative of a specific form of iron. 54/26 Fe (Stable), 55/26 Fe (electron capture), 56/26 Fe (Stable), 57/26 Fe (Stable), 58/26 Fe (Stable). The K+ electron capture isotope of iron 55/26 Fe on capture of the electron from the K shell gives 55/25 Mn (Stable).

The photon reduction of ion from the Fe 3+ charged state to the Fe 2+ charged state involves the addition of one electron from the photon. The K shell electron joins with a proton in K+ electron capture and the number of protons is decreased by 1. The iron 55/26 Fe is converted into 55/25 Mn a stable form of Mn.

There are 8 different oxidation states for iron. There are 28 different isotopes for iron.

|K(1s)|7112eV|

20 keV CRT screen provides sufficiently energetic electrons to reduce Fe3+ to Fe2+.

The iron is unreactive as Fe3+ towards hydrogen peroxide but reactive towards hydrogen peroxide when it is photo-reduced. The use light as an input to control the rate of reaction. Light having quantum properties being both a wave and a particle depending on the rules of observation. You can control the reaction using hydrogen peroxide concentration, wavelengths of light and the intensity of light.

There is an input of energy into the aromatic ring. What is inside of the ring is hidden from the outside. Think of it like an event horizon where the only thing that is small enough and the right shape to enter the ring is hydrogen (proton tunnelling system). The hydrogen tunnels into the ring. It stays in there until we use the photo-Fenton chemistry and the reactivity of the hydroxyl radical OH* to hydroxylate the aromatic ring and release the atom/isotope from inside of the ring. As the ring faraday cage system has hidden the atom that has been grown through the hydrogen input into the ring, we have little knowledge of what energy output we are going to get until the ring is broken and the unstable atom within the ring is released. Information on the identity of the atom within the ring can be obtained through laser input and spectroscopic output. These features are the connected to the OpEMCSS control of the analysis of atom/isotope identity of which atom and what decay process is operating within the ring system.

The use of a laser light and the microscope (NanoSight) has shown that the light in the ring can give functional feedback and that feedback is mediated through photoemissions where spectroscopic information has the potential to provide atomic diagnostic information as to what atom is in the ring along with which isotope depending on its twinkle emission (timings between emissions of photons).

The ability to intercept the spectral lines using a spectroscope has been shown. The Fraunhofer lines giving the atomic fingerprint. The temporal features e.g. Weak force timings around 1 E−13 second and Strong Force decay timings of 1 E−22 seconds offer spectral information as to what type of decay is responsible for the emission. This can be ascertained by the timings between emissions.

Light acts as a functional input into the entanglement of light into atomic form. It becomes the electromagnetic spectrum. The use of the hydroxyl radical system is an atomic energy harvesting system whereby the atoms that are within the ring (only room for one atom within the ring), provides the basis for recovery of the stored atomic energy. The release of this one atom energy system is controlled by light and the photo-reduction process of the coordinated atoms of iron.

The model of energy storage is the use of hydrogen as the input into the ring. Hydrogen has a different structure for the input into the ring. It is a balanced model of the proton and electron where mass and charge are not present. This corresponds to a geometry related to Einstein's c\hat{ }=E/M a cross 90-degree angle and the inverse square law features of every action having an equal and opposite reaction. So, the mass and charge are features of the atom's geometry. The no mass and no charge occur in the balance of opposites around a central point. It is as if the positron and electron pairs are arranged in a way that is aligned with a two-photon system in a cross based geometry. Under such an arrangement tunnelling of the proton into the ring can occur and so can the growth of the atom within the ring.

The confinement of the atomic space within the ring functions to facilitate the conversion of energy inputs into atomic outputs.

The IU/MU process is therefore a functional isotope physics transition system that uses temporal features of atomic decay to transition into new stable atoms from unstable ones. The energy is consistent with the transitions of the geometry. In other words, it uses the energy for the transformation of the atom from an unstable state towards atomic stability. To obtain the energy the release of the atom from the ring must be performed in a timely fashion that equates to control over the growth rate and the timing of release. These are the functional rules of the ring that need to be learned.

### Fenton Chemistry and Iron Electron Capture

Photon-Fenton chemistry requires electron capture of s orbital electrons in the L or K electron bands. Iron can perform K+ electron capture via these orbital electrons which converts the proton associated with the electron through tunnelling into a neutron. It is another way of balancing the books in terms of the SUSY inversion Baryonic symmetry system apparent operating within the atomic system.

The CRT TV emits 20 keV electrons which have sufficient energy to enable electron capture in iron Fe3+ allowing the electron reduction of iron to Fe2+. The reduction of iron then enables the reaction with hydrogen peroxide which generates the hydroxyl radical system that oxidizes biological materials into CO₂ and water as well as generating energy that can be captured and stored in different forms of atomic structures. This energy is used as a functional way to create LENR by growing atoms within the confines of aromatic ring system or hexagon lattice system of graphene or graphite (multi-layered graphene) sheet materials. The IU MU Transducer CRT screen 20 KeV electron system provides the energy for K+ electron capture enabling electron reduction of iron and was used to reduce iron to catalyze the Fenton chemistry.

Experiment: A 4B pencil was used to shade in a 1 cm×1 cm square section of paper towel (absorbent paper), the 1 cm² section of paper towel was cut out and placed into a 50 mL glass beaker. The beaker was placed on top of a 1 cm neodymium magnet on top of the CRT screen in the IU MU Transducer photonic feedback control system where the video camera was used to explore the functional reaction taking place. The addition of 1 mL of 30% hydrogen peroxide was added to the paper in the beaker. No reaction was observed. The several grains of Fe2+ sulphate was added to the paper and the reaction was commenced. The reaction generated a brown/red coloured Fe3+ and the CO₂ bubbles and water as expected. After 1 hour reaction the paper had completely disappeared. The material was left overnight at room temperature exposed to the air. After 24 hours the sample was collected and centrifuged at 13,200 rpm for 1 minutes at room temperature. The pallet material was observed at the bottom of the Eppendorf tube. The solution looked clear to the naked eye. Investigation of the solution before and after centrifugation was performed.

The generation of atomic energy within the graphite sheets from the photo-Fenton and Fenton-K+ electron capture mediated hydroxyl radical generation system provides a way to store atomic energy into the hexagonal ring system of the graphite. Separation of the graphite from the cellulose fibers can be obtained through their respective resistance to photo-Fenton chemistry and stability towards the hydroxyl radicals. Examining the material using coherent laser light provides additional observations associated with the quantum hall effect where charge is predominately distributed at the edge of the graphite materials generated in the reaction.

Several areas within the graphite demonstrated high photon intensities FIG. 80. This appears to be associated with the captured stored energy within the hexagon ring graphite structure. This further supports the idea that the energy generated by Fenton chemistry can be captured within aromatic ring systems for later use. The quantum tunnelling properties of Fenton chemistry is functionally useful in both a biological setting associated with Senolytic activity in apoptosis and phagocytosis but also industrially in combination with external materials that can function to store the energy within the ring system.

### REFERENCES

[1]. Clymer, J. R. and Amar M. Vakil, 2017. Exploring Combined Material and Information Universe to Discover New Physics Available on Research Gate.
[2]. Ben-Ya'acov, U. 2021. Godel's Incompleteness Theorem and Universal Physics Theories. Newest Updates in Physical Science Research Vol. 2. (March 2021), 79-89. DOI:https://doi.org/10.9734/bpi/nupsr/v2/7335D.
[3]. Clymer, J. R. and Amar M. Vakil., 2018. Quantum Particle Regulation in the Combined Material and Information Universe: Simulation Model, ResearchGate.
[4]. Clymer, J. R. and Amar M. Vakil., 2020. Evolution of Information Universe Rules to Regulate Material Universe Quantum Stability: Simulation Model, ResearchGate
[5] Clymer, J. R. 2017. Mathematics of Complex Adaptive Systems, Int. J. of Design & Nature and Ecodynamics. Vol. 12, No. 3, 377-384
[6]. Clymer, J. R., 2009. Simulation-Based Engineering of Complex Systems, Hoboken, NJ: John Wiley & Sons Inc.
[7]. Clymer, J. R. and Amar M. Vakil. 2022. IU MU System, Available on Research Gate.
[8]. F. S. Zaitsev, V. L. Bychkov. 2021. Mathematical Modeling of Electromagnetic and Gravitational Phenomena by the Methodology of Continuous Media Mechanics. MAKS PRESS. Moscow
[9]. Roschin & Godin: Magneto-Gravity Effects; Verification of the Searl Effect, Institute for High Temperatures, Russian Academy of Science, Izhorskaya 13/19, Moscow 127412, Russia (THIS INCLUDES UPDATED PATENTS as of 2023 and need to be appended to this reference)
[10]. Franceschetti, M. 2018. Wave Theory of Information, Cambridge University Press
[11] Perinotti, P., Tosini, A., and Vaglini, L. 2022. Shannon theory beyond quantum: information content of a source. arXiv:2112.12689v2
[12]. Gariaev, P. P, et al. 2011. DNA as Basis for Quantum Bio-computer, DNA Decipher Journal, Vol. 1, Issue 1,025-046.
[13]. Meijer, Dirk. K. F., 2020. A New Premise for Quantum Physics, Consciousness and Fabric of Reality, Available on Research Gate
[14]. Hill, Vanessa & Peter Rowlands. 2008. Natures Code, Available on ResearchGate.
[15]. “APEC 4/3 4K: Roger Shawyer's EmDrive & The Information Universe.” YouTube, APEC 4K, 28, Oct. 2021, https://www.youtube.com/watch?v=7oa9hVTT-Ok
[16] Giacomo Mauro D'Ariano, Paolo Perinotti, and Alessandro Tosini, 2020. Information and disturbance in operational probabilistic theories. Quantum 4, 363
[17] Modern Nonlinear Optics, Second Edition, 3 vols., edited by M. W. Evans, Wiley, 2001. The 3 volumes comprise a Special Topic issue as Vol. 119, I. Prigogine and S. A. Rice (series eds.), Advances in Chemical Physics, Wiley, ongoing.
[18] M. W. Evans, P. K. Anastasovski, T. E. Bearden et al., “Derivation of the B(3) Field and Concomitant Vacuum Energy Density from the Sachs Theory of Electrodynamics,” Foundations of Physics Letters, 14(6), December 2001, p. 589-593
[19]—“Development of the Sachs Theory of Electrodynamics,” Foundations of Physics Letters, 14(6), December 2001, p. 595-600;
[20]—“Explanation of the Motionless Electromagnetic Generator with 0(3) Electrodynamics,” Foundations of Physics Letters, 14(1), February 2001, p. 87-94.
[21]—“Explanation of the Motionless Electromagnetic Generator by Sachs's Theory of Electrodynamics,” Foundations of Physics Letters, 14(4), 2001, p. 387-393.
[22]—“Operator Derivation of the Gauge Invariant Proca and Lehnert Equation: Elimination of the Lorentz Condition,” Foundations of Physics, 39(7), 2000, p. 1123-1130.
[23]—“Effect of Vacuum Energy on the Atomic Spectra,” Foundations of Physics Letters, 13(3), June 2000, p. 289-296.
[24]—“Runaway Solutions of the Lehnert Equations: The Possibility of Extracting Energy from the Vacuum,” Optik, 111(9), 2000, p. 407-409.
[25]—“Classical Electrodynamics Without the Lorentz Condition: Extracting Energy from the Vacuum,” Physica Scripta 61(5), May 2000, p. 513-517.
[26]—“On the Representation of the Maxwell-Heaviside Equations in Terms of the Barut Field Four-Vector,” Optik 111(6), 2000, p. 246-248.
[27] “The New Maxwell Electrodynamic Equations: New Tools for New Technologies. A Collection of 60 papers from the Alpha Foundation's Institute for Advanced Study. Published as a Special Issue of the Journal of New Energy, 4(3), Winter 1999. 335 p.
[28] T. E. Bearden, “Extracting and Using Electromagnetic Energy from the Active Vacuum,” in M. W. Evans (ed.), Modern Nonlinear Optics, Second Edition, 3 vols., Wiley, 2001; Vol. 2, p. 639-698.
[29] T. E. Bearden, “Energy from the Active Vacuum: The Motionless Electromagnetic Generator,” in M. W. Evans (Ed.), Modern Nonlinear Optics, Second Edition, 3-vols., Wiley, 2001; Vol. 2, p. 699-776.
[30] T. E. Bearden, Energy from the Vacuum: Concepts and Principles, World Scientific, Singapore, 2002, in process.
[31] T. E. Bearden, “Giant Negentropy from the Common Dipole,” Proceedings of Congress 2000, St. Petersburg, Russia, Vol. 1, July 2000, p. 86-98. Also published in Journal of New Energy, 5(1), Summer 2000, p. 11-23. Also carried on DoE restricted website http://www.ott.doe.gov/electromagnetic/and www.cheniere.org.
[32] T. E. Bearden, “Bedini's Method For Forming Negative Resistors In Batteries,” Proceedings of Congress 2000, St. Petersburg, Russia, Vol. 1, July 2000, p. 24-38. Also published in Journal of New Energy, 5(1), Summer 2000, p. 24-38.
[33] Floyd Sweet and T. E. Bearden, “Utilizing Scalar Electromagnetics to Tap Vacuum Energy,” Proceedings of the 26th Intersociety Energy Conversion Engineering Conference (IECEC '91), Boston, Massachusetts, 1991, p. 370-375.
[34] M. W. Evans, “The Link Between the Sachs and O(3) Theories of Electrodynamics,” in M. W. Evans (Ed.), Modern Nonlinear Optics, Second Edition, 3 vols. Wiley, 2001; vol. 2, p. 469-494.
[35] M. W. Evans, “The Link Between the Topological Theory of Ranada and Trueba, the Sachs Theory, and O(3) Electrodynamics,” in M. W. Evans (Ed.), Modern Nonlinear Optics, Second Edition, 3 vols. Wiley, 2001, vol. 2, p. 495-499.
[36] M. W. Evans, “0(3) Electrodynamics,” a review in M. W. Evans (ed.), Modern Nonlinear Optics, Second Edition, 3 vols., Wiley, 2001; Vol. 2, p. 79-267.
[37] M. W. Evans and L. B. Crowell, Classical and Quantum Electrodynamics and the B(3) Field, World Scientific, Singapore, 2001.
[38] M. W. Evans and S. Jeffers, “The Present Status of the Quantum Theory of Light,” in M. W. Evans (ed.), Modern Nonlinear Optics, Second Edition, 3 vols., Wiley, 2001; Vol. 3, p. 1-196.
[39], B. Lehnert, “Optical Effects of an Extended Electromagnetic Theory,” in Modern Nonlinear Optics, Second Edition, 3 vols., Wiley, 2001; Vol. 2, p. 1-77.
[40]. Jack, P. M., 2003. Physical Space as a Quaternion Structure, I: Maxwell Equation. A Brief Note
[41]¹ Britannica, T. Editors of Encyclopaedia (2021, March 15). alpha decay. Encyclopedia Britannica. https://www.britannica.com/science/alpha-decay
[42] Vakil, A. “Smart Feature Collector” Final Research Paper for Mathematical Seminar Ottawa University
[43] United States Patent Application Publication, Clymer et al., Pub No.: US 2006/0224 A1, Pub Date Oct. 5, 2006

1: IU/MU Transducer toolbox that facilitates characterization of subatomic physics processes within atoms, which enables the integration of SUSY DE DM, AUP, OpEMCSS, TNLT and SEG functionality into a universal system for studying LENR processes.
claim 1a: A process of cataloging and classifying LENR systems through machine learning of AUP and OpEMCSS that identifies subatomic features using AI that gives rise to novel and unobvious physical phenomena.
claim 1b: A process according to claim 1a, where the LENR process analyzed by the IU/MU Transducer enables autonomous control of atomic structure through electromagnetic inputs that disturb, regulate, and provide feedback controls through the transduction of an information wave (IW) generated through LENR.
claim 1c: A claim according to claim 1b, where the IW energetics is characterized through SUSY DE DM framework to generate location and momentum data for positron and electron pairing in a quadrupole geometry that correlates to kJ/mole (m/s) velocities plotted against nm distances that provide gravitational subatomic characterization of LENR events.
claim 1d: A claim according to claim 1c, where the IW analyzed through SUSY DE DM calculations generates subatomic information through the analysis of Km and Vmax parameters associated with atomic inflation, which correlates positron and electron differential velocities (kJ/mole plotted against nm) determined from electromagnetic signals generated through LENR emissions.
claim 1e: A claim according to claim 1d, where proton tunnelling into aromatic ring system generates an inversion field corresponding to fMRI signal that can be used to generate functional information through unsupervised learning AUP analysis correlated to mapping of brain activity and the LENR signals associated with the unconscious mind.
claim 1f: A claim according to claim 1e, where photo-Fenton chemistry is harnessed to generate proton tunnelling in the production of unstable atoms that generate LENR IW signals to enable modelling of AUP unconscious mind physics processes.

2: We claim an IU MU Transducer involving a quadrupole geometry that aligns with SUSY DE DM conservation of energy rules based on inverse square law enabling the modelling of subatomic physics processes associated with LENR emissions.
claim 2a: A claim according to claim 2, where the analysis of LENR emissions generated in the quadrupole geometry are analyzed using AUP and OpEMCSS processes and SUSY inversion DE DM modelling associated with photonic feedback control using spectroscopic analysis of the IW.
claim 2b: A claim according to claim 2a, where the quadrupole is arranged to balance the electric and magnetic fields through 180-degree phase shift giving rise to geometries in subatomic systems corresponding to cancellation of eddy currents in layered systems that provide IW signals though layered disks in condensed matter medium to generate signals from IU yielding an IUMU exhaust analyzed by IU MU Transducer.
claim 2c: A claim according to claim 2b, where the layered disks generate IW signals carrying features associated with the quantum hall effect and Casimir cavity.

3: A method of analysis using the IU MU Transducer whereby the controlled generation of an information Wave (IW) is obtained from a single atom, corresponding to a specific energy input that modulates velocities within the atom and results in the controlled transition of the atom from a stable state to an unstable state.
claim 3a: A method of analysis that correlates the temporal features of the IW claimed in claim 3 that is analyzed using AUP whose features mapped onto OpEMCSS where the rules described by SUSY inversion DE DM are utilized to analyze gravitational processes of subatomic particles through plotting kJ/mole (m/s) vs. nm distances correlated to Planck reference (0,0,0) and reciprocal Planck distance of m⁻¹.
claim 3b: A method of analysis of the IW generated in claim 3, where the information regarding subatomic time and space based on the temporal and spatial relativistic and non-relativistic features of IW generated by the IU MU Transducer provides the basis of differential velocity analysis where velocity in kJ/mole (m/s) is derived from binding energy of the unstable atom and the spectroscopic information obtained from the IW generated in claim 3 facilitates identification of the atom and its ability to modulate time.
claim 3c: A method of analysis according to claim 3, where the IU MU Transducer correlates spectroscopic fine and hyperfine structures with atomic expansionary processes identified by SUSY DE DM hydrogen model, to provide information determining the momentum and location of the electron and positron within the subatomic system under investigation.
claim 3d: A method of analysis of subatomic particle physics where the AUP experts provide input features into OpEMCSS along with the quasi-quantum clustering of information to provide OpEMCSS features that modulate the electromagnetic inputs into the IU MU Transducer reactor space.
claim 3e: A method according to claim 3, where the IW corresponds to the reciprocal temporal relationship with isotope half-life timing, where the IU MU Transducer identifies conditions corresponding to DE/DM emission processes associated with binding energy where kJ/mole (m/s) v>c and alpha particle (DE system operates under negative time dilation cosmic inflation IW conditions) and atomic recoil UM (negative mass generation anti-gravity IW) input processes are identified using the IU MU Transducer, AUP and OpEMCSS.
claim 3f: A method according to claim 3e, where energy generated from DE/DM systems corresponds to subatomic processes identified by the IU MU Transducer that map features related to v>c within the aromatic ring system and these features are generated using photo-Fenton chemistry tunneled protons into the aromatic ring which is controlled through AUP regulation of OpEMCSS.
claim 3g: A method according to claim 3e, where the IU MU Transducer identifies conditions that support DE/DM generation in claim 3a allowing for the identification of input parameters that correlate to the production of unusual physics generated by the IU MU Transducer through unsupervised learning quasi-quantum processes of AUP mapped onto OpEMCSS.
claim 3h: A method according to claim 3e, where the IU MU Transducer analysis of DE/DM corresponding to spectroscopic inputs that result in the reduction of mass via isotope physics mediated decay systems release of alpha particles with the corresponding IW, where v>c, and the IW is controlled and regulated by AUP and OpEMCSS. Where alpha particle emission from atoms having (Δdistance based on binding energy <3.9903e−13 m) corresponding to (1−v²/c²=negative time) and kJ/mole (m/s)>c are selected from stable atoms that display functional features identified by IU MU Transducer to generate DE and DM.
